(19) United States
(12) Patent Application Publication
(10) Pub. No.: US 2025/0373098 A1
(43) Pub. Date: Dec. 4, 2025

(54) MOTOR

(71) Applicant: Nidec Motor Corporation, St. Louis, MO (US)

(72) Inventors: Keng-Chang Wu, Taipei (TW); Guo-Jhih Yan, Taipei (TW); Wei-Qian Jian, Taipei (TW); Tsung-Ting Hsieh, Taipei (TW); Chun-Lang Tsai, Taipei (TW); Sheng-Tse Wu, Taipei (TW)

(73) Assignee: Nidec Motor Corporation, St. Louis, MO (US)

(21) Appl. No.: 19/222,738

(22) Filed: May 29, 2025

(30) Foreign Application Priority Data
May 30, 2024 (JP) 2024-088290
May 30, 2024 (JP) JP2024-088287
May 30, 2024 (JP) JP2024-088289
May 30, 2024 (JP) JP2024-088334
May 30, 2024 (JP) JP2024-088335

(51) Int. Cl. H02K 1/2798; H02K 5/15

(52) U.S. Cl. CPC H02K 1/2798; H02K 5/15

(57) ABSTRACT

A motor according to an aspect of the present invention includes a rotor rotatable around a center axis and a stator located on one side of the rotor in an axial direction. The stator includes a plurality of magnetic poles facing an end surface of the rotor on the one side in the axial direction. The rotor includes a rotor body having an annular shape and including at least one magnet, a rotor frame including a plurality of arms extending in a radial direction, and a first cover fixed to the rotor frame. The at least one magnet has, at least in part or in whole, a magnetization direction in the axial direction. The plurality of arms are located on the other side of the rotor body in the axial direction. The first cover is configured to cover at least part of a surface of the at least one magnet, the surface facing the one side in the axial direction.

### CROSS-REFERENCE TO RELATED APPLICATIONS

This application claims priority of Japanese Patent Application Nos. JP2024-088290, JP2024-088335, JP2024-088334, JP2024-088289, and JP2024-088287, all of which were filed on May 30, 2024, and each of which is hereby incorporated by reference in its entirety herein.

This application is being filed contemporaneously with U.S. patent application Ser. No. ______, entitled MOTOR, U.S. patent application Ser. No. ______, entitled MOTOR, U.S. patent application Ser. No. ______, entitled MOTOR AND PROPULSION APPARATUS, and U.S. patent application Ser. No. ______, entitled MOTOR, each of which is hereby incorporated by reference in its entirety herein.

### FIELD OF THE INVENTION

The present invention relates to a motor.

### BACKGROUND

An axial flux type motor in which a stator is located on one side of a rotor in an axial direction is known.

### SUMMARY

### Technical Problem

In an axial flux type motor, a magnet of the rotor is subjected to a force that pulls the magnet toward the stator, creating a risk that the magnet will detach from a rotor frame and move toward the stator. This results in a risk that the magnet may come into contact with the stator.

In view of the above circumstances, one object of the present invention is to provide a motor having a structure capable of suppressing contact of a magnet with a stator.

### Solution to Problem

A motor according to one aspect of the present invention includes a rotor rotatable around a center axis and a stator located on one side of the rotor in an axial direction. The stator includes a plurality of magnetic poles facing an end surface of the rotor on the one side in the axial direction. The rotor includes a rotor body having an annular shape and including at least one magnet, a rotor frame including a plurality of arms extending in a radial direction, and a first cover fixed to the rotor frame. The at least one magnet has, at least in part or in whole, a magnetization direction in the axial direction. The arms are located on the other side of the rotor body in the axial direction. The first cover is configured to cover at least part of a surface of the at least one magnet, the surface facing the one side in the axial direction.

### Advantageous Effects

According to one aspect of the present invention, in a motor, it is possible to suppress contact of a magnet with a stator.

### BRIEF DESCRIPTION OF THE DRAWINGS

FIG. 1 is a perspective view of a motor of a propulsion device according to a first embodiment.

FIG. 2 is a perspective view illustrating the motor of the propulsion device according to the first embodiment, and is a perspective view of the motor as viewed from an angle different from that in FIG. 1.

FIG. 3 is a view of the motor of the propulsion device according to the first embodiment as viewed from a rear side.

FIG. 4 is a cross-sectional view illustrating the motor of the propulsion device according to the first embodiment.

FIG. 5 is a perspective view illustrating an attachment member according to the first embodiment.

FIG. 6 is a cross-sectional view of part of the motor according to the first embodiment.

FIG. 7 is a perspective view illustrating a first rotor according to the first embodiment.

FIG. 8 is an exploded perspective view illustrating the first rotor according to the first embodiment.

FIG. 9 is a perspective view illustrating a first rotor frame and a second rotor frame according to the first embodiment.

FIG. 10 is a perspective view illustrating part of the first rotor frame according to the first embodiment.

FIG. 11 is a cross-sectional view illustrating part of the first rotor according to the first embodiment.

FIG. 12 is a perspective view illustrating a rotor body according to the first embodiment.

FIG. 13 is a perspective view illustrating part of an annular member according to the first embodiment.

FIG. 14 is a perspective view illustrating part of the first rotor frame, part of the annular member, and part of a plurality of second covers according to the first embodiment.

FIG. 15 is a perspective view illustrating part of the first rotor according to the first embodiment.

FIG. 16 is a cross-sectional view illustrating part of the first rotor according to the first embodiment, and is a cross-sectional view illustrating a location different from that in FIG. 11.

FIG. 17 is a view of a first cover of the first rotor according to the first embodiment as viewed from a front side.

FIG. 18 is a perspective view illustrating part of the first cover according to the first embodiment.

FIG. 19 is a perspective view illustrating part of the first cover according to the first embodiment, and is a view of part of the first cover as viewed from an angle different from that in FIG. 18.

FIG. 20 is a perspective view illustrating part of a first arm, part of the first cover, and part of the second cover according to the first embodiment.

FIG. 21 is a cross-sectional view illustrating part of the attachment member, part of the first rotor, and part of a stator according to the first embodiment.

FIG. 22 is a perspective view illustrating the second cover according to the first embodiment.

FIG. 23 is a perspective view illustrating a second rotor and a connection tube according to the first embodiment.

FIG. 24 is a cross-sectional view illustrating part of the motor according to the first embodiment, and is a partially enlarged view of FIG. 4.

FIG. 25 is an exploded perspective view illustrating a first rolling bearing, a second rolling bearing, a first spacer, a second spacer, and a bearing support member according to the first embodiment.

FIG. 26 is a perspective view illustrating a part including a preload member of the motor according to the first embodiment.

FIG. 27 is a perspective view illustrating the stator according to the first embodiment.

FIG. 28 is a perspective view illustrating the stator according to the first embodiment, and is a perspective view of the stator as viewed from an angle different from that in FIG. 27.

FIG. 29 is a cross-sectional view illustrating part of the stator according to the first embodiment, and is a view illustrating a cross section orthogonal to an axial direction.

FIG. 30 is a cross-sectional view illustrating part of the stator according to the first embodiment, and is a view illustrating a cross section orthogonal to a circumferential direction.

FIG. 31 is a perspective view illustrating an inner housing and an outer housing according to the first embodiment.

FIG. 32 is a cross-sectional perspective view illustrating part of the inner housing according to the first embodiment.

FIG. 33 is a perspective view illustrating part of the inner housing and part of the outer housing according to the first embodiment.

FIG. 34 is a perspective view illustrating part of the outer housing, part of a stator cover, and part of a stator support section according to the first embodiment.

FIG. 35 is a perspective view illustrating the stator cover according to the first embodiment.

FIG. 36 is a cross-section perspective view illustrating part of the stator according to the first embodiment.

FIG. 37 is a perspective view illustrating part of the stator according to the first embodiment.

FIG. 38 is a perspective view illustrating a bus bar according to the first embodiment.

FIG. 39 is a cross-sectional perspective view illustrating part of a motor of a propulsion device according to a second embodiment.

FIG. 40 is a perspective view illustrating part of the motor of the propulsion device according to the second embodiment.

FIG. 41 is a cross-sectional view illustrating part of a stator according to a third embodiment.

FIG. 42 is a cross-sectional view illustrating part of a stator according to a fourth embodiment.

FIG. 43 is a cross-sectional view illustrating a motor of a propulsion device according to a fifth embodiment.

FIG. 44 is a perspective view illustrating a motor of a propulsion device according to a sixth embodiment.

FIG. 45 is a cross-sectional view illustrating the motor of the propulsion device according to the sixth embodiment.

FIG. 46 is a cross-sectional view illustrating a part of the motor of the propulsion device according to the sixth embodiment.

FIG. 47 is a cross-sectional view illustrating the motor of the propulsion device according to the sixth embodiment, and is a view illustrating a cross section orthogonal to the axial direction.

FIG. 48 is a cross-sectional perspective view illustrating a motor of a propulsion device according to a seventh embodiment.

### DETAILED DESCRIPTION

In each drawing, a center axis J of a motor of each embodiment below is illustrated as appropriate. The center axis J is a virtual axis. In the description below, a direction in which the center axis J extends, that is, an axial direction of the center axis J, is simply referred to as an “axial direction,” a radial direction about the center axis J is simply referred to as a “radial direction,” and a circumferential direction about the center axis J is simply referred to as a “circumferential direction.” Each drawing illustrates a Z axis parallel to the axial direction. In the following description, a side in the axial direction toward which an arrow of the Z axis points (+Z side) is called a “front side,” and a side in the axial direction opposite to the side toward which the arrow of the Z axis points (−Z side) is called a “rear side.” Note that the front side and the rear side are merely names for describing an arrangement relationship and the like of the respective parts, and the actual arrangement relationship and the like may be an arrangement relationship and the like other than the arrangement relationship and the like indicated by these names.

### First Embodiment

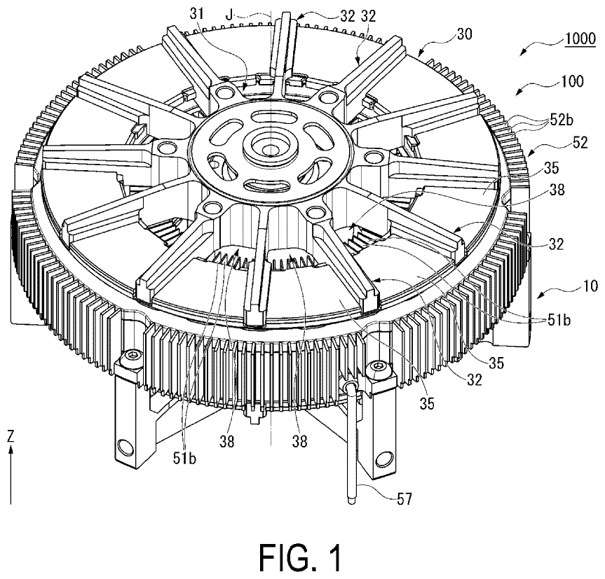

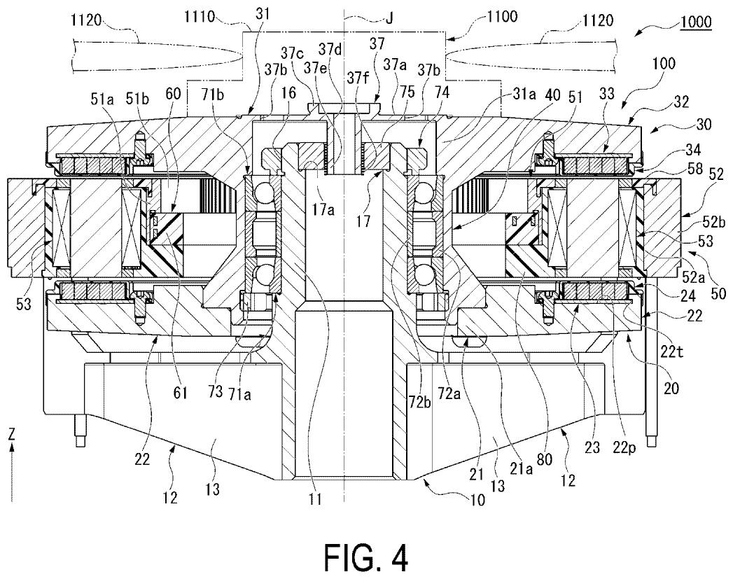

A motor 100 illustrated in FIG. 1 to FIG. 3 is a motor included in a propulsion device 1000. The propulsion device 1000 is mounted onto, for example, an unmanned aerial vehicle. The propulsion device 1000 generates a propulsive force for moving the unmanned aerial vehicle. As illustrated in FIG. 4, the propulsion device 1000 includes the motor 100 and a propeller 1100. The propeller 1100 is rotated around the center axis J by the motor 100. The propeller 1100 is attached to a second rotor 30, described below, of the motor 100. The propeller 1100 includes a base part 1110 fixed to the second rotor 30 and a plurality of blade parts 1120 connected to the base part 1110. The plurality of blade parts 1120 extend in the radial direction and are disposed spaced apart in the circumferential direction.

The motor 100 is an axial flux type motor. In the present embodiment, the motor 100 is a double-rotor axial flux type motor in which the rotor includes a first rotor 20 and the second rotor 30. The motor 100 includes an attachment member 10, the first rotor 20, the second rotor 30, a connection tube 40, a stator 50, a bus bar assembly 60, a first rolling bearing 71a, a second rolling bearing 71b, a first spacer 72a, a second spacer 72b, a bearing support member 73, a preload member 74, and a conductive member 75.

The attachment member 10 is attached to a device onto which the motor 100 is mounted. The attachment member 10 supports the first rotor 20, the second rotor 30, and the stator 50. The attachment member 10 has conductivity. The attachment member 10 is made of a non-magnetic material. Note that, in the present specification, the expression “a certain object is made of a non-magnetic material” includes the certain object being made of a paramagnetic material and the certain object being made of a diamagnetic material. In the present embodiment, the attachment member 10 is made of a metal. The metal constituting the attachment member 10 is, for example, aluminum.

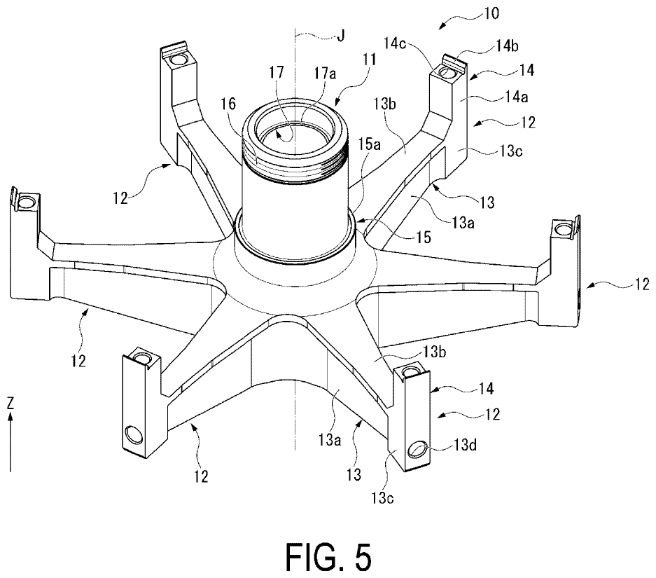

As illustrated in FIG. 5, the attachment member 10 includes a support shaft 11 and a plurality of stator support sections 12. That is, the motor 100 includes the support shaft 11 and the plurality of stator support sections 12. The support shaft 11 has a tubular shape extending in the axial direction along the center axis J. More specifically, the support shaft 11 has a cylindrical shape about the center axis J. As illustrated in FIG. 4, the support shaft 11 opens to the front side (+Z side) and the rear side (−Z side). An end portion of the support shaft 11 on the rear side is located rearward of the first rotor 20. The support shaft 11 rotatably supports the first rotor 20 and the second rotor 30 via the first rolling bearing 71a and the second rolling bearing 71b.

As illustrated in FIG. 5, a stepped portion 15 including a second stepped surface 15a facing the front side (+Z side) is provided on a part of an outer circumferential surface of the support shaft 11 on the rear side (−Z side). The second stepped surface 15a has an annular shape surrounding the center axis J. More specifically, the second stepped surface 15a has a circular annular shape having a center that coincides with the center axis J in a planar view in the axial direction. The second stepped surface 15a is a surface orthogonal to the axial direction. An outer diameter of a part of the support shaft 11 located rearward of the second stepped surface 15a is larger than an outer diameter of a part of the support shaft 11 located frontward of the second stepped surface 15a.

A stepped portion 17 including a third stepped surface 17a facing the front side is provided on a part of an inner circumferential surface of the support shaft 11 on the front side (+Z side). The third stepped surface 17a has an annular shape surrounding the center axis J. More specifically, the third stepped surface 17a has a circular annular shape having a center that coincides with the center axis J in a planar view in the axial direction. The third stepped surface 17a is a surface orthogonal to the axial direction. An inner diameter of a part of the support shaft 11 located frontward of the third stepped surface 17a is larger than an inner diameter of a part of the support shaft 11 located rearward (−Z side) of the third stepped surface 17a.

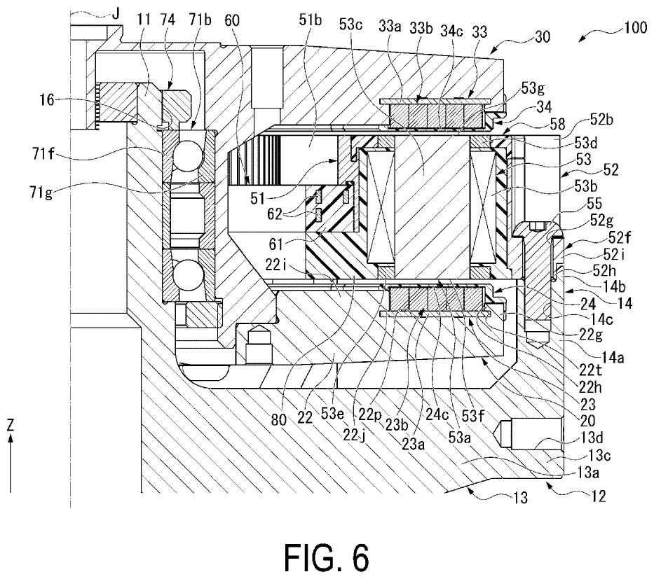

The support shaft 11 includes a first threaded portion 16 on the outer circumferential surface thereof. As illustrated in FIG. 6, the first threaded portion 16 is provided on the outer circumferential surface of a part of the support shaft 11 located frontward (+Z side) of an inner ring 71f of the second rolling bearing 71b. In the present embodiment, the first threaded portion 16 is provided on an outer circumferential surface of an end portion of the support shaft 11 on the front side.

As illustrated in FIG. 4, the conductive member 75 is disposed in an interior of the support shaft 11. The conductive member 75 has an annular shape surrounding the center axis J. More specifically, the conductive member 75 has a circular annular shape having a center that coincides with the center axis J in a planar view in the axial direction. The conductive member 75 has conductivity. The conductive member 75 is made of a non-magnetic material. The conductive member 75 is made of, for example, a metal. The metal constituting the conductive member 75 is, for example, aluminum. The conductive member 75 is fitted into the end portion of the support shaft 11 on the front side. An outer circumferential surface of the conductive member 75 comes into contact with the inner circumferential surface of the support shaft 11. The conductive member 75 is fixed inside the support shaft 11 by, for example, press-fitting. Note that the conductive member 75 may be fixed inside the support shaft 11 by another method such as shrink-fitting. A radial outer edge portion of a surface of the conductive member 75 on the rear side (−Z side) comes into contact with the third stepped surface 17a. Thus, the conductive member 75 is positioned in the axial direction relative to the support shaft 11.

As illustrated in FIG. 5, the plurality of stator support sections 12 are disposed spaced apart in the circumferential direction. In the present embodiment, six stator support sections 12 are provided. Each of the plurality of stator support sections 12 includes a first extending portion 13 and a support column part 14. The first extending portion 13 extends in the radial direction. As illustrated in FIG. 6, an end portion of the first extending portion 13 on the inner side in the radial direction is connected to a part of the support shaft 11 that is located rearward (−Z side) of the first rotor 20. An end portion of the first extending portion 13 on the outer side in the radial direction is located outward of the first rotor 20 in the radial direction. As illustrated in FIG. 5, the first extending portion 13 includes a first plate-shaped portion 13a, a second plate-shaped portion 13b, and a tip portion 13c.

The first plate-shaped portion 13a extends in the radial direction. The first plate-shaped portion 13a has a plate shape with a plate surface facing the circumferential direction. An end portion of the first plate-shaped portion 13a on the inner side in the radial direction is connected to the support shaft 11. An end portion of the first plate-shaped portion 13a on the rear side (−Z side) is located on the front side (+Z side), extending toward the outer side in the radial direction.

The second plate-shaped portion 13b extends in the radial direction. The second plate-shaped portion 13b has a plate shape with a plate surface facing the axial direction. The second plate-shaped portion 13b is connected to an end portion of the first plate-shaped portion 13a on the front side (+Z side). An end portion of the second plate-shaped portion 13b on the inner side in the radial direction is connected to the support shaft 11. The second plate-shaped portion 13b protrudes from the end portion of the first plate-shaped portion 13a on the front side toward both sides in the circumferential direction. A dimension of the second plate-shaped portion 13b in the circumferential direction decreases toward the outer side in the radial direction.

The tip portion 13c is connected to an end portion of the first plate-shaped portion 13a on the outer side in the radial direction and to an end portion of the second plate-shaped portion 13b on the outer side in the radial direction. The tip portion 13c has a substantially rectangular parallelepiped shape. The tip portion 13c includes a threaded hole 13d recessed from a surface of the tip portion 13c on the outer side in the radial direction toward the inner side in the radial direction. A bolt (not illustrated) that fixes the attachment member 10 to a device on which the motor 100 is mounted is fastened into the threaded hole 13d. The motor 100 is fixed to the device on which the motor 100 is mounted by fixing each tip portion 13c of the plurality of stator support sections 12 to the device with a bolt (not illustrated).

As illustrated in FIG. 6, the support column part 14 protrudes toward the front side (+Z side) from a part of the first extending portion 13 that is located outward of the first rotor 20 in the radial direction. In the present embodiment, the support column part 14 protrudes toward the front side from the end portion of the first extending portion 13 on the outer side in the radial direction, that is, the tip portion 13c. The support column part 14 is located on the outer side of the first rotor 20 in the radial direction. As illustrated in FIG. 5, in the present embodiment, the support column part 14 has a substantially quadrangular prism shape extending in the axial direction. The support column part 14 includes a support column body portion 14a and a wall portion 14b. The support column body portion 14a has a substantially quadrangular columnar shape protruding from the tip portion 13c toward the front side. The support column body portion 14a includes a threaded hole 14c recessed from a surface of the support column body portion 14a on the front side toward the rear side (−Z side). As illustrated in FIG. 6, the surface of the support column body portion 14a on the front side comes into contact with a surface of a housing fixed portion 52f, described below, of the stator 50, the surface being on the rear side (−Z side). Thus, the support column part 14 comes into contact with the surface of the housing fixed portion 52f on the rear side. The plurality of stator support sections 12 support the stator 50 from the rear side by the support column parts 14.

As illustrated in FIG. 5, the wall portion 14b protrudes toward the front side from an edge portion of a surface of the support column body portion 14a on the front side (+Z direction), the edge portion being on the outer side in the radial direction. The wall portion 14b is located outward of the threaded hole 14c in the radial direction. The wall portion 14b extends from an edge on one side in the circumferential direction to an edge on the other side in the circumferential direction of the support column body portion 14a.

The first rotor 20 and the second rotor 30 are rotatable around the center axis J. As illustrated in FIG. 4, the second rotor 30 is located frontwardly (+Z side) away from the first rotor 20. The first rotor 20 is located on the rear side (−Z side) of the stator 50. The second rotor 30 is located on the front side of the stator 50. That is, in the present embodiment, the rotors are disposed on both sides of the stator 50 in the axial direction. In the first rotor 20 of the present embodiment, a side on which the stator 50 is located relative to the first rotor 20, that is, the front side (+Z side), is “one side in the axial direction,” and a side on which the first rotor 20 is located relative to the stator 50, that is, the rear side (−Z side), is “the other side in the axial direction.” In the second rotor 30 of the present embodiment, a side on which the stator 50 is located relative to the second rotor 30, that is, the rear side, is “one side in the axial direction,” and a side on which the second rotor 30 is located relative to the stator 50, that is, the front side, is “the other side in the axial direction.”

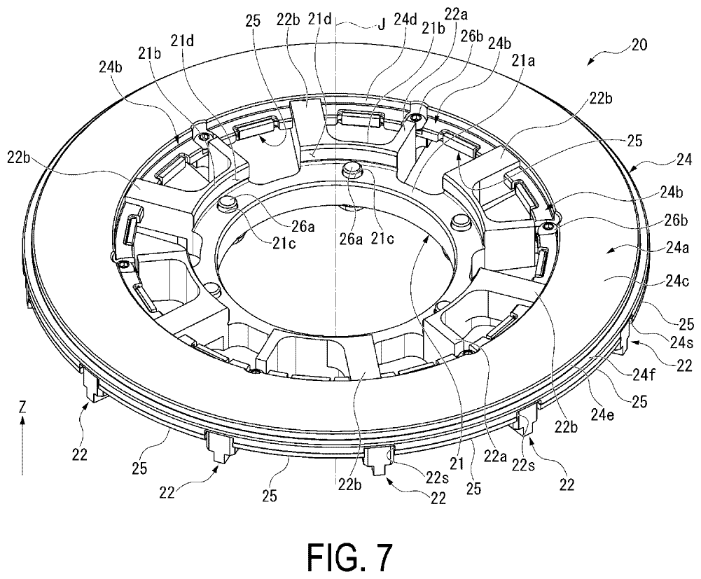

As illustrated in FIG. 7, the first rotor 20 has an annular shape surrounding the center axis J. More specifically, the first rotor 20 has a substantially circular annular shape having a center that coincides with the center axis J in a planar view in the axial direction. As illustrated in FIG. 4, the first rotor 20 is located frontward (+Z side) of the first extending portions 13 of the plurality of stator support sections 12. The first rotor 20 is located on the outer side of the support shaft 11 in the radial direction and surrounds the support shaft 11.

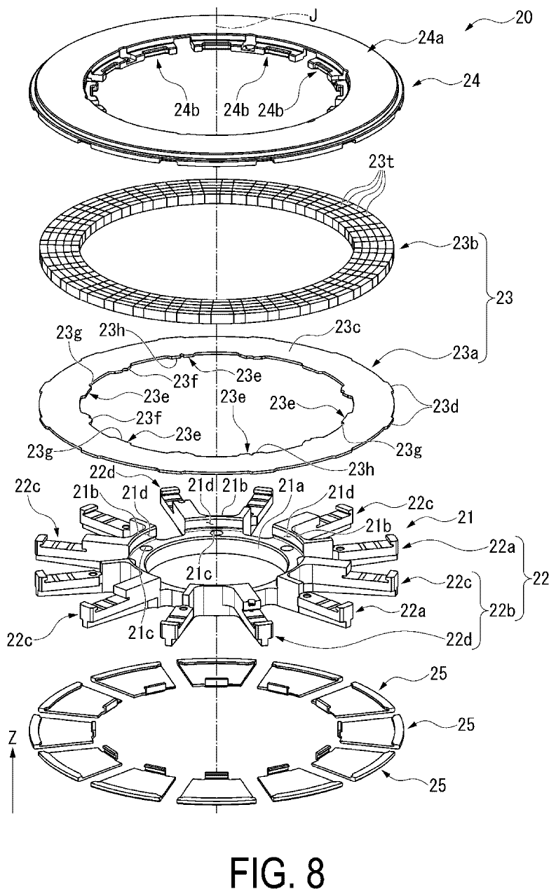

As illustrated in FIG. 8, the first rotor 20 includes a first rotor frame 21, a rotor body 23, a first cover 24, and a plurality of second covers 25. The first rotor frame 21 has conductivity. The first rotor frame 21 is made of a non-magnetic material. In the present embodiment, the first rotor frame 21 is made of a metal. The metal constituting the first rotor frame 21 is, for example, aluminum. The first rotor frame 21 includes a first rotor annular portion 21a, a plurality of first protruding walls 21b, and a plurality of first arms 22.

The first rotor annular portion 21a has an annular shape surrounding the center axis J. More specifically, the first rotor annular portion 21a has a substantially circular annular shape having a center that coincides with the center axis J in a planar view in the axial direction. The first rotor annular portion 21a includes a plurality of holes 21c penetrating the first rotor annular portion 21a in the axial direction. The plurality of holes 21c are disposed spaced apart in the circumferential direction.

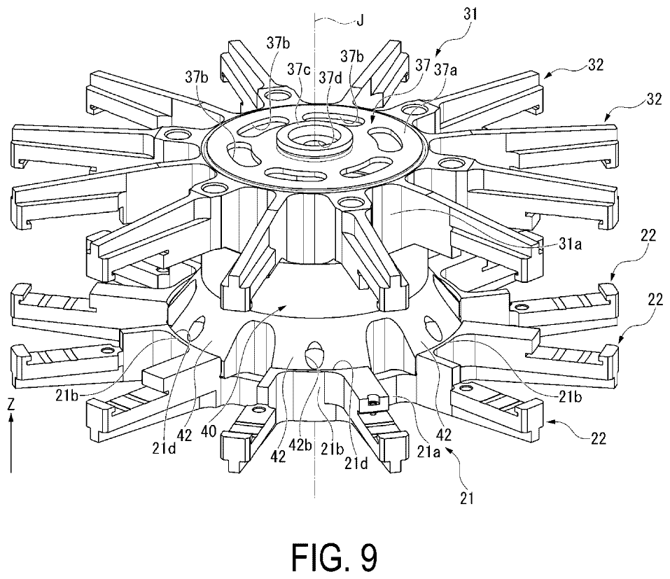

The plurality of first protruding walls 21b are protruding walls protruding from a radial outer edge of the first rotor annular portion 21a toward the front side (+Z side). The plurality of first protruding walls 21b are disposed spaced apart in the circumferential direction. The plurality of first protruding walls 21b extend in the circumferential direction. A radial inner surface 21d of each of the plurality of first protruding walls 21b has a circular arc shape extending in the circumferential direction in a planar view in the axial direction. As illustrated in FIG. 9, the plurality of first protruding walls 21b are located on the outer side of the connection tube 40 in the radial direction and are disposed surrounding the connection tube 40. In the present embodiment, six first protruding walls 21b are provided.

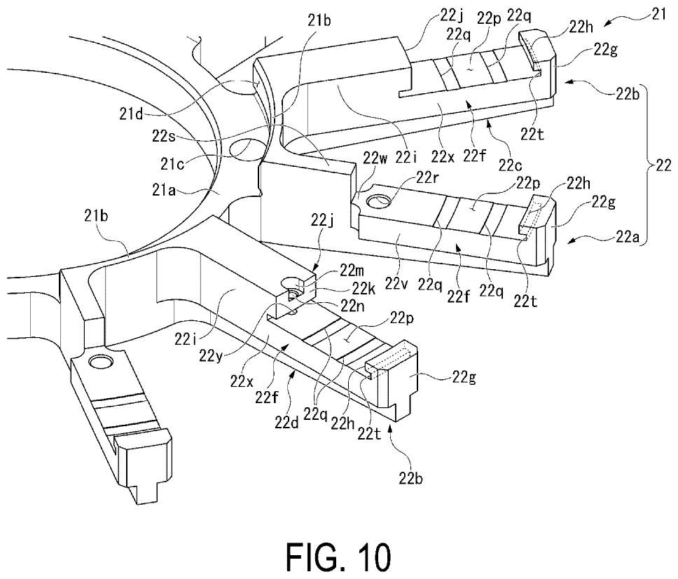

The plurality of first arms 22 extend in the radial direction. Each of the plurality of first arms 22 extends from an outer circumferential surface of the first rotor annular portion 21a toward the inner side in the radial direction. The plurality of first arms 22 are disposed spaced apart from each other in the circumferential direction. In the present embodiment, the plurality of first arms 22 are disposed at equal intervals across the entire circumference in the circumferential direction. As illustrated in FIG. 4, the plurality of first arms 22 are located on the rear side (−Z side) of the rotor body 23. The plurality of first arms 22 are located frontward (+Z side) of the plurality of first extending portions 13. As illustrated in FIG. 10, each of the plurality of first arms 22 includes an arm body portion 22f extending in the radial direction, a holding wall 22g protruding from an end portion of the arm body portion 22f on the outer side in the radial direction toward the front side, and a first protruding portion 22h protruding from an end portion of the holding wall 22g on the front side toward the inner side in the radial direction.

The arm body portion 22f extends from the outer circumferential surface of the first rotor annular portion 21a toward the outer side in the radial direction. The arm body portion 22f includes a mounting surface 22p. That is, each of the plurality of first arms 22 includes the mounting surface 22p. The mounting surface 22p is part of a surface of the arm body portion 22f on the front side (+Z side). The mounting surface 22p faces the front side. In the present embodiment, the mounting surface 22p is a surface orthogonal to the axial direction. As illustrated in FIG. 6, the mounting surface 22p is located on the rear side (−Z side) of the rotor body 23. The mounting surface 22p comes into contact with a surface of the rotor body 23 on the rear side. That is, each of the plurality of first arms 22 comes into contact with the surface of the rotor body 23 on the rear side at a surface facing the front side of the first arm 22, that is, the mounting surface 22p. This makes it possible to position the rotor body 23 in the axial direction relative to the first rotor frame 21 by the first arms 22. Accordingly, the position of the rotor body 23 in the axial direction relative to the stator 50 can be accurately determined. In the present embodiment, the mounting surface 22p comes into contact with the surface of the rotor body 23 on the rear side, making it possible to more stably support the rotor body 23 by the first arms 22. Note that each of the plurality of first arms 22 may come into contact with the surface of the rotor body 23 on the rear side, at an edge of the first arm 22 in the circumferential direction. Even in this case, the rotor body 23 can be positioned in the axial direction relative to the first rotor frame 21 by the first arms 22.

The holding wall 22g includes a holding surface 22t. That is, the plurality of first arms 22 each include the holding surface 22t. The holding surface 22t is a surface on the inner side of the holding wall 22g in the radial direction. The holding surface 22t faces the inner side in the radial direction. In the present embodiment, the holding surface 22t is a surface orthogonal to the radial direction. The holding surface 22t is located on the outer side of the rotor body 23 in the radial direction. More specifically, the holding surface 22t is located on the outer side, in the radial direction, of an annular member 23a (described below) of the rotor body 23. As illustrated in FIG. 10, in the present embodiment, the holding surface 22t has a circular arc shape about the center axis J in a planar view in the axial direction. Note that, in the present specification, a center of the circular arc is a center in the case of a circle obtained by virtually extending the circular arc. The holding surfaces 22t come into contact with an outer circumferential surface of the rotor body 23. This makes it possible to position the rotor body 23 in the radial direction relative to the first rotor frame 21 by the holding surfaces 22t. As a result, a positional accuracy of the rotor body 23 in the radial direction can be improved. Accordingly, a magnet 23t, described below, of the rotor body 23 is readily disposed with high positional accuracy in the radial direction relative to the stator 50.

The first protruding portion 22h is disposed on the front side (+Z side) of the arm body portion 22f with a gap therebetween. A surface of the first protruding portion 22h on the rear side (−Z side) faces, in the axial direction, an end portion of the mounting surface 22p on the outer side in the radial direction, with a gap therebetween. A surface of the first protruding portion 22h on the inner side in the radial direction has a circular arc shape about the center axis J in a planar view in the axial direction. A dimension of the first protruding portion 22h in the circumferential direction is the same as a dimension of the holding wall 22g in the circumferential direction. As illustrated in FIG. 6, the first protruding portion 22h is located on the outer side, in the radial direction, of a magnet assembly 23b (described below) of the rotor body 23.

As illustrated in FIG. 10, each first arm 22 includes a groove 22q recessed from the mounting surface 22p toward the rear side. The groove 22q extends in the circumferential direction. End portions of the groove 22q on both sides in the circumferential direction are respectively provided at both circumferential edge portions of the mounting surface 22p. The groove 22q opens to both sides in the circumferential direction. A dimension of the groove 22q in the axial direction is smaller than a dimension of the groove 22q in the radial direction. The groove 22q is located inward, in the radial direction, of an end portion of the first protruding portion 22h on the inner side in the radial direction. The groove 22q is provided outwardly away, in the radial direction, from an end portion of the mounting surface 22p on the inner side in the radial direction. A plurality of the grooves 22q are provided spaced apart in the radial direction. In the present embodiment, two grooves 22q are provided for each first arm 22.

As illustrated in FIG. 8, in the present embodiment, twelve first arms 22 are provided. The plurality of first arms 22 include a first arm 22a and a first arm 22b. The first arm 22a and the first arm 22b are alternately provided one by one in the circumferential direction. In the present embodiment, six first arms 22a and six first arms 22b are provided. Note that a number of the first arms 22a and a number of the first arms 22b are not particularly limited. All first arms 22 may be the first arm 22b without provision of the first arm 22a, or all first arms 22 may be the first arm 22a without provision of the first arm 22b.

As illustrated in FIG. 10, the first arm 22a includes a second protruding wall 22s protruding toward the front side (+Z side) from a part of the arm body portion 22f that is inwardly separated from the holding wall 22g in the radial direction. In the present embodiment, the second protruding wall 22s protrudes from an end portion of the arm body portion 22f on the inner side in the radial direction toward the front side. The second protruding wall 22s has a substantially rectangular parallelepiped shape long in the radial direction. An end portion of the second protruding wall 22s on the inner side in the radial direction is connected to an end portion of the first protruding wall 21b on the one side in the circumferential direction. The second protruding wall 22s is located inwardly away from the first protruding portion 22h in the radial direction. A dimension of the second protruding wall 22s in the circumferential direction is the same as a dimension, in the circumferential direction, of a part of the arm body portion 22f of the first arm 22a that is connected to the rear side (−Z side) of the second protruding wall 22s.

The first arm 22a includes a mounting portion 22v. The mounting portion 22v is a part on the front side (+Z side) of a part of the arm body portion 22f of the first arm 22a that is located outward of the second protruding wall 22s in the radial direction. A surface of the mounting portion 22v on the front side is the mounting surface 22p of the first arm 22a. An end portion of the mounting portion 22v on the inner side in the radial direction is a narrow-width portion 22w having a dimension in the circumferential direction that decreases toward the inner side in the radial direction. Both side surfaces of the narrow-width portion 22w in the circumferential direction approach each other in the circumferential direction inwardly in the radial direction. Both side surfaces of the narrow-width portion 22w in the circumferential direction have a circular arc shape recessed toward the outer side in the radial direction in a planar view in the axial direction. A dimension of the mounting portion 22v in the circumferential direction, excluding an end portion of the narrow-width portion 22w on the inner side in the radial direction, is larger than, of the arm body portion 22f of the first arm 22a, a dimension, in the circumferential direction, of a part that is connected to the rear side (−Z side) of the mounting portion 22v and a dimension, in the circumferential direction, of a part of the second protruding wall 22s that is connected to the rear side. The mounting portion 22v protrudes from the end portion on the front side of the part of the arm body portion 22f of the first arm 22a that is connected to the rear side of the mounting portion 22v toward both sides in the circumferential direction.

The first arm 22a includes a threaded hole 22r recessed from the mounting surface 22r toward the rear side (−Z side). In the present embodiment, the threaded hole 22r is provided at an end portion of a part, on the inner side in the radial direction, of the mounting portion 22v that is located outward of the narrow-width portion 22w in the radial direction. The threaded hole 22r is located inward of the grooves 22q in the radial direction.

The first arm 22b includes a third protruding wall 22i. The third protruding wall 22i is a protruding wall that protrudes toward the front side (+Z side) from a part of the arm body portion 22f that is inwardly separated from the holding wall 22g in the radial direction. In the present embodiment, the third protruding wall 22i protrudes from an end portion of the arm body portion 22f on the inner side in the radial direction toward the front side. The third protruding wall 22i has a substantially rectangular parallelepiped shape long in the radial direction. The end portion of the third protruding wall 22i on the inner side in the radial direction is connected to an end portion of the first protruding wall 21b on the other side in the circumferential direction. In the present embodiment, the second protruding wall 22s of the first arm side 22a and the third protruding wall 22i of the first arm 22b are respectively connected to the end portions of the first protruding wall 21b on both sides in the circumferential direction. The third protruding wall 22i is located inwardly away from the first protruding portion 22h in the radial direction. A dimension of the third protruding wall 22i in the circumferential direction is larger than the dimension of the second protruding wall 22s in the circumferential direction. As illustrated in FIG. 6, the third protruding wall 22i is located on the inner side of the rotor body 23 in the radial direction. A surface of the third protruding wall 22i on the outer side in the radial direction is disposed facing, of the rotor body 23, the inner side of the annular member 23a, described below, in the radial direction.

As illustrated in FIG. 10, a dimension in the circumferential direction of a part, on the front side (+Z side), of the arm body portion 22f of the first arm 22b is larger than a dimension in the circumferential direction of a part, on the rear side (−Z side), of the arm body portion 22f of the first arm 22b. The first arm 22b includes a mounting portion 22x. The mounting portion 22x is a part located outward of the third protruding wall 22i in the radial direction of a part, on the front side, of the arm body portion 22f of the first arm 22b. A surface of the mounting portion 22x on the front side is the mounting surface 22p of the first arm 22b. A dimension of the mounting portion 22x in the circumferential direction is larger than a dimension in the circumferential direction of a part of the arm body portion 22f of the first arm 22b that is connected to the rear side (−Z side) of the mounting portion 22x. The mounting portion 22x protrudes from an end portion on the front side of the part of the arm body portion 22f of the first arm 22b that is connected to the rear side of the mounting portion 22x toward both sides in the circumferential direction.

The first arm 22b includes a second protruding portion 22j protruding from an end portion of the third protruding wall 22i on the front side (+Z side) toward the outer side in the radial direction. The second protruding portion 22j is disposed on the front side of the arm body portion 22f, with a gap therebetween. A surface of the second protruding portion 22j on the rear side (−Z side) faces, in the axial direction, an end portion of the mounting surface 22p on the inner side in the radial direction, with a gap therebetween. A surface of the second protruding portion 22j on the outer side in the radial direction has a circular arc shape about the center axis J in a planar view in the axial direction. A dimension of the second protruding portion 22j in the circumferential direction is the same as the dimension of third protruding wall 22i in the circumferential direction. As illustrated in FIG. 6, the second protruding portion 22j is located on the inner side, in the radial direction, of the magnet assembly 23b, described below, of the rotor body 23.

As illustrated in FIG. 10, the plurality of first arm 22b include a first arm 22c and a first arm 22d. The second protruding portion 22j of the first arm 22d is a second protruding portion 22k including a recess portion 22m and a second penetrating portion 22n. That is, the second protruding portion 22j includes the second protruding portion 22k including the second penetrating portion 22n. The recess portion 22m is recessed from the surface of the second protruding portion 22k on the front side (+Z side) toward the rear side (−Z side). An interior of the recess portion 22m is open to a surface of the second protruding portion 22k on the outer side in the radial direction. A part of an inner edge of the recess portion 22m located on the inner side in the radial direction has a semicircular arc shape recessed toward the inner side in the radial direction in a planar view in the axial direction.

The second penetrating portion 22n passes through the second protruding portion 22k in the axial direction. In the present embodiment, the second penetrating portion 22n is a hole penetrating in the axial direction from a surface, located on the rear side (−Z side), of an inner surface of the recess portion 22m to a surface of the second protruding portion 22k on the rear side. The second penetrating portion 22n has a circular shape in a planar view in the axial direction. An inner edge of the second penetrating portion 22n includes parts located on both sides in the circumferential direction.

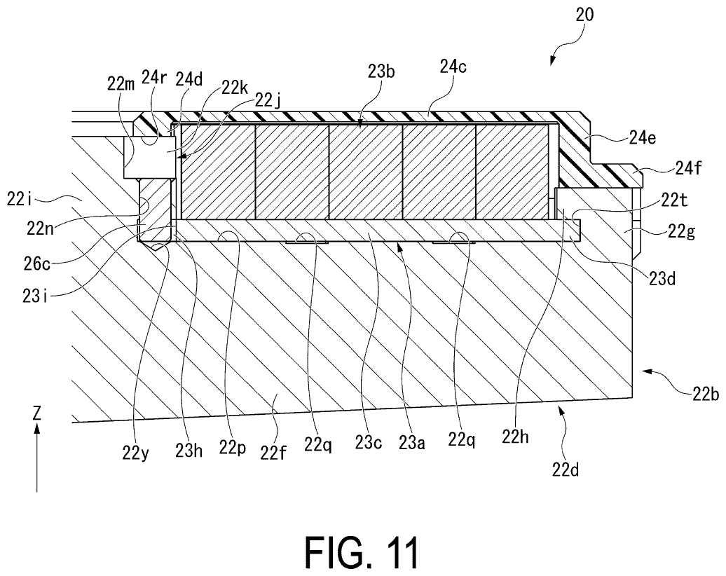

The mounting portion 22x of the first arm 22d includes a recess portion 22y recessed from the mounting surface 22p toward the rear side (−Z side). The recess portion 22y is provided in a part of the mounting portion 22x that is located on the rear side of the second protruding portion 22j. The recess portion 22y overlaps the second penetrating portion 22n in a planar view in the axial direction. As illustrated in FIG. 11, an inner surface of the recess portion 22y has a conical shape protruding toward the rear side. The recess portion 22y is formed by, for example, cutting part of the mounting surface 22p with a tip of a drill when the second penetrating portion 22n is formed by drilling using the drill.

As illustrated in FIG. 8, a pair of the first arms 22d are provided with the center axis J interposed therebetween in the radial direction. In the present embodiment, among the six first arms 22b, four first arms 22b excluding the pair of first arms 22d are the first arms 22c. As illustrated in FIG. 10, the first arm 22c has a configuration similar to that of the first arm 22d except that the recess portions 22m, 22y and the second penetrating portion 22n are not provided.

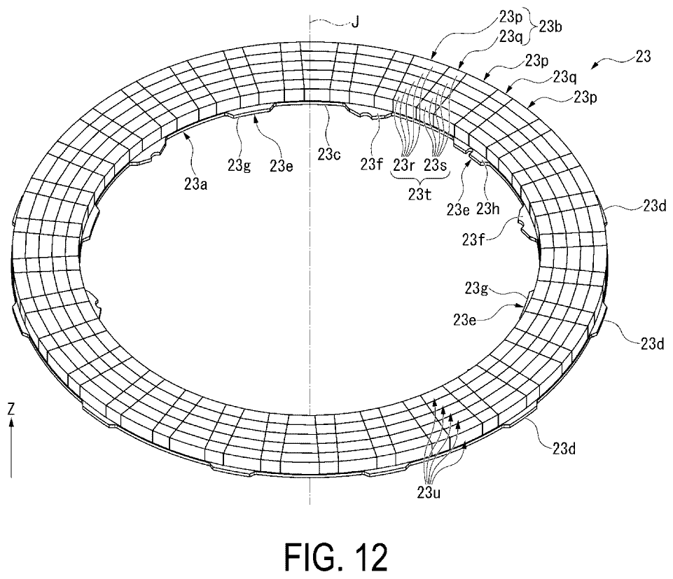

As illustrated in FIG. 12, the rotor body 23 has an annular shape surrounding the center axis J. More specifically, the rotor body 23 has a substantially circular annular shape having a center that coincides with the center axis J in a planar view in the axial direction. The rotor body 23 includes the annular member 23a and the magnet assembly 23b. The annular member 23a has an annular shape surrounding the center axis J. More specifically, the annular member 23a has a substantially circular annular shape having a center that coincides with the center axis J in a planar view in the axial direction. The annular member 23a has a plate shape with a plate surface facing the axial direction. The annular member 23a is made of a magnetic material. Note that, in the present specification, the expression “a certain object is made of a magnetic material” includes the certain object being made of a ferromagnetic material. The annular member 23a is located on the rear side (−Z side) of a plurality of the magnets 23t constituting the magnet assembly 23b. A surface of the annular member 23a on the rear side is the surface of the rotor body 23 on the rear side.

As illustrated in FIG. 11, the annular member 23a is located on the front side (+Z side) of the mounting surface 22p of the plurality of first arms 22. The surface of the annular member 23a on the rear side (−Z side) comes into contact with the mounting surface 22p. The annular member 23a is located on the first arm 22b, between the holding wall 22g and the third protruding wall 22i in the radial direction. As illustrated in FIG. 8, the annular member 23a includes an annular body portion 23c, a plurality of outer protruding portions 23d, a first inner protruding portion 23e, and a second inner protruding portion 23f.

The annular body portion 23c has an annular shape surrounding the center axis J. More specifically, the annular body portion 23c has a circular annular shape having a center that coincides with the center axis J in a planar view in the axial direction. As illustrated in FIG. 11, the annular body portion 23c is located on the front side (+Z side) of the mounting surface 22p of the plurality of first arms 22. A surface of the annular body portion 23c on the rear side (−Z side) comes into contact with the mounting surface 22p. The annular body portion 23c is fixed to each first arm 22 via, for example, an adhesive provided in each groove 22q.

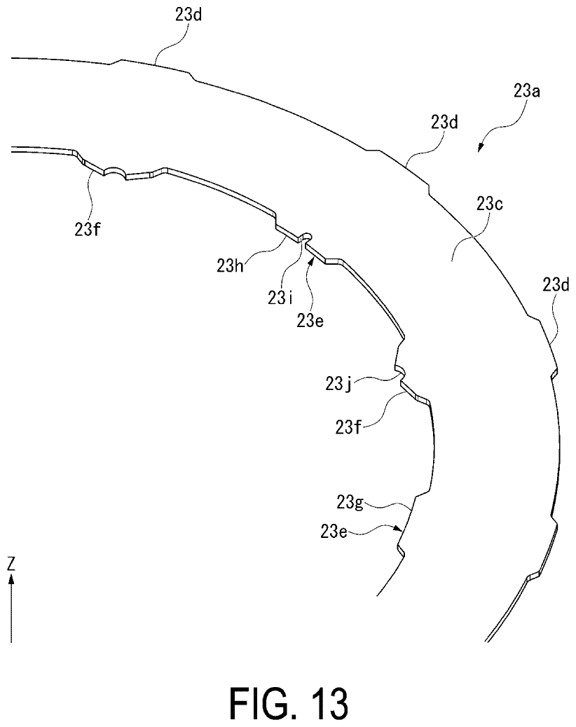

As illustrated in FIG. 8, the plurality of outer protruding portions 23d protrude from an outer circumferential edge of the annular body portion 23c toward the outer side in the radial direction. The plurality of outer protruding portions 23d are disposed spaced apart in the circumferential direction. The plurality of outer protruding portions 23d are disposed at equal intervals across the entire circumference in the circumferential direction. A number of the outer protruding portions 23d is the same as a number of the first arms 22. That is, in the present embodiment, twelve outer protruding portions 23d are provided. Note that the number of the outer protruding portions 23d is not particularly limited as long as the number is two or more. As illustrated in FIG. 13, the outer protruding portion 23d has a substantially trapezoidal shape in which a dimension in the circumferential direction decreases toward the outer side in the radial direction in a planar view in the axial direction. A dimension of the outer protruding portion 23d in the radial direction is smaller than the dimension of the outer protruding portion 23d in the circumferential direction. A radial outer edge of the outer protruding portion 23d has a circular arc shape having a center that coincides with the center axis J in a planar view in the axial direction.

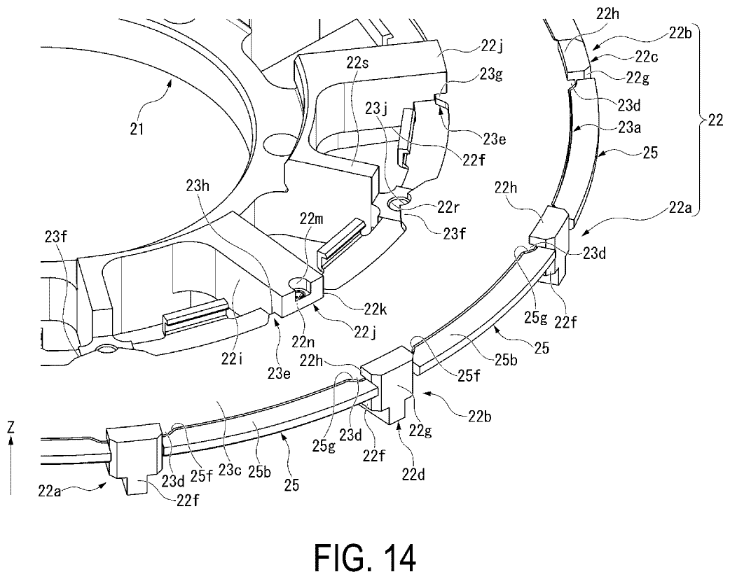

As illustrated in FIG. 14, the plurality of outer protruding portions 23d are respectively located on the rear side (−Z side) of the first protruding portions 22h of the plurality of first arms 22. Each outer protruding portion 23d is located between each arm body portion 22f and each first protruding portion 22h in the axial direction. The dimension of each outer protruding portion 23d in the circumferential direction is larger than a dimension of each first arm 22 in the circumferential direction. As illustrated in FIG. 11, the radial outer edge of each of the plurality of outer protruding portions 23d comes into contact with the holding surface 22t. Therefore, the annular member 23a is positioned in the radial direction relative to the first rotor frame 21. Apart of the rotor body 23 that comes into contact with the holding surfaces 22t is the annular member 23a, making it possible to suppress application of a load to the magnets 23t constituting the magnet assembly 23b as compared with a case in which the magnets 23t come into contact with the holding surfaces 22t. This makes it possible to suppress breakage of the magnets 23t.

The respective outer protruding portions 23d come into contact with respective surfaces of the first protruding portions 22h on the rear side (−Z side). As a result, movement of the outer protruding portions 23d toward the front side (+Z side) is suppressed. This suppresses movement of the annular member 23a toward the front side, and suppresses detachment of the rotor body 23 from the first rotor frame 21 in the axial direction. Further, the annular member 23a, not the magnets 23t constituting the magnet assembly 23b, can be pressed by the surfaces of the first protruding portions 22h on the rear side, making it possible to further suppress application of a load to the magnets 23t. This makes it possible to further suppress breakage of the magnets 23t. Note that the respective outer protruding portions 23d may face the respective surfaces of the first protruding portions 22h on the rear side with a gap therebetween. Even in this case, when the outer protruding portion 23d is about to move toward the front side, the outer protruding portion 23d is hooked by the first protruding portion 22h from the rear side. As a result, detachment of the rotor body 23 from the first rotor frame 21 in the axial direction is suppressed. The surface of the outer protruding portion 23d on the rear side comes into contact with the mounting surface 22p.

As illustrated in FIG. 8, the first inner protruding portion 23e and the second inner protruding portion 23f protrude from an inner circumferential edge of the annular body portion 23c toward the inner side in the radial direction. In the present embodiment, a plurality of the first inner protruding portions 23e and a plurality of the second inner protruding portions 23f are provided. The first inner protruding portions 23e and the second inner protruding portions 23f are alternately provided one by one spaced apart in the circumferential direction. The plurality of inner protruding portions including the plurality of first inner protruding portions 23e and the plurality of second inner protruding portions 23f are disposed at equal intervals across the entire circumference in the circumferential direction. The plurality of inner protruding portions including the plurality of first inner protruding portions 23e and the plurality of second inner protruding portions 23f are respectively provided on the inner side of the plurality of outer protruding portions 23d in the radial direction. A total sum of a number of the first inner protruding portions 23e and a number of the second inner protruding portions 23f is the same as the number of the first arms 22. In the present embodiment, six first inner protruding portions 23e and six second inner protruding portions 23f are provided. Note that the number of the first inner protruding portions 23e and the number of the second inner protruding portions 23f are not particularly limited as long as each is one or more.

As illustrated in FIG. 13, the first inner protruding portion 23e has a substantially trapezoidal shape in which a dimension in the circumferential direction decreases toward the inner side in the radial direction in a planar view in the axial direction. A dimension of the first inner protruding portion 23e in the radial direction is smaller than a dimension of the first inner protruding portion 23e in the circumferential direction. A maximum dimension of the first inner protruding portion 23e in the circumferential direction is, for example, the same as a maximum dimension of the outer protruding portion 23d in the circumferential direction. A radial inner edge of the first inner protruding portion 23e has a circular arc shape having a center that coincides with the center axis J in a planar view in the axial direction.

As illustrated in FIG. 14, the respective first inner protruding portions 23e are located on the rear side (−Z side) of the respective second protruding portions 22j of the respective first arms 22b. The respective first inner protruding portions 23e are located between the respective arm body portions 22f and the respective second protruding portions 22j of the respective first arms 22b in the axial direction. The dimension of each first inner protruding portion 23e in the circumferential direction is larger than a dimension of each first arm 22b in the circumferential direction. The respective first inner protruding portions 23e come into contact with the respective surfaces of the second protruding portions 22j on the rear side. As a result, movement of each first inner protruding portion 23e toward the front side (+Z side) is suppressed. This further suppresses movement of the annular member 23a toward the front side, and further suppresses detachment of the annular member 23a from the first rotor frame 21 in the axial direction. Note that the respective first inner protruding portions 23d may face the respective surfaces of the second protruding portions 22j on the rear side with a gap therebetween. Even in this case, when the first inner protruding portion 23e is about to move toward the front side, the first inner protruding portion 23e is hooked by the second protruding portion 22j from the rear side. Asa result, detachment of the annular member 23a from the first rotor frame 21 in the axial direction is further suppressed. A surface of the first inner protruding portion 23e on the rear side comes into contact with the mounting surface 22p.

As illustrated in FIG. 8, the plurality of first inner protruding portions 23e include a first inner protruding portion 23g and a first inner protruding portion 23h. A pair of the first inner protruding portions 23h are provided with the center axis J interposed therebetween in the radial direction. In the present embodiment, among the six first inner protruding portion 23e, four first inner protruding portion 23e other than the pair of first inner protruding portions 23h are the first inner protruding portions 23g. The first inner protruding portion 23g has a configuration similar to that of the first inner protruding portion 23h except for not including a first penetrating portion 23i described below.

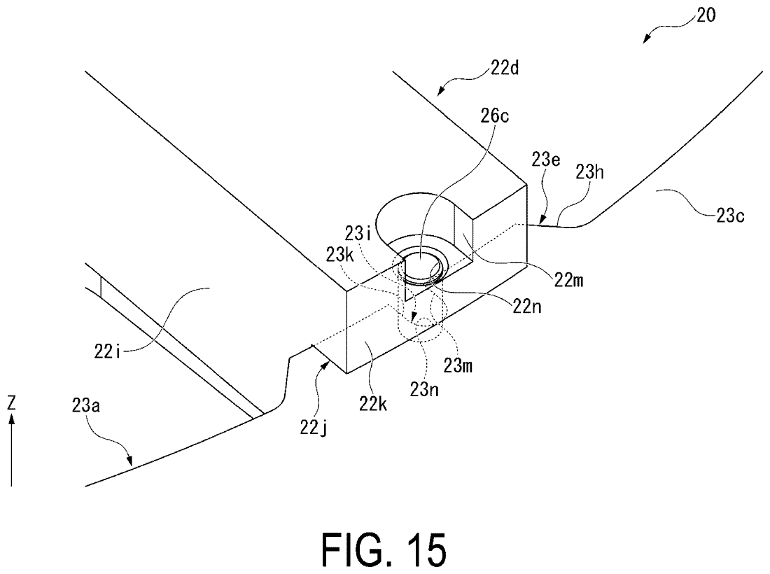

As illustrated in FIG. 13, the first inner protruding portion 23h includes the first penetrating portion 23i that passes through the first inner protruding portion 23h in the axial direction. In the present embodiment, the first penetrating portion 23i is a recess portion recessed from a center portion in the circumferential direction of a radial inner edge of the first inner protruding portion 23h toward the outer side in the radial direction. As illustrated in FIG. 15, an inner edge of the first penetrating portion 23i includes a pair of circumferential edge portions 23k, 23m and a radial outer edge portion 23n. The pair of circumferential edge portions 23k, 23m are parts of the inner edge of the first penetrating portion 23i that are located on both sides in the circumferential direction. The pair of circumferential edge portions 23k, 23m extend in, among the radial directions, a radial direction passing through a center of the first inner protruding portion 23h in the circumferential direction and are parallel to each other in a planar view in the axial direction. The radial outer edge portion 23n is a part of the inner edge of the first penetrating portion 23i that is located on the outer side in the radial direction. The radial outer edge portion 23n has a semicircular arc shape recessed toward the outer side in the radial direction in a planar view in the axial direction. The radial outer edge portion 23n connects end portions of the pair of circumferential edge portions 23k, 23m on the outer sides in the radial direction.

The first penetrating portion 23i is located on the rear side (−Z side) of the second penetrating portion 22n provided in the second protruding portion 22k. The first penetrating portion 23i and the second penetrating portion 22n at least partially overlap each other in a planar view in the axial direction. In the present embodiment, the second penetrating portion 22n as a whole overlaps part of the first penetrating portion 23i in a planar view in the axial direction. A pin member 26c extending in the axial direction is passed through the first penetrating portion 23i and the second penetrating portion 22n. In the present embodiment, the pin member 26c is a cylindrical member extending in the axial direction. In the present embodiment, the pin member 26c is passed through the second penetrating portion 22n from the front side (+Z side) and inserted into the first penetrating portion 23i from the front side. The pin member 26c comes into contact with parts of the inner edge of the first penetrating portion 23i that are located on both sides in the circumferential direction, that is, the pair of circumferential edge portions 23k, 23m, and parts of the inner edge of the second penetrating portion 22n that are located on both sides in the circumferential direction. Therefore, the first inner protruding portion 23h and the second protruding portion 22k are positioned in the circumferential direction via the pin member 26c. As a result, the annular member 23a is positioned in the circumferential direction relative to the first rotor frame 21. Accordingly, displacement of the annular member 23a relative to the first rotor frame 21 in the circumferential direction is suppressed. In the present embodiment, the pin member 26c is press-fitted inside the first penetrating portion 23i and inside the second penetrating portion 22n. As illustrated in FIG. 11, a rear end of the pin member 26c on the rear side comes into contact with a circumferential edge portion of the recess portion 22y of the mounting surface 22p.

As illustrated in FIG. 13, a dimension of the second inner protruding portion 23f in the circumferential direction decreases toward the inner side in the radial direction. A dimension of the second inner protruding portion 23f in the radial direction is smaller than the maximum dimension of the second inner protruding portion 23f in the circumferential direction. A maximum dimension of the second inner protruding portion 23f in the circumferential direction is, for example, the same as the maximum dimension of the outer protruding portion 23d in the circumferential direction. A radial inner edge of the second inner protruding portion 23f includes a circular arc portion 23j having a circular arc shape recessed toward the outer side in the radial direction in a planar view in the axial direction. In the present embodiment, the circular arc portion 23j is provided at a center portion, in the circumferential direction, of the radial inner edge of the second inner protruding portion 23f.

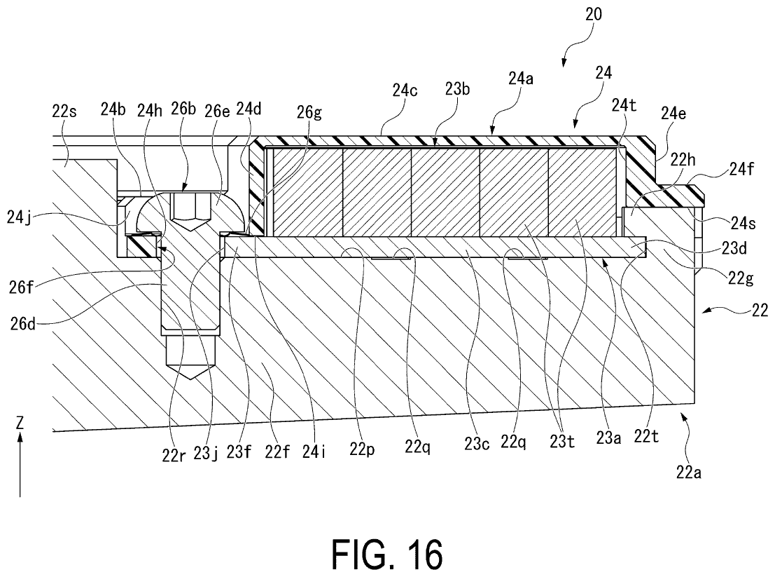

As illustrated in FIG. 14, the respective second inner protruding portions 23f are located on the front side (+Z side) of the respective arm body portions 22f of the first arms 22a. The maximum dimension of each second inner protruding portion 23f in the circumferential direction is larger than a dimension of each first arm 22a in the circumferential direction. The circular arc portion 23j is, in a planar view in the axial direction, disposed at a position substantially overlapping a part of an inner edge of the threaded hole 22r provided in the first arm 22a, the part being located on the outer side in the radial direction. As illustrated in FIG. 16, a surface of the second inner protruding portion 23f on the rear side (−Z side) comes into contact with the mounting surface 22p of the first arm 22a.

As illustrated in FIG. 12, the magnet assembly 23b has an annular shape surrounding the center axis J. More specifically, the magnet assembly 23b has a circular annular shape having a center that coincides with the center axis J in a planar view in the axial direction. The magnet assembly 23b is configured by combining the plurality of magnets 23t. That is, the rotor body 23 includes the plurality of magnets 23t. The magnet assembly 23b is located on the front side (+Z side) of the annular member 23a. The magnet assembly 23b is fixed to a surface of the annular member 23a on the front side. More specifically, the magnet assembly 23b is fixed to the surface of the annular member 23a that is on the front side of the annular body portion 23c. That is, the plurality of magnets 23t are fixed to the annular body portion 23c. The plurality of magnets 23t are fixed to the annular body portion 23c by, for example, an adhesive. An inner circumferential edge of the magnet assembly 23b is located outward of the inner circumferential edge of the annular body portion 23c in the radial direction. An outer circumferential edge of the magnet assembly 23b is located outward of the outer circumferential edge of the annular body portion 23c in the radial direction.

The magnet assembly 23b includes a plurality of first magnet assemblies 23p and a plurality of second magnet assemblies 23q. The first magnet assemblies 23p and the second magnet assemblies 23q are alternately disposed one by one in the circumferential direction. The first magnet assembly 23p and the second magnet assembly 23q adjacent to each other in the circumferential direction come into contact with each other. The first magnet assembly 23p has a substantially trapezoidal shape in which a dimension in the circumferential direction decreases toward the inner side in the radial direction in a planar view in the axial direction. The second magnet assembly 23q has a substantially rectangular shape long in the radial direction in a planar view in the axial direction. A dimension of the second magnet assembly 23q in the circumferential direction is smaller than the dimension of the first magnet assembly 23p in the circumferential direction.

In the present embodiment, each first magnet assembly 23p is configured by combining a plurality of first magnets 23r arranged in the radial direction. In the present embodiment, each second magnet assembly 23q is configured by combining a plurality of second magnets 23s arranged in the radial direction. That is, the plurality of magnets 23t include the plurality of first magnets 23r and the plurality of second magnets 23s. Each first magnet assembly 23p is configured by coupling five first magnets 23r in the radial direction. Each second magnet assembly 23q is configured by coupling five second magnets 23s in the radial direction. The five first magnets 23r constituting one first magnet assembly 23p are respectively coupled to the five second magnets 23s constituting each second magnet assembly 23q disposed adjacent to both sides of the first magnet assembly 23s in the circumferential direction. In the present embodiment, the magnet assembly 23b is configured by arranging, in the radial direction, five annular magnet assemblies 23u, each having an annular shape formed by alternately arranging the first magnets 23r and the second magnets 23s one by one in the circumferential direction. An outer diameter of the annular magnet assembly 23u increases for each of the annular magnet assemblies 23u located further toward the outer side in the radial direction.

The plurality of magnets 23t have, at least in part or in whole, a magnetization direction in the axial direction. In the present embodiment, some magnets 23t among the plurality of magnet 23t have a magnetization direction in the axial direction. The plurality of first magnets 23r have a magnetization direction in the axial direction. The plurality of second magnets 23s have magnetization directions in directions intersecting the axial direction. The plurality of second magnets 23s have magnetization directions in, for example, directions inclined in the circumferential direction relative to the axial direction. In each annular magnet assembly 23u, the magnetization directions of the two second magnets 23s positioned sandwiching one first magnet 23r in the circumferential direction are, for example, directions inclined toward different sides in the circumferential direction relative to the axial direction.

In the present embodiment, the plurality of magnets 23t constituting the magnet assembly 23b are arranged in a Halbach array. The Halbach array in which the plurality of magnets 23t are arranged is an array capable of maximizing a magnetic field strength toward the side where the stator 50 is located relative to the first rotor 20 in the axial direction, that is, the front side (+Z side). In each of the above-described five annular magnet assemblies 23u constituting the magnet assembly 23b, the plurality of first magnets 23r and the plurality of second magnets 23s are arranged in the circumferential direction in the Halbach array. By arranging the plurality of magnets 23t in the Halbach array, it is possible to increase a density of magnetic fluxes flowing between the first rotor 20 and the stator 50. This makes it possible to improve an output torque of the motor 100. The plurality of magnets 23t may be bonded to each other by, for example, an adhesive or the like. Note that the plurality of magnets 23t need not be arranged in a Halbach array. The magnetization direction of all magnets 23t may be the axial direction.

As illustrated in FIG. 8, the first cover 24 has an annular shape surrounding the center axis J. More specifically, the first cover 24 has a substantially circular annular shape having a center that coincides with the center axis J in a planar view in the axial direction. The first cover 24 is fixed to the first rotor frame 21. The first cover 24 is located on the front side (+Z side) of the magnet assembly 23b. The first cover 24 covers at least part of a surface of each magnet 23t facing the front side. This makes it possible for the first cover 24 to suppress movement of the magnets 23t to the front side (+Z side) in the axial direction, that is, the side where the stator 50 is located relative to the first rotor 20. As a result, contact of the magnets 23t with the stator 50 is suppressed. Accordingly, a stability of the operation of the motor 100 can be improved. Further, because the movement of the magnets 23t toward the stator 50 can be suppressed, when a size of a gap, that is, a size of an air gap, between the first rotor 20 and the stator 50 in the axial direction is determined, it is no longer necessary to increase the air gap in consideration of the movement of the magnets 23t in the axial direction. The air gap is therefore readily reduced, and a magnetic force generated between the magnets 23t and the stator 50 is readily increased. Accordingly, the output torque of the motor 100 is readily improved.

In the present embodiment, the first cover 24 covers each surface, facing the front side (+Z side), of the plurality of magnets 23t constituting the magnet assembly 23b, as a whole. This makes it possible to further suppress the movement of the plurality of magnets 23t to the front side, and further suppress contact of the plurality of magnets 23t with the stator 50.

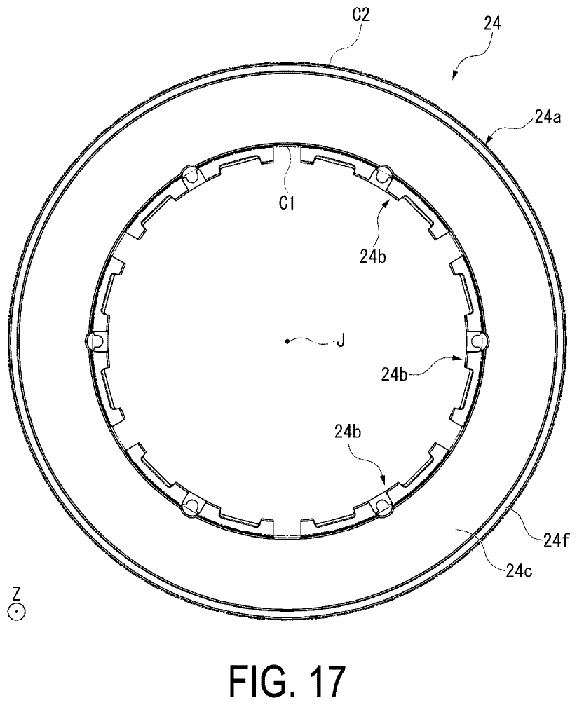

As illustrated in FIG. 17, the first cover 24 includes an annular portion 24a and a fixed portion 24b. In a planar view in the axial direction, the annular portion 24a has an annular shape surrounded inwardly and outwardly by two concentric circles C1, C2. The two concentric circles C1, C2 are imaginary circles indicated by dot-dash lines in FIG. 17. In a planar view in the axial direction, a center of the two concentric circles C1, C2 coincides with the center axis J. A diameter of the concentric circle C2 is larger than a diameter of the concentric circle C1. An inner circumferential edge of the annular portion 24a overlaps the concentric circle C1 in a planar view in the axial direction. An outer circumferential edge of the annular portion 24a overlaps the concentric circle C2 in a planar view in the axial direction. When a difference in radius between the two concentric circles C1, C2 is referred to as a width of the annular portion 24a, the width of the annular portion 24a is larger than a height of the first cover 24 as a whole in the axial direction, as illustrated in FIG. 8. The width of the annular portion 24a is a distance in the radial direction between the inner circumferential edge of the annular portion 24a and the outer circumferential edge of the annular portion 24a.

As illustrated in FIG. 16, the annular portion 24a includes a first top plate portion 24c, an inner wall 24d, an outer wall 24e, and a flange portion 24f. That is, the first cover 24 includes the first top plate portion 24c, the inner wall 24d, the outer wall 24e, and the flange portion 24f. The first top plate portion 24c is located on the front side (+Z side) of the magnet assembly 23b. The first top plate portion 24c is a top plate portion that covers at least part of the surfaces of the plurality of magnets 23t facing the front side. In the present embodiment, the first top plate portion 24c covers each surface, facing the front side (+Z side), of the plurality of magnets 23t constituting the magnet assembly 23b, as a whole. The first top plate portion 24c has a plate shape with a plate surface facing the axial direction. A surface of the first top plate portion 24c on the rear side (−Z side) faces, in the axial direction, the surfaces of the plurality of magnets 23t facing the front side, with a gap interposed therebetween. The surface of the first top plate portion 24c on the rear side may come into contact with the surfaces of the plurality of magnets 23t facing the front side. As illustrated in FIG. 17, the first top plate portion 24c has an annular shape surrounding the center axis J. More specifically, the first top plate portion 24c has a substantially circular annular shape having a center that coincides with the center axis J in a planar view in the axial direction.

As illustrated in FIG. 7, the inner wall 24d protrudes from an inner circumferential edge of the first top plate portion 24c toward the rear side (−Z side). The inner wall 24d has a tubular shape surrounding the center axis J. More specifically, the inner wall 24d has a substantially cylindrical shape having a center that coincides with the center axis J in a planar view in the axial direction. As illustrated in FIG. 16, the inner wall 24d is located on the inner side of the rotor body 23 in the radial direction. In the present embodiment, the inner wall 24d is located on the inner side of the magnet assembly 23b in the radial direction. An outer circumferential surface of the inner wall 24d faces the inner side, in the radial direction, of the inner circumferential surface of the magnet assembly 23b with a gap therebetween. The outer circumferential surface of the inner wall 24d may come into contact with the inner circumferential surface of the magnet assembly 23b. The outer circumferential surface of the inner wall 24d is located inward, in the radial direction, of the inner circumferential edge of the annular body portion 23c.

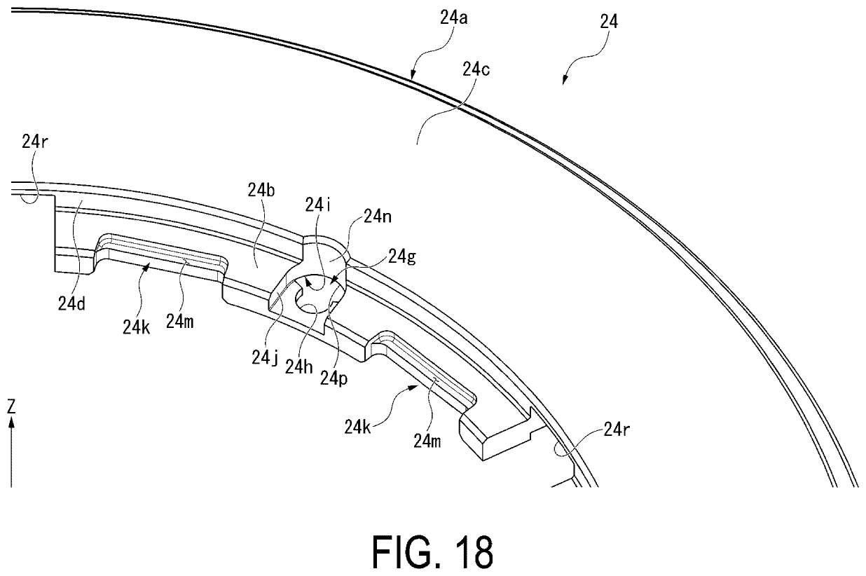

An end portion of the inner wall 24d on the rear side (−Z side) is located on the front side (+Z side) of the annular member 23a. More specifically, the end portion of the inner wall 24d on the rear side is located on the front side of the plurality of first inner protruding portions 23e and the plurality of second inner protruding portions 23f. As illustrated in FIG. 18, an axial recess portion 24r recessed toward the front side is provided in a part of the end portion of the inner wall 24d on the rear side to which the fixed portion 24b is not connected.

The inner wall 24d includes, in an inner circumferential surface, a radial recess portion 24n recessed toward the outer side in the radial direction. The radial recess portion 24n extends in the axial direction from an end portion on the front side (+Z side) to the end portion on the rear side (−Z side) of the inner wall 24d. In a planar view in the axial direction, an inner edge of the radial recess portion 24n has a circular arc shape recessed toward the outer side in the radial direction. The radial recess portion 24n is provided at the same position in the circumferential direction as a through-hole 24g, described below, provided in the fixed portion 24b.

As illustrated in FIG. 7, the outer wall 24e protrudes from an outer circumferential edge of the first top plate portion 24c toward the rear side (−Z side). The outer wall 24e has a tubular shape surrounding the center axis J. More specifically, the outer wall 24e has a cylindrical shape about the center axis J. As illustrated in FIG. 16, the outer wall 24e is located on the outer side of the rotor body 23 in the radial direction. In the present embodiment, the outer wall 24e is located on the outer side of the magnet assembly 23b in the radial direction. An inner circumferential surface of the outer wall 24e faces an outer circumferential surface of the magnet assembly 23b with a gap therebetween. The inner circumferential surface of the outer wall 24e may come into contact with the outer circumferential surface of the magnet assembly 23b. The inner circumferential surface of the outer wall 24e is located outward of the outer circumferential edge of the annular body portion 23c in the radial direction. The outer wall 24e is located on the front side (+Z side) of the first protruding portion 22h.

As illustrated in FIG. 7, the flange portion 24f protrudes toward the outer side, in the radial direction, of an end portion of the outer wall 24e on the rear side (−Z side). The flange portion 24f has an annular shape surrounding the center axis J. More specifically, the flange portion 24f has a circular annular shape having a center that coincides with the center axis J in a planar view in the axial direction. As illustrated in FIG. 16, a surface of the flange portion 24f on the rear side is located on the front side (+Z side) of the holding wall 22g.

The first cover 24 includes a first cover recess portion 24t on the rear side (−Z side). The first cover recess portion 24t is a part formed by recessing a center portion, in a width direction, of the annular portion 24a toward the front side (+Z side). The first cover recess portion 24t is constituted by the first top plate portion 24c, the inner wall 24d, and the outer wall 24e. The first cover recess portion 24t extends along the annular portion 24a and surrounds the center axis J. By providing the first cover recess portion 24t, it is possible to provide a part for fixing the first cover 24 to the first rotor frame 21 on the inner side in the radial direction or the outer side in the radial direction of the annular portion 24a while accommodating the magnet assembly 23b inside the first cover recess portion 24t. In the present embodiment, the fixed portion 24b is provided on the inner side of the annular portion 24a in the radial direction. The fixed portion 24b can be disposed rearward of an end portion of the annular portion 24a on the front side and thus, even in a case in which the fixed portion 24b is fixed by a bolt 26b, it is possible to suppress protrusion of a head portion 26e of the bolt 26e frontward of an end portion of the first cover 24 on the front side. In the present embodiment, a part of the magnet assembly 23b on the front side is located inside the first cover recess portion 24t.

As illustrated in FIG. 7, the first cover 24 includes a plurality of accommodation recess portions 24s recessed from the end portion of the outer wall 24e on the rear side (−Z side) and an end portion of the flange portion 24f on the rear side toward the front side (+Z side). The plurality of accommodation recess portions 24s are disposed spaced apart in the circumferential direction. A number of the accommodation recess portions 24s is the same as the number of the first arms 22. As illustrated in FIG. 16, an interior of each accommodation recess portion 24s opens to the inner side in the radial direction and to the outer side in the radial direction. A part of the holding wall 22g on the front side and the first protruding portion 22h of each first arm 22 are located in the interior of each accommodation recess portion 24s. A surface of an inner surface of each accommodation recess portion 24s that is located on the front side comes into contact with a surface of each holding wall 22g on the front side and a surface of each first protruding portion 22h on the front side. The surface of the inner surface of each accommodation recess portion 24s that is located on the front side is fixed to, for example, each holding wall 22g and each first protruding portion 22h with an adhesive or the like.

As illustrated in FIG. 7, the fixed portion 24b protrudes from the end portion of the inner wall 24d on the rear side (−Z side) toward the inner side in the radial direction. The fixed portion 24b extends in the circumferential direction. A plurality of the fixed portions 24b are provided spaced apart in the circumferential direction. In the present embodiment, six fixed portions 24b are provided. A center portion of each fixed portion 24b in the circumferential direction is located on the front side (+Z side) of the first arm 22a. Each of the fixed portions 24b is disposed between, in the circumferential direction, two first arms 22b disposed with the first arm 22a interposed therebetween. As illustrated in FIG. 18, the fixed portion 24b includes a recess portion 24j recessed from a surface of the fixed portion 24b on the front side toward the rear side. The recess portion 24j is provided at the center portion of the fixed portion 24b in the circumferential direction. An interior of the recess portion 24j opens to the inner side in the radial direction. An end portion of the recess portion 24j on the outer side in the radial direction is connected to the radial recess portion 24n provided in the inner wall 24d.

The fixed portion 24b includes the through-hole 24g penetrating the fixed portion 24b in the axial direction. The through-hole 24g is provided at the center portion of the fixed portion 24b in the circumferential direction. The through-hole 24g is provided in the recess portion 24j. The through-hole 24g opens to a surface of an inner surface of the recess portion 24j, the surface being located on the rear side (−Z side). The through-hole 24g includes a first hole portion 24h and a second hole portion 24i. The first hole portion 24h is a part of the through-hole 24g on the inner side in the radial direction. The first hole portion 24h has a circular arc shape in which an inner edge is recessed toward the inner side in the radial direction in a planar view in the axial direction. The inner edge of the first hole portion 24h has a circular arc shape having a central angle larger than 180° in a planar view in the axial direction.

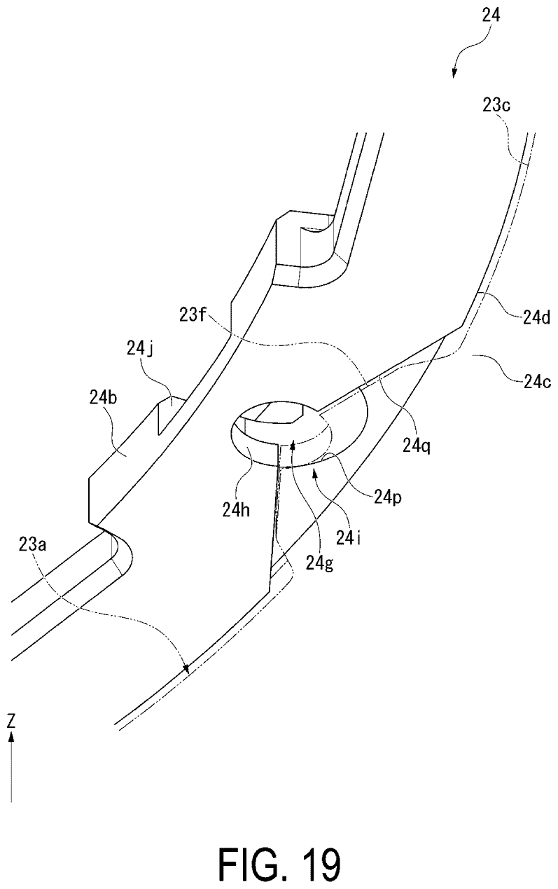

The second hole portion 24i is located on the outer side of the first hole portion 24h in the radial direction. The second hole portion 24i is connected to the first hole portion 24h. A dimension of the second hole portion 24i in the circumferential direction is larger than a dimension of the first hole portion 24h in the circumferential direction. As illustrated in FIG. 19, the second hole portion 24i includes a first opening portion 24p and a second opening portion 24q. The first opening portion 24p is an opening portion on the front side (+Z side) of the second hole portion 24i. As illustrated in FIG. 18, the first opening portion 24p opens to a surface of the inner surface of the recess portion 24j, the surface being located on the rear side (−Z side). A part of an inner edge of the first opening portion 24p that is located on the outer side in the radial direction has a circular arc shape recessed toward the outer side in the radial direction in a planar view in the axial direction.

As illustrated in FIG. 19, the second opening portion 24q is an opening portion on the rear side (−Z side) of the second hole portion 24i. An end portion of the second opening portion 24q on the outer side in the radial direction is located outward, in the radial direction, of the end portion of the first opening portion 24p on the outer side in the radial direction. The second opening portion 24q is provided across the fixed portion 24b and the inner wall 24d. The second opening portion 24q opens to a surface of the fixed portion 24b on the rear side, a surface of the inner wall 24d on the rear side, and the outer circumferential surface of the inner wall 24d. The second hole portion 24i opens to a surface of the inner wall 24d on the outer side in the radial direction, at the second opening portion 24q. The second hole portion 24i, as a whole, excluding the first opening portion 24p, opens to the surface of the inner wall 24d on the outer side in the radial direction. A dimension of the second opening portion 24q in the circumferential direction increases toward the outer side in the radial direction. At least part of the second inner protruding portion 23f is located in the second hole portion 24i. In the present embodiment, the second inner protruding portion 23f is, as a whole, located in the second hole portion 24i.

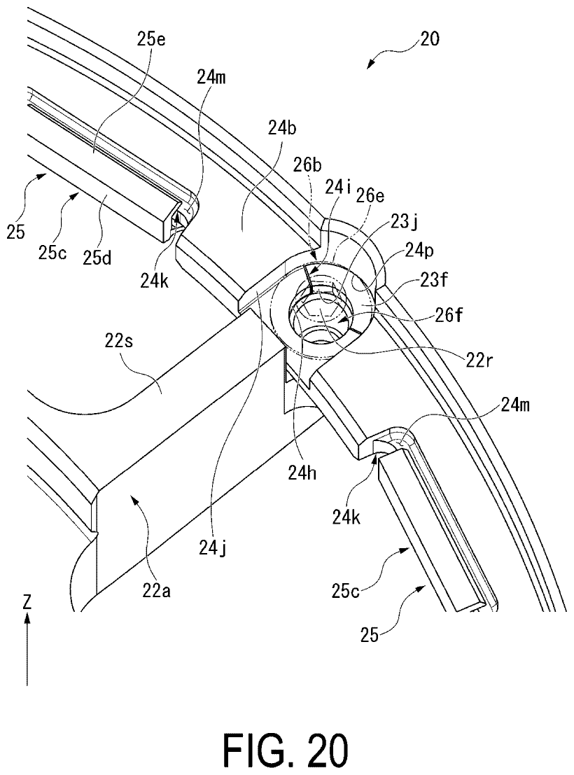

As illustrated in FIG. 20, a part of the second inner protruding portion 23f located inside the second hole portion 24i, the part being on the outer side in the radial direction, overlaps the first opening portion 24p in a planar view in the axial direction. A surface of the second inner protruding portion 23f on the front side (+Z side) is provided at the same position in the axial direction as that of a surface located on the rear side (−Z side) of the inner surface of the recess portion 24j. The circular arc portion 23j provided at the radial inner edge of the second inner protruding portion 23f is located on the outer side of the first hole portion 24h in the radial direction. The inner edge of the first hole portion 24h and the circular arc portion 23j constitute a bolt through-hole 26f through which the bolt 26b is passed from the front side. The bolt through-hole 26f has a circular shape in a planar view in the axial direction. As illustrated in FIG. 16, the bolt 26b is passed through the bolt through-hole 26f and fastened into the threaded hole 22r provided in the first arm 22a. The fixed portion 24b is fixed to the first arm 22a by the bolt 26b.

The bolt 26b includes a threaded portion 26d that meshes with a threaded portion of the threaded hole 22r, and the head portion 26e connected to an end portion of the threaded portion 26d on the front side (+Z side). The threaded portion 26d extends in the axial direction. The threaded portion 26d is passed through the bolt through-hole 26f in the axial direction from the front side and is fastened into the threaded hole 22r. An outer diameter of the head portion 26e is larger than an outer diameter of the threaded portion 26d. As illustrated in FIG. 20, the head portion 26e is located on the front side of a part of the fixed portion 24b where the recess portion 24j is provided and a part of the second inner protruding portion 23f located inside the second hole portion 24i that overlaps the first opening portion 24p in the axial direction. The head portion 26e of the bolt 26b presses the fixed portion 24b and the second inner protruding portion 23f against the first arm 22a from the front side. Therefore, the fixed portion 24b and the second inner protruding portion 23f are fixed to the first arm 22a by the bolt 26b. Accordingly, the first cover 24 and the annular member 23a can be firmly fixed to the first arms 22a, and movement of the first cover 24 and the rotor body 23 can be suitably suppressed in the axial direction relative to the first rotor frame 21. Further, the annular member 23a can be fixed to the first arms 22b by utilizing the bolts 26b that fix the first cover 24 to the first arms 22a, eliminating the need to separately provide bolts for fixing the annular member 23a to the first arms 22a. Accordingly, an increase in a number of components of the motor 100 can be suppressed. The annular member 23a is fixed to the first arms 22a, thereby fixing the plurality of magnets 23t fixed to the annular member 23a indirectly to the first rotor frame 21. As illustrated in FIG. 16, a surface of the fixed portion 24b on the rear side (−Z side) comes into contact with the mounting surface 22p of the first arm 22a.

A washer 26g having an annular shape surrounding the threaded portion 26d is provided in the axial direction between the head portion 26e and the fixed portion 24b as well as the second inner protruding portion 23f. In the present embodiment, the washer 26g is a wave washer. The washer 26g comes into contact with a surface of the inner surface of the recess portion 24j that is located on the rear side (−Z side), a surface of the second inner protruding portion 23f on the front side (+Z side), and a surface of the head portion 26e on the rear side. The washer 26g is pressed toward the rear side by the head portion 26e and is elastically deformed. With the washer 26g being a wave washer, an elastic force of the washer 26g can be utilized to more firmly press the fixed portion 24b and the second inner protruding portion 23f against the first arm 22a. The head portion 26e is located in the interior of the recess portion 24j. With the recess portion 24j being provided, it is possible to further suppress the locating of the head portion 26e frontward of the end portion of the first cover 24 on the front side.

As illustrated in FIG. 18, the fixed portion 24b includes a hooking portion 24k at a radial inner edge of the fixed portion 24k. The hooking portion 24k is located outward, in the radial direction, of a part of the radial inner edge of the fixed portion 24b excluding the part where the hooking portion 24k is provided. The hooking portion 24k extends in the circumferential direction. The hooking portion 24k includes a hooking surface 24m facing the front side (+Z side). The hooking surface 24m is located rearward (−Z side) of a surface on the front side of a part of the fixed portion 24b that is adjacent to the outer side of the hooking portion 24k in the radial direction and parts adjacent to both sides of the hooking portion 24k in the circumferential direction. The hooking surface 24m extends in the circumferential direction. The hooking surface 24m is a surface orthogonal to the axial direction. In the present embodiment, two hooking portions 24k are provided on one fixed portion 24b. One hooking portion 24k is provided at a part of the fixed portion 24b that is located on one side of the through-hole 24g in the circumferential direction. The other hooking portion 24k is provided at a part of the fixed portion 24b that is located on the other side of the through-hole 24g in the circumferential direction.

The first cover 24 is made of a non-magnetic material. In the present embodiment, the first cover 24 is made of a resin. More specifically, the first cover 24 is made of a fiber reinforced plastic. As a result, a rigidity of the first cover 24 can be improved while suppressing an increase in a mass of the first cover 24. This makes it possible to improve a rigidity of the first rotor 20 and suppress bending of the first rotor 20 in the axial direction even when a magnetic force acts between the first rotor 20 and the stator 50. Accordingly, this make it possible to suppress fluctuation in an interval in the axial direction between the first rotor 20 and the stator 50, and stabilize the magnetic force acting between the first rotor 20 and the stator 50. Examples of the fiber reinforced plastic constituting the first cover 24 include a carbon fiber reinforced plastic (CFRP).

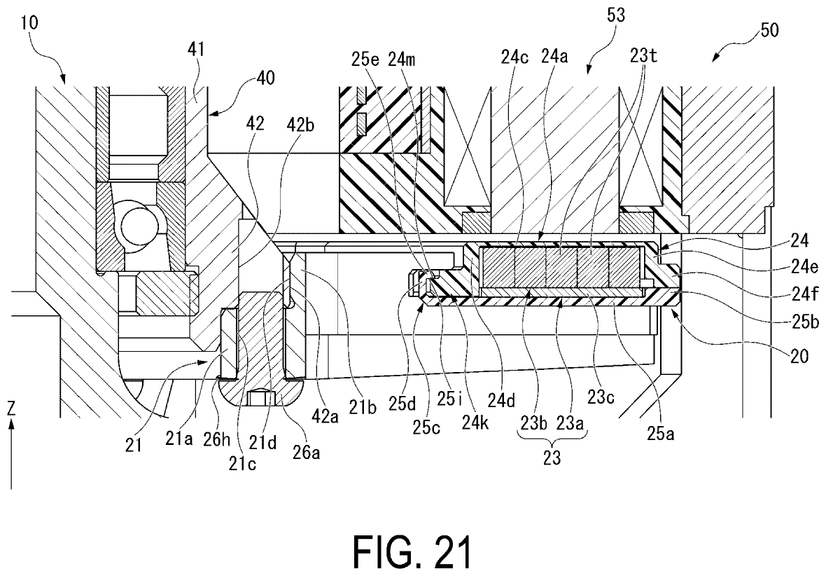

As illustrated in FIG. 8, the plurality of second covers 25 are disposed on the rear side (−Z side) of the rotor body 23. The plurality of second covers 25 are disposed spaced apart in the circumferential direction. The plurality of second covers 25 are disposed at equal intervals across the entire circumference in the circumferential direction. As illustrated in FIG. 14, the plurality of second covers 25 are respectively located between the first arms 22 adjacent to each other in the circumferential direction. Each second cover 25 comes into contact with the first arms 22 adjacent to each other on both sides in the circumferential direction. Note that each second cover 25 need not come into contact with the first arms 22 adjacent to each other on both sides in the circumferential direction. As illustrated in FIG. 21, each second cover 25 covers at least part of the surface of the rotor body 23 on the rear side. In the present embodiment, each second cover 25 covers a surface, on the rear side, of each part of the annular member 23a that is located between, in the circumferential direction, the first arms 22 adjacent to each other in the circumferential direction. In the present embodiment, the surface of the rotor body 23 on the rear side is covered as a whole by the plurality of first arms 22 and the plurality of second covers 25. The second covers 25 are fixed to the first cover 24. With the second cover 25 being provided, it is possible to further improve the rigidity of the first rotor 20. This makes it possible to further improve the rigidity of the first rotor 20 and further suppress the bending of the first rotor 20 in the axial direction even when a magnetic force acts between the first rotor 20 and the stator 50. Accordingly, this make it possible to further suppress the fluctuation in the interval in the axial direction between the first rotor 20 and the stator 50, and further stabilize the magnetic force acting between the first rotor 20 and the stator 50. Note that the second covers 25 may be fixed to the first rotor frame 21 instead of the first cover 24, or may be fixed to both the first rotor frame 21 and the first cover 24. Even in this case, the rigidity of the first rotor 20 can be further improved, and the magnetic force acting between the first rotor 20 and the stator 50 can be further stabilized.

The second cover 25 is made of a non-magnetic material. In the present embodiment, the second cover 25 is made of a resin. More specifically, the second cover 25 is made of a fiber reinforced plastic. As a result, a rigidity of the second cover 25 can be improved while suppressing an increase in a mass of the second cover 25. This makes it possible to further improve the rigidity of the first rotor 20 and further suppress the bending of the first rotor 20 in the axial direction. Accordingly, this make it possible to further suppress the fluctuation in the interval in the axial direction between the first rotor 20 and the stator 50, and further stabilize the magnetic force acting between the first rotor 20 and the stator 50. Examples of the fiber reinforced plastic constituting the second cover 25 include a carbon fiber reinforced plastic.

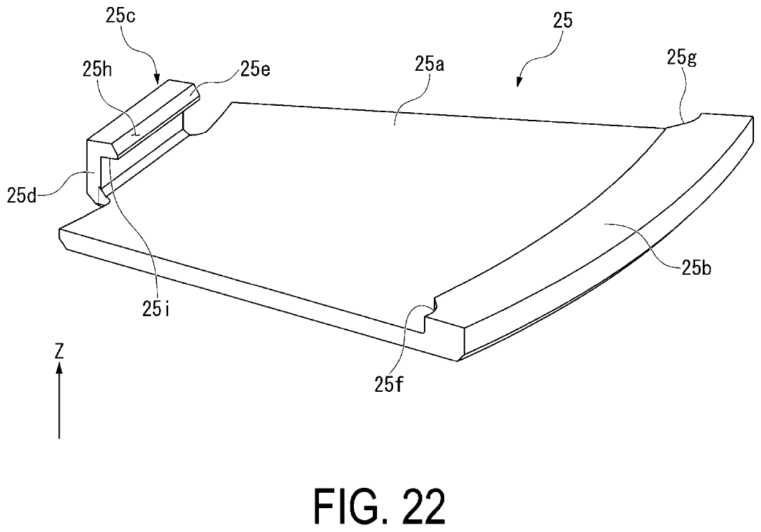

As illustrated in FIG. 22, the second cover 25 includes a bottom plate portion 25a, a fixed wall 25b, and a claw 25c. The bottom plate portion 25a has a fan shape about the center axis J in a planar view in the axial direction. In the present specification, a center of the fan shape is the center of a circle obtained by virtually extending a circular arc portion of the fan shape. In the present specification, the “fan shape” includes a shape surrounded by two arcs having the same center of curvature but different radii and two line segments extending in the radial direction of a circle about the center of curvature and connecting both ends of the two arcs. In the present embodiment, the bottom plate portion 25a has a shape surrounded by two arcs having the same center of curvature but different radii and two line segments extending in the radial direction of a circle about the center of curvature and connecting both ends of the two arcs in a planar view in the axial direction. A dimension of the bottom plate portion 25a in the circumferential direction increases toward the outer side in the radial direction. As illustrated in FIG. 21, the bottom plate portion 25a covers part of the surface of the rotor body 23 on the rear side (−Z side). A surface of the bottom plate portion 25a on the front side (+Z side) comes into contact with the surface, on the rear side, of the annular body portion 23a of the annular member 23c.

The fixed wall 25b protrudes from a radial outer edge of the bottom plate portion 25a toward the first cover 24 toward the front side (+Z side). The fixed wall 25b is located on the outer side of the rotor body 23 in the radial direction. In the present embodiment, the fixed wall 25b is located on the outer side of the annular body portion 23c in the radial direction. The fixed wall 25b faces a radial outer edge of the annular body portion 23c with a gap interposed therebetween. The fixed wall 25b may come into contact with the radial outer edge of the annular body portion 23c. In the present embodiment, a surface of the fixed wall 25b on the front side is provided at substantially the same position in the axial direction as that of the surface of the annular member 23a on the front side.

An end surface of the fixed wall 25b on the front side (+Z side) comes into contact with the surface of the flange portion 24f on the rear side (−Z side). The end surface of the fixed wall 25b on the front side is fixed to the surface of the flange portion 24f on the rear side. Accordingly, the fixed wall 25b is fixed to the first cover 24. With the fixed wall 25b being provided, it is possible to improve the rigidity of the second cover 25. This makes it possible to further improve the rigidity of the first rotor 20 and further suppress the bending of the first rotor 20 in the axial direction. Accordingly, this make it possible to further suppress the fluctuation in the interval in the axial direction between the first rotor 20 and the stator 50, and further stabilize the magnetic force acting between the first rotor 20 and the stator 50. In the present embodiment, as described above, the plurality of second covers 25 are respectively located between the first arms 22 adjacent to each other in the circumferential direction. As a result, the rigidity of the first rotor 20 can be further improved by the plurality of second covers 25. This make it possible to further suppress the fluctuation in the interval in the axial direction between the first rotor 20 and the stator 50, and further stabilize the magnetic force acting between the first rotor 20 and the stator 50. A fixing method for fixing the fixed wall 25b and the flange portion 24f is not particularly limited. The fixed wall 25b and the flange portion 24f may be fixed to each other by an adhesive or may be fixed to each other by welding.

As illustrated in FIG. 22, the fixed wall 25b extends in the circumferential direction. The fixed wall 25b extends from one end to the other end in the circumferential direction of a radial outer edge of the bottom plate portion 25a. Cutout portions 25f, 25g recessed toward the outer side in the radial direction are provided at both circumferential end portions of a radial inner edge of the fixed wall 25b. As illustrated in FIG. 14, the cutout portions 25f, 25g are respectively located on the outer sides, in the radial direction, of circumferential end portions of the outer protruding portion 23d, and disposed facing the circumferential end portions of the outer protruding portion 23d. With the cutout portions 25f, 25g being provided, it is possible to suppress collision of the fixed wall 25b with the outer protruding portion 23d.

As illustrated in FIG. 22, the claw 25c protrudes from the radial inner edge of the bottom plate portion 25a toward the front side (+Z side). More specifically, the claw 25c protrudes from a center portion, in the circumferential direction, of the radial inner edge of the bottom plate portion 25a toward the front side. A dimension of the claw 25c in the circumferential direction is smaller than a dimension of the radial inner edge of the bottom plate portion 25a in the circumferential direction. The claw 25c includes a base portion 25d and a claw body portion 25e. The base portion 25d protrudes from the radial inner edge of the bottom plate portion 25a toward the front side. The base portion 25d has a plate shape with a plate surface facing the radial direction. The base portion 25d is elastically deformable in the radial direction. The claw body portion 25e protrudes from an end portion of the base portion 25d on the front side toward the outer side in the radial direction. The claw body portion 25e extends in the circumferential direction from one end to the other end of the base portion 25d in the circumferential direction.

The claw body portion 25e includes an inclined surface 25h and a hooking surface 25i. The inclined surface 25h is a part on the outer side, in the radial direction, of a surface of the claw body portion 25e on the front side. The inclined surface 25h faces the front side (+Z side) and the outer side in the radial direction. The inclined surface 25h is located on the rear side (−Z side), extending toward the outer side in the radial direction. The hooking surface 25i is a surface of the claw body portion 25e on the rear side. The hooking surface 25i is orthogonal to the axial direction.

As illustrated in FIG. 21, the claw 25c is located on the inner side of the rotor body 23 in the radial direction. Each base portion 25d of the plurality of claws 25c is located on the inner side of each hooking portion 24k in the radial direction. The respective claw body portions 25e of the plurality of claws 25c are located on the front sides (+Z sides) of the respective hooking portions 24k. The hooking surface 25i of each claw body portion 25e comes into contact with the hooking surface 24m of each hooking portion 24k. Each claw body portion 25e is hooked onto each hooking portion 24k from the front side. Accordingly, each claw 25c is hooked onto the first cover 24 from the front side. As a result, the second covers 25 are attached to the first cover 24 by the fixed walls 25b and the claws 25c. This makes it possible to more firmly fix the second covers 25 to the first cover 24 and further improve the rigidity of the first rotor 20. Further, the second covers 25 can be fixed to the first cover 24 by fixing the fixed walls 25b to the first cover 24 after the claws 25c are hooked onto the first cover 24. Therefore, a worker or the like that fixes the second covers 25 to the first cover 24 need only perform a task of fixing the first cover 24 and the second covers 25 by an adhesive, welding, or the like with respect to the fixed walls 25b. Accordingly, the task of fixing the second covers 25 to the first cover 24 can be performed more easily.

In the present specification, the “worker or the like” includes a worker, a device, or the like that performs each task. Each task may be performed by only a worker, may be performed by only a device, or may be performed by a worker and a device.

In the present embodiment, the worker or the like that attaches the second cover 25 brings the second cover 25 from the rear side (−Z side) close to the first cover 24 attached along with the rotor body 23 to the first rotor frame 21. When the second cover 25 approaches the first cover 24, the inclined surface 25h of the claw 25c comes into contact with the hooking portion 24k of the first cover 24 from the rear side. In this state, when the second cover 25 is brought even closer to the first cover 24, the claw 25c is pressed toward the inner side in the radial direction by the hooking portion 24k, and the base portion 25d of the claw 25c is elastically deformed toward the inner side in the radial direction. When the second cover 25 is brought even closer to the first cover 24 and the claw body portion 25e is located frontward (+Z side) of the hooking portion 24k, the base portion 25d is elastically restored toward the outer side in the radial direction, and the claw body portion 25e is hooked onto the hooking portion 24k from the front side. As a result, the worker or the like can hook the claw 25c of the second cover 25 onto the first cover 24 from the front side by simply bringing the second cover 25 close to the first cover 24 from the rear side in the axial direction. Note that the worker or the like may hook the claw body portion 25e onto the hooking portion 24k without elastically deforming the base portion 25d by obliquely inclining the second cover 25 to an orientation in which the claw 25c is located frontward of the fixed wall 25b.

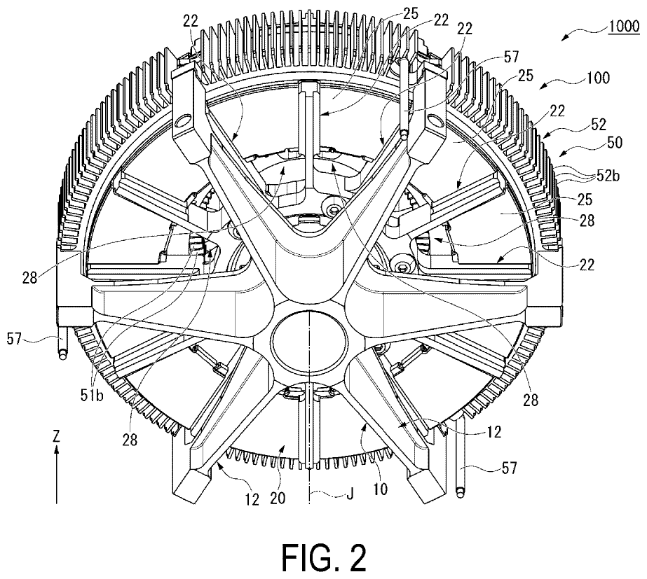

As illustrated in FIG. 2, the first rotor 20 includes a first rotor penetrating portion 28 that passes through the first rotor 20 in the axial direction. A plurality of the first rotor penetrating portions 28 are disposed spaced apart in the circumferential direction. In the present embodiment, twelve first rotor penetrating portions 28 are provided. The plurality of first rotor penetrating portions 28 are respectively provided between the first arms 22 adjacent to each other in the circumferential direction. More specifically, the plurality of first rotor penetrating portions 28 are respectively provided between the parts of the first arms 22 adjacent to each other in the circumferential direction that are located inward of the second covers 25 in the radial direction. In the present embodiment, the plurality of first rotor penetrating portions 28 each have a fan shape about the center axis J in a planar view in the axial direction. An end portion of each first rotor penetrating portion 28 on the front side (+Z side) opens to the inner side of the stator 50 in the radial direction.

The worker or the like that assembles the first rotor 20 attaches the rotor body 23 to the first rotor frame 21. The worker or the like inserts circumferential parts of the rotor body 23 where the outer protruding portion 23d, the first inner protruding portion 23e, and the second inner protruding portion 23f are not provided on the annular member 23a between, in the radial direction, the first protruding portions 22h and the second protruding portions 22j of the first arms 22b, from the front side (+Z side). Accordingly, the worker or the like arranges the rotor body 23 on the mounting surface 22p of each first arm 22. The worker or the like rotates the rotor body 23 around the center axis J, inserts the outer protruding portions 23d of the annular member 23a into the rear sides (−Z sides) of the first protruding portions 22h, and inserts the first inner protruding portions 23e of the annular member 23a into the rear sides of the second protruding portions 22j. The worker or the like inserts the pin members 26c into the second penetrating portions 22n from the front side, and press-fits the pin members 26c into the first penetrating portions 23i and the second penetrating portions 22n. The worker or the like arranges the first cover 24 on the front side of the rotor body 23, and fixes the first cover 24 and the annular member 23a to each first arm 22a by the bolts 26b. The worker or the like inserts the second covers 25 between the first arms 22 adjacent to each other in the circumferential direction from the rear side, and hooks the claws 25c of the second covers 25 onto the hooking portions 24k of the first cover 24 from the front side. The worker or the like fixes the fixed walls 25b of the second covers 25 and the flange portion 24f of the first cover 24 by welding or the like. Thus, the first rotor 20 is assembled. Note that the above-described method of assembling the first rotor 20 is an example. The first rotor 20 may be assembled in any manner.

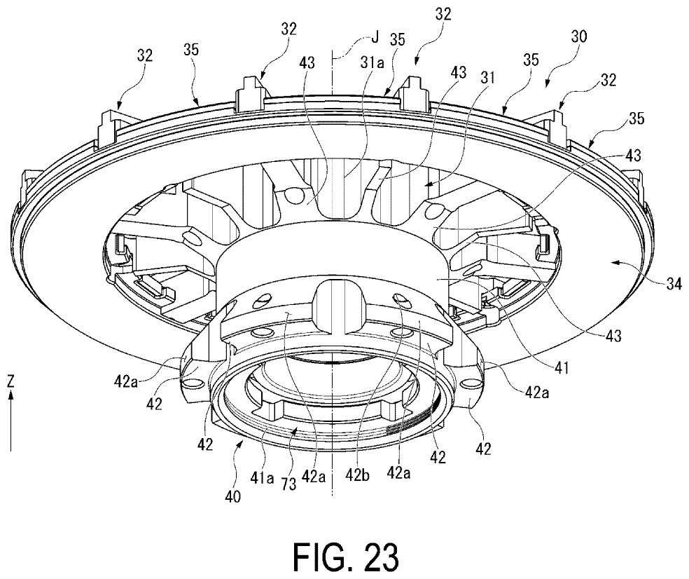

As illustrated in FIG. 4, the second rotor 30 includes a second rotor frame 31, a rotor body 33, and a first cover 34. As illustrated in FIG. 23, the second rotor 30 includes a plurality of second covers 35. The second rotor 30 has a configuration similar to that of the first rotor 20 except for being inverted in the axial direction. In the following, the description of the second rotor 30 may be omitted for configurations similar to those of the first rotor 20 except for being inverted in the axial direction.

The second rotor frame 31 has conductivity. The second rotor frame 31 is made of a non-magnetic material. In the present embodiment, the second rotor frame 31 is made of a metal. The metal constituting the second rotor frame 31 is, for example, aluminum. The second rotor frame 31 includes a second rotor annular portion 31a and a plurality of second arms 32.

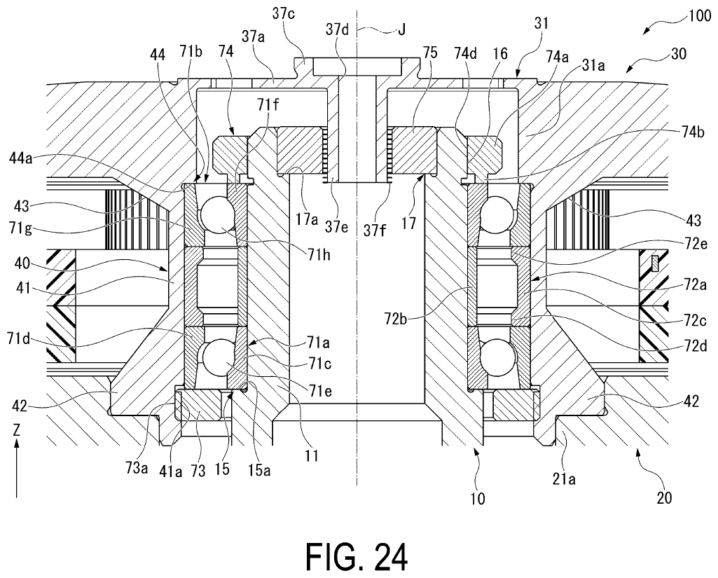

As illustrated in FIG. 9, the second rotor annular portion 31a has an annular shape surrounding the center axis J. More specifically, the second rotor annular portion 31a has a substantially circular annular shape having a center that coincides with the center axis J in a planar view in the axial direction. As illustrated in FIG. 24, the end portion of the support shaft 11 on the front side (+Z side) is located on the inner side of the second rotor annular portion 31a in the radial direction. As illustrated in FIG. 9, the plurality of second arms 32 extend from the second rotor annular portion 31a toward the outer side in the radial direction. A configuration of the plurality of second arms 32 is similar to the configuration of the plurality of first arms 22 except for being inverted in the axial direction.

As illustrated in FIG. 4, the second rotor frame 31 includes a propeller fixing part 37. The propeller fixing part 37 is provided at an end portion of the second rotor annular portion 31a on the front side (+Z side). The propeller fixing part 37 is a part to which the propeller 1100 is fixed. The propeller fixing part 37 includes a second top plate portion 37a, an annular protruding portion 37c, and a second extending portion 37e. That is, the second rotor frame 31 includes the second top plate portion 37a, the annular protruding portion 37c, and the second extending portion 37e.

The second top plate portion 37a is a top plate portion extending from the end portion of the second rotor annular portion 31a on the front side (+Z side) toward the inner side in the radial direction. The second top plate portion 37a closes part of an opening of the second rotor annular portion 31a on the front side. The second top plate portion 37a is located on the front side of the support shaft 11. The second top plate portion 37a has a plate shape with a plate surface facing the axial direction. As illustrated in FIG. 9, the second top plate portion 37a has a disc shape in which a center coincides with the center axis J in a planar view in the axial direction. The second top plate portion 37a includes a plurality of holes 37b penetrating the second top plate portion 37a in the axial direction. The plurality of holes 37b are disposed spaced apart in the circumferential direction and surround the center axis J. The plurality of holes 37b extend in the circumferential direction. The second top plate portion 37a includes a center hole 37d penetrating the second top plate portion 37a in the axial direction. The center hole 37d is provided in a center portion of the second top plate portion 37a in the radial direction. The center hole 37d has a circular shape having a center that coincides with the center axis J in a planar view in the axial direction.

The annular protruding portion 37c protrudes from a surface of the second top plate portion 37a on the front side (+Z side) toward the front side. The annular protruding portion 37c has an annular shape surrounding the center axis J. More specifically, the annular protruding portion 37c has a circular annular shape having a center that coincides with the center axis J in a planar view in the axial direction. The annular protruding portion 37c is located outward of the center hole 37d in the radial direction and surrounds the center hole 37d in a planar view in the axial direction.

As illustrated in FIG. 24, the second extending portion 37e extends from the second top plate portion 37a toward the rear side (−Z side) along the center axis J. In the present embodiment, the second extending portion 37e has a tubular shape that surrounds the center axis J and opens to both sides in the axial direction. More specifically, the second extending portion 37e has a cylindrical shape about the center axis J. The second extending portion 37e extends toward the rear side from a circumferential edge portion of the center hole 37d of a surface of the second top plate portion 37a on the rear side. An end portion of the second extending portion 37e on the front side (+Z side) opens to the front side through the center hole 37d. An outer diameter of the second extending portion 37e is smaller than an inner diameter of the conductive member 75. An end portion of the second extending portion 37e on the rear side is inserted into the support shaft 11 from the front side. The end portion of the second extending portion 37e on the rear side is located rearward of the third stepped surface 17a. The second extending portion 37e is passed in the axial direction through the inner side of the conductive member 75 in the radial direction. Accordingly, part of the second extending portion 37e is located on the inner side of the conductive member 75 in the radial direction. The end portion of the second extending portion 37e on the rear side is located rearward of the end portion of the conductive member 75 on the rear side.

A brush 37f that comes into contact with an inner circumferential surface of the conductive member 75 is provided on an outer circumferential surface of the second extending portion 37e. Therefore, an electrostatic charge generated in the second rotor 30 can be made to flow to the conductive member 75 through the second extending portion 37e and the brush 37f, and the electrostatic charge can be made to flow from the conductive member 75 to the support shaft 11. Further, as described below, the first rotor 20 is connected to the second rotor 30 through the connection tube 40. Therefore, an electrostatic charge generated in the first rotor 20 flows to the second rotor 30 through the connection tube 40, and the electrostatic charge generated in the first rotor 20 can be made to flow to the support shaft 11, as with the electrostatic charge generated in the second rotor 30 described above. With this configuration, it is possible to suppress the flow of the electrostatic charge generated in the first rotor 20 and the second rotor 30 to the first rolling bearing 71a and the second rolling bearing 71b. Accordingly, it is possible to suppress the occurrence of electric corrosion in the first rolling bearing 71a and the second rolling bearing 71b. The brush 37f is formed of, for example, a plurality of conductive fibers protruding from the outer circumferential surface of the second extending portion 37e toward the outer side in the radial direction.

As illustrated in FIG. 4, the rotor body 33 has a configuration similar to that of the rotor body 23 of the first rotor 20 except for being inverted in the axial direction. As illustrated in FIG. 6, the rotor body 33 includes an annular member 33a and a magnet assembly 33b. The annular member 33a of the rotor body 33 is fixed to the second arms 32 of the second rotor frame 31, as with the annular member 23a of the first rotor 20. Accordingly, a plurality of magnets constituting the magnet assembly 33b in the rotor body 33 are fixed to the second rotor frame 31. The first cover 34 has a configuration similar to that of the first cover 24 of the first rotor 20 except for being inverted in the axial direction. The plurality of second covers 35 each have a configuration similar to that of the plurality of second covers 25 of the first rotor 20 except for being inverted in the axial direction.

As illustrated in FIG. 1, the second rotor 30 includes a second rotor penetrating portion 38 that passes through the second rotor 30 in the axial direction. A plurality of the second rotor penetrating portions 38 are disposed spaced apart in the circumferential direction. In the present embodiment, twelve second rotor penetrating portions 38 are provided. The plurality of second rotor penetrating portions 38 are respectively provided between the second arms 32 adjacent to each other in the circumferential direction. More specifically, the plurality of second rotor penetrating portions 38 are respectively provided between parts of the second arms 32 adjacent to each other in the circumferential direction, the parts being located inward of the second covers 35 in the radial direction. In the present embodiment, the plurality of second rotor penetrating portions 38 each have a fan shape about the center axis J in a planar view in the axial direction. An end portion of each second rotor penetrating portion 38 on the rear side (−Z side) opens to the inner side of the stator 50 in the radial direction.

As illustrated in FIG. 23, the connection tube 40 has a tubular shape extending in the axial direction along the center axis J. More specifically, the connection tube 40 has a substantially cylindrical shape about the center axis J. The connection tube 40 extends from the second rotor annular portion 31a toward the rear side (−Z side). The second rotor annular portion 31a and the connection tube 40 are parts of the same single member. In the present embodiment, the second rotor frame 31 and the connection tube 40 are parts of the same single member. As illustrated in FIG. 21, a part of the connection tube 40 on the rear side is fixed to the first rotor annular portion 21a. Thus, the connection tube 40 connects the first rotor 20 and the second rotor 30.

As illustrated in FIG. 24, the connection tube 40 is located on the outer side of the support shaft 11 in the radial direction and surrounds the support shaft 11. That is, the support shaft 11 is located on the inner side of the connection tube 40. An inner circumferential surface of the connection tube 40 is provided outwardly separated in the radial direction from the outer circumferential surface of the support shaft 11. The connection tube 40 includes a tubular body portion 41, a plurality of first ribs 42, and a plurality of second ribs 43.

The tubular body portion 41 has a tubular shape extending from the second rotor annular portion 31a toward the rear side (−Z side). In the present embodiment, the tubular body portion 41 has a cylindrical shape about the center axis J. The tubular body portion 41 is positioned on the outer side of the support shaft 11 in the radial direction. An inner circumferential surface of the tubular body portion 41 is provided outwardly separated in the radial direction from the outer circumferential surface of the support shaft 11. The inner circumferential surface of the tubular body portion 41 is the inner circumferential surface of the connection tube 40. A stepped portion 44 including a first stepped surface 44a facing the rear side (−Z side) is provided on a part on the front side (+Z side) of the inner circumferential surface of the tubular body portion 41. The first stepped surface 44a has an annular shape surrounding the center axis J. The first stepped surface 44a has a circular annular shape having a center that coincides with the center axis J in a planar view in the axial direction. The first stepped surface 44a is, for example, a surface orthogonal to the axial direction. An inner diameter of a part of the tubular body portion 41 that is located rearward of the first stepped surface 44a is larger than an inner diameter of a part of the tubular body portion 41 that is located frontward of the first stepped surface 44a. An end portion of the tubular body portion 41 on the rear side is an end portion of the connection tube 40 on the rear side. The end portion of the tubular body portion 41 on the rear side is fitted to the inner side of the first rotor annular portion 21a in the radial direction. The end portion of the tubular body portion 41 on the rear side is, for example, loosely fitted to the inner side of the first rotor annular portion 21a in the radial direction.

The first rolling bearing 71a and the second rolling bearing 71b are located between, in the radial direction, the inner circumferential surface of the tubular body portion 41, that is, the inner circumferential surface of the connection tube 40, and the outer circumferential surface of the support shaft 11. The first rolling bearing 71a and the second rolling bearing 71b rotatably support the first rotor 20 and the second rotor 30 relative to the support shaft 11. The second rolling bearing 71b is located between the inner circumferential surface of the connection tube 40 and the outer circumferential surface of the support shaft 11 and frontwardly (+Z side) separated from the first rolling bearing 71a. The first rolling bearing 71a and the second rolling bearing 71b each have an annular shape surrounding the support shaft 11. In the present embodiment, the first rolling bearing 71a and the second rolling bearing 71b are ball bearings. The first rolling bearing 71a and the second rolling bearing 71b are identical rolling bearings having the same shape and size. The first rolling bearing 71a and the second rolling bearing 71b are disposed in postures inverted from each other in the axial direction. Angular contact ball bearings are adopted as the first rolling bearing 71a and the second rolling bearing 71b, for example. The first rolling bearing 71a includes an inner ring 71c, an outer ring 71d, and a plurality of rolling elements 71e. The second rolling bearing 71b includes the inner ring 71f, an outer ring 71g, and a plurality of rolling elements 71h.

The inner rings 71c, 71f each have an annular shape surrounding the support shaft 11. More specifically, the inner rings 71c, 71f each have a substantially circular annular shape having a center that coincides with the center axis J in a planar view in the axial direction. The support shaft 11 is fitted to the inner sides of the inner rings 71c, 71f. The inner rings 71c, 71f come into contact with the outer circumferential surface of the support shaft 11. More specifically, at least part of the inner circumferential surface of each of the inner rings 71c, 71f comes into contact with the outer circumferential surface of the support shaft 11. The inner rings 71c, 71f are relatively movably supported in the axial direction with respect to the support shaft 11.

The outer rings 71d, 71g have annular shapes respectively surrounding the inner rings 71c, 71f on the outer sides of the inner rings 71c, 71f in the radial direction. More specifically, the outer rings 71d, 71g have circular annular shapes, each having a center that coincides with the center axis J in a planar view in the axial direction. The outer rings 71d, 71g are fitted to the inner side of the connection tube 40. The outer rings 71d, 71g come into contact with the inner circumferential surface of the connection tube 40. More specifically, at least part of an outer circumferential surface of each of the outer rings 71d, 71g comes into contact with the inner circumferential surface of the connection tube 40.

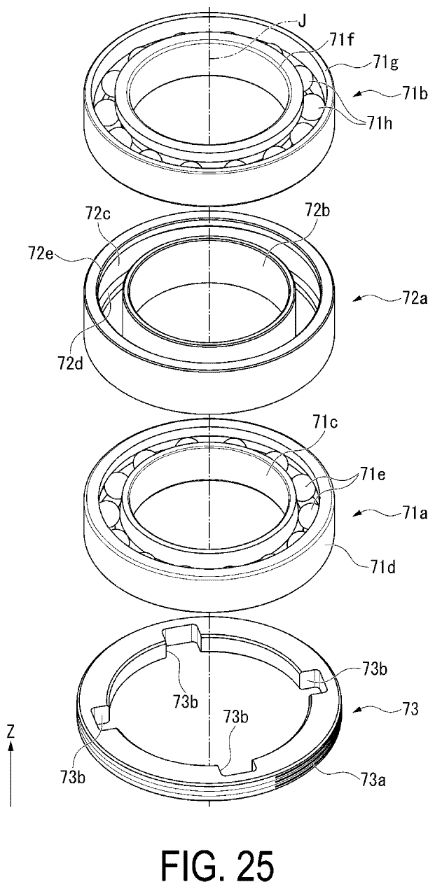

As illustrated in FIG. 25, the plurality of rolling elements 71e of the first rolling bearing 71a are located between the inner ring 71c and the outer ring 71d in the radial direction. The plurality of rolling elements 71e are arranged side by side in the circumferential direction. The plurality of rolling elements 71h of the second rolling bearing 71b are located between the inner ring 71f and the outer ring 71g in the radial direction. The plurality of rolling elements 71h are arranged side by side in the circumferential direction. In the present embodiment, the plurality of rolling elements 71e and the plurality of rolling elements 71h are spherical.

As illustrated in FIG. 24, the end portion, on the rear side (−Z side), of the inner ring 71c of the first rolling bearing 71a comes into contact with the second stepped surface 15a facing the front side (+Z side) and provided on the outer circumferential surface of the support shaft 11. Thus, the inner ring 71c is positioned in the axial direction relative to the support shaft 11. An end portion, on the front side, of the outer ring 71g of the second rolling bearing 71b comes into contact with the first stepped surface 44a facing the rear side and provided on the inner circumferential surface of the connection tube 40. As a result, the outer ring 71g is positioned in the axial direction relative to the connection tube 40.

The first spacer 72a and a second spacer 72b are located between the first rolling bearing 71a and the second rolling bearing 71b in the axial direction. The first spacer 72a and the second spacer 72b are made of a non-magnetic material. The first spacer 72a and the second spacer 72b may be made of a metal or may be made of a resin, for example. As illustrated in FIG. 25, the first spacer 72a and the second spacer 72b each have a tubular shape surrounding the center axis J. More specifically, the first spacer 72a and the second spacer 72b each have a cylindrical shape about the center axis J. An inner diameter of the first spacer 72a is larger than an outer diameter of the second spacer 72b. The first spacer 72a is positioned outwardly away from the second spacer 72b in the radial direction. The first spacer 72a surrounds the second spacer 72b. As illustrated in FIG. 24, the first spacer 72a and the second spacer 72b are located on the outer side of the support shaft 11 in the radial direction, surrounding the support shaft 11.

The first spacer 72a is located between the outer ring 71d of the first rolling bearing 71a and the outer ring 71g of the second rolling bearing 71b in the axial direction. The first spacer 72a comes into contact with the outer ring 71d of the first rolling bearing 71a and the outer ring 71g of the second rolling bearing 71b. The second spacer 72b is located between the inner ring 71c of the first rolling bearing 71a and the inner ring 71f of the second rolling bearing 71b in the axial direction. The second spacer 72b comes into contact with the inner ring 71c of the first rolling bearing 71a and the inner ring 71f of the second rolling bearing 71b.

The first spacer 72a is fitted into the connection tube 40. An outer circumferential surface of the first spacer 72a comes into contact with the inner circumferential surface of the connection tube 40. The support shaft 11 is fitted to the inner side of the second spacer 72b. An inner circumferential surface of the second spacer 72b comes into contact with the outer circumferential surface of the support shaft 11. The second spacer 72b is elastically deformable in the axial direction. With regard to compression amounts in the axial direction caused by elastic deformation when identical compressive stresses are applied in the axial direction, the compression amount of the second spacer 72b is larger than the compression amount of the first spacer 72a.

The first spacer 72a includes a spacer body portion 72c, a first annular protruding portion 72d, and a second annular protruding portion 72e. The spacer body portion 72c has a tubular shape surrounding the center axis J. More specifically, the spacer body portion 72c has a cylindrical shape about the center axis J. The first annular protruding portion 72d protrudes toward the inner side in the radial direction from an end portion, on the rear side (−Z side), of an inner circumferential surface of the spacer body portion 72c. The second annular protruding portion 72e protrudes toward the inner side in the radial direction from an end portion, on the front side (+Z side), of the inner circumferential surface of the spacer body portion 72c. The first annular protruding portion 72d and the second annular protruding portion 72e each have an annular shape surrounding the center axis J. More specifically, the first annular protruding portion 72d and the second annular protruding portion 72e each have a circular annular shape having a center that coincides with the center axis J in a planar view in the axial direction. The first annular protruding portion 72d comes into contact with an end portion, on the front side, of the outer ring 71d of the first rolling bearing 71a. The second annular protruding portion 72e comes into contact with an end portion, on the rear side, of the outer ring 71g of the second rolling bearing 71b.

A thickness of the second spacer 72b in the radial direction between the inner circumferential surface and an outer circumferential surface is smaller than a thickness of the first spacer 72a in the radial direction between an inner circumferential surface and the outer circumferential surface. The thickness in the radial direction between the inner circumferential surface and the outer circumferential surface of the first spacer 72a includes a thickness in the radial direction between an inner circumferential surface of the first annular protruding portion 72d and an outer circumferential surface of the spacer body portion 72c, a thickness in the radial direction between the inner circumferential surface and the outer circumferential surface of the spacer body portion 72c, and a thickness in the radial direction between an inner circumferential surface of the second annular protruding portion 72e and the outer circumferential surface of the spacer body portion 72c.

The bearing support member 73 is located on the rear side (−Z side) of the first rolling bearing 71a. As illustrated in FIG. 25, the bearing support member 73 has an annular shape surrounding the center axis J. The bearing support member 73 has a circular annular shape having a center that coincides with the center axis J in a planar view in the axial direction. The bearing support member 73 includes a plurality of second recess portions 73b recessed radially outward from an inner circumferential surface of the bearing support member 73. The plurality of second recess portions 73b are disposed spaced apart in the circumferential direction. The plurality of second recess portions 73b are disposed at equal intervals across the entire circumference in the circumferential direction. In the present embodiment, an interior of the second recess portion 73b opens to both sides in the axial direction. The interior of the second recess portion 73b has a quadrangular shape in a planar view in the axial direction. In the present embodiment, four second recess portions 73b are provided. The bearing support member 73 includes a third threaded portion 73a in the outer circumferential surface thereof.

As illustrated in FIG. 24, the bearing support member 73 is located on the inner side of the connection tube 40 in the radial direction and on the outer side of the support shaft 11 in the radial direction. The bearing support member 73 surrounds the support shaft 11. The inner circumferential surface of the bearing support member 73 is located outwardly away from the outer circumferential surface of the support shaft 11 in the radial direction. The bearing support member 73 is located on the rear side (−Z side) of the outer ring 71d of the first rolling bearing 71a. The bearing support member 73 comes into contact with the end portion, on the rear side, of the outer ring 71d of the first rolling bearing 71a. The bearing support member 73 sandwiches the outer ring 71d of the first rolling bearing 71a, the first spacer 72a, and the outer ring 71g of the second rolling bearing 71b between the bearing support member 73 and the first stepped surface 44a provided on the inner circumferential surface of the connection tube 40 in the axial direction. A distance in the axial direction between the outer ring 71d of the first rolling bearing 71a and the outer ring 71g of the second rolling bearing 71b is maintained by the first spacer 72a. The third threaded portion 73a provided in the outer circumferential surface of the bearing support member 73 meshes with a fourth threaded portion 41a provided in the inner circumferential surface of the tubular body portion 41. That is, the connection tube 40 includes the fourth threaded portion 41a that meshes with the third threaded portion 73a, in a part of the inner circumferential surface that is located rearward of the outer ring 71d of the first rolling bearing 71a. This makes it possible to adjust a position of the bearing support member 73 in the axial direction relative to the connection tube 40 and adjust a distance in the axial direction between the bearing support member 73 and the first stepped surface 44a by rotating the bearing support member 73. As a result, the outer ring 71d of the first rolling bearing 71a, the first spacer 72a, and the outer ring 71g of the second rolling bearing 71b can be sandwiched by the bearing support member 73 and the first stepped surface 44a without the occurrence of a gap between the components. Accordingly, the distance in the axial direction between the outer ring 71d of the first rolling bearing 71a and the outer ring 71g of the second rolling bearing 71b can be stably maintained.

In the present embodiment, as described above, the bearing support member 73 includes the plurality of second recess portions 73b recessed toward the outer side in the radial direction from the inner circumferential surface of the bearing support member 73 and disposed spaced apart in the circumferential direction. Therefore, by inserting part of a tool into the interior of at least one of the plurality of second recess portions 73b, or the like, the worker or the like can easily rotate the bearing support member 73 about the center axis J using the tool. This makes it possible to easily adjust a position of the bearing support member 73 in the axial direction.

The preload member 74 is located on the front side (+Z side) of the second rolling bearing 71b. The preload member 74 is located on the front side of the inner ring 71f of the second rolling bearing 71b. The preload member 74 comes into contact with an end portion, on the front side, of the inner ring 71f of the second rolling bearing 71b. The preload member 74 is attached to the support shaft 11. An attachment structure in which the preload member 74 is attached to the support shaft 11 is an attachment structure in which a position of the preload member 74 in the axial direction relative to the support shaft 11 is adjustable. Therefore, by moving the preload member 74 in the axial direction relative to the support shaft 11, it is possible to change a distance in the axial direction between the preload member 74 and the second stepped surface 15a provided on the outer circumferential surface of the support shaft 11. The inner ring 71c of the first rolling bearing 71a, the second spacer 72b, and the inner ring 71f of the second rolling bearing 71b are located between the preload member 74 and the second stepped surface 15a in the axial direction. Therefore, when the distance in the axial direction between the preload member 74 and the second stepped surface 15a becomes smaller than a total sum of the dimensions of the components in the axial direction, the second spacer 72b is compressed and elastically deformed in the axial direction. This reduces a distance in the axial direction between the inner ring 71c of the first rolling bearing 71a and the inner ring 71f of the second rolling bearing 71b. When the distance between the inner ring 71c of the first rolling bearing 71a and the inner ring 71f of the second rolling bearing 71b is reduced in a state in which the distance between the outer ring 71d of the first rolling bearing 71a and the outer ring 71g of the second rolling bearing 71b is maintained by the first spacer 72a, the inner rings are displaced in the axial direction relative to the outer rings in each of the rolling bearings. Thus, a preload is applied to each rolling bearing. The preload applied to each rolling bearing increases as the distance in the axial direction between the inner ring 71c of the first rolling bearing 71a and the inner ring 71f of the second rolling bearing 71b decreases. Accordingly, the worker or the like can adjust the preload applied to the first rolling bearing 71a and the second rolling bearing 71b by adjusting the position of the preload member 74 in the axial direction relative to the support shaft 11. Therefore, the worker or the like can apply a desired preload to the first rolling bearing 71a and the second rolling bearing 71b. This makes it possible to improve a rigidity of the first rolling bearing 71a and a rigidity of the second rolling bearing 71b. Accordingly, in the first rolling bearing 71a and the second rolling bearing 71b, it is possible to suppress inclination of the outer rings relative to the inner rings, and suppress inclination of the connection tube 40, with which the outer rings of the rolling bearings come into contact, relative to the support shaft 11. The connection tube 40, connecting the first rotor 20 and the second rotor 30, can suppress inclination of the connection tube 40 relative to the support shaft 11, and thus suppress inclination of the first rotor 20 and the second rotor 30 relative to the support shaft 11. In particular, the second rotor annular portion 31a of the second rotor 30 and the connection tube 40 are parts of the same single member, making it possible to suppress inclination of the connection tube 40 relative to the support shaft 11, and thus further suppress inclination of the second rotor 30 relative to the support shaft 11. Thus, it is possible to suppress inclination of the first rotor 20 and the second rotor 30.

In a case in which the motor 100 is mounted onto the propulsion device 1000, a force generated by the propeller 1100 may vary in the circumferential direction, readily generating a force in a direction toward the first rotor 20 and the second rotor 30, causing inclination of the first rotor 20 and the second rotor 30. In contrast, according to the present embodiment, with the configuration described above, it is possible to suppress inclination of the first rotor 20 and the second rotor 30. The effect of facilitating suppression of the inclination of the first rotor 20 and the second rotor 30 is particularly useful in a case in which the motor 100 is mounted onto the propulsion device 1000. Furthermore, the propeller 1100 is attached to the second rotor 30. With the inclination of the second rotor 30 being suppressed further than the inclination of the first rotor 20 as described above, even when a force that is not uniform in the circumferential direction is applied to the second rotor 30 by rotation of the propeller 1100, inclination of the second rotor 30 can be suitably suppressed.

In the present embodiment, as described above, the thickness of the second spacer 72b in the radial direction between the inner circumferential surface and the outer circumferential surface is smaller than the thickness of the first spacer 72a in the radial direction between the inner circumferential surface and the outer circumferential surface. This makes it possible to readily reduce the thickness of the second spacer 72b in the radial direction between the inner circumferential surface and the outer circumferential surface and readily elastically deform the second spacer 72b in the axial direction. Thus, when the preload member 74 is moved in the axial direction relative to the support shaft 11, the second spacer 72b can be readily compressed and elastically deformed in the axial direction. Accordingly, the preload applied to the first rolling bearing 71a and the preload applied to the second rolling bearing 71b can be easily adjusted. Further, the thickness of the first spacer 72a in the radial direction between the inner circumferential surface and the outer circumferential surface is readily increased, and the distance in the axial direction between the outer ring 71d of the first rolling bearing 71a and the outer ring 71g of the second rolling bearing 71b is readily stably maintained by the first spacer 72a.

In the present embodiment, as described above, the first spacer 72a includes the first annular protruding portion 72d and the second annular protruding portion 72e that protrude toward the inner side in the radial direction from the inner circumferential surface of the spacer body portion 72c. This makes it possible to improve a rigidity of the first spacer 72a. Accordingly, the distance in the axial direction between the outer ring 71d of the first rolling bearing 71a and the outer ring 71g of the second rolling bearing 71b is more readily stably maintained by the first spacer 72a. Further, the first annular protruding portion 72d protrudes toward the inner side in the radial direction from an end portion, on the rear side (−Z side), of the inner circumferential surface of the spacer body portion 72c, making it possible to increase a thickness in the radial direction between the inner circumferential surface and the outer circumferential surface at an end portion of the first spacer 72a on the rear side by the first annular protruding portion 72d. This makes it possible to increase a contact area between the first spacer 72a and the outer ring 71d of the first rolling bearing 71a. The second annular protruding portion 72e protrudes toward the inner side in the radial direction from an end portion, on the front side (+Z side), of the inner circumferential surface of the spacer body portion 72c, making it possible to increase a thickness in the radial direction between the inner circumferential surface and the outer circumferential surface at an end portion of the first spacer 72a on the front side by the second annular protruding portion 72e. This makes it possible to increase a contact area between the first spacer 72a and the outer ring 71g of the second rolling bearing 71b. Accordingly, the outer ring 71d of the first rolling bearing 71a and the outer ring 71g of the second rolling bearing 71b can be more stably supported by the first spacer 72a.

In the present embodiment, as described above, the end portion of the tubular body portion 41 on the rear side (−Z side), that is, the end portion of the connection tube 40 on the rear side, is fitted to the inner side of the first rotor annular portion 21a in the radial direction. This makes it possible to arrange the connection tube 40 and the first rotor frame 21 with high axial accuracy relative to the center axis J. This also makes it possible to suppress inclination of the first rotor frame 21 relative to the connection tube 40. Accordingly, it is possible to further suppress inclination of the first rotor 20.

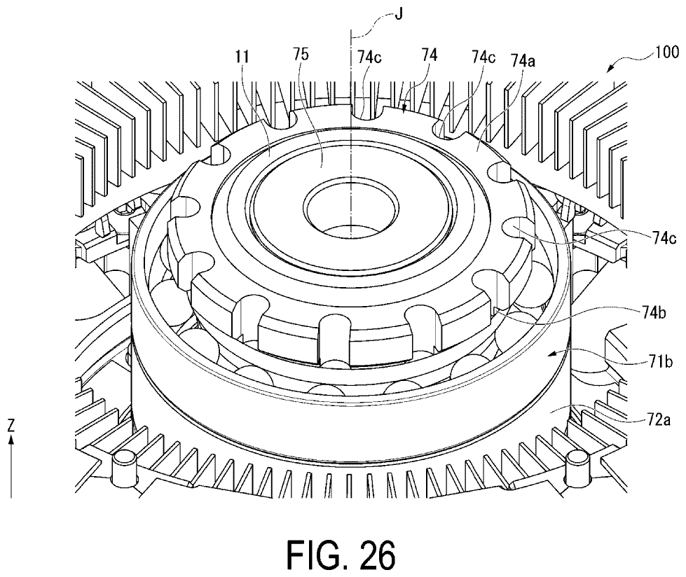

As illustrated in FIG. 26, the preload member 74 has an annular shape surrounding the center axis J. More specifically, the preload member 74 has a circular annular shape having a center that coincides with the center axis J in a planar view in the axial direction. The preload member 74 surrounds the end portion of the support shaft 11 on the front side (+Z side). An outer diameter of the preload member 74 is smaller than an outer diameter of the first rolling bearing 71a and an outer diameter of the second rolling bearing 71b. As illustrated in FIG. 24, the preload member 74 is provided inwardly away from an inner circumferential surface of the second rotor annular portion 31a in the radial direction. The preload member 74 includes a nut part 74a and a contact portion 74b.

The nut part 74a has an annular shape surrounding the support shaft 11. In the present embodiment, the nut part 74a has a circular annular shape having a center that coincides with the center axis J in a planar view in the axial direction. The nut part 74a includes, in an inner circumferential surface, a second threaded portion 74d that meshes with the first threaded portion 16. That is, in the present embodiment, an attachment structure in which the preload member 74 is attached to the support shaft 11 is a structure in which the first threaded portion 16 and the second threaded portion 74d mesh with each other. This makes it possible for the worker or the like to move the preload member 74 in the axial direction relative to the support shaft 11 and thus adjust the position of the preload member 74 in the axial direction relative to the support shaft 11 by rotating the nut part 74a. Accordingly, the worker or the like can easily adjust the preload applied to the first rolling bearing 71a and the second rolling bearing 71b by rotating the nut part 74a. Note that the attachment structure for attaching the preload member 74 to the support shaft 11 is not particularly limited as long as the attachment structure facilitates adjustment of the position of the preload member 74 relative to the support shaft 11 in the axial direction, and may be a structure other than threads.

As illustrated in FIG. 26, the nut part 74a includes a plurality of first recess portions 74c recessed toward the inner side in the radial direction from an outer circumferential surface of the nut part 74a. The plurality of first recess portions 74c are disposed spaced apart in the circumferential direction. Therefore, by inserting part of a tool into an interior of at least one of the plurality of first recess portions 74c, or the like, the worker or the like can easily rotate the nut part 74a about the center axis J using the tool. This makes it possible for the worker or the like to easily adjust the position of the preload member 74 in the axial direction. Accordingly, the worker or the like can more easily perform the task of adjusting the preload applied to the first rolling bearing 71a and the second rolling bearing 71b. The plurality of first recess portions 74c are disposed at equal intervals across the entire circumference in the circumferential direction. In the present embodiment, twelve first recess portions 74c are provided. The interior of the first recess portion 74c opens to both sides in the axial direction. A part of an inner surface of the first recess portion 74c that is located on the inner side in the radial direction has a circular arc shape recessed toward the inner side in the radial direction in a planar view in the axial direction.

As illustrated in FIG. 24, the contact portion 74b protrudes from a surface of the nut part 74a on the rear side (−Z side) toward the rear side. The contact portion 74b has an annular shape surrounding the center axis J. More specifically, the contact portion 74b has a circular annular shape having a center that coincides with the center axis J in a planar view in the axial direction. An inner circumferential surface of the contact portion 74b is located outward of the inner circumferential surface of the nut part 74a in the radial direction. An outer circumferential surface of the contact portion 74b is located inward of the outer circumferential surface of the nut part 74a in the radial direction. An end surface of the contact portion 74b on the rear side comes into contact with the end portion, on the front side (+Z side), of the inner ring 71f of the second rolling bearing 71b. As illustrated in FIG. 26, in the present embodiment, the plurality of first recess portions 74c are provided extending across the contact portion 74b.

As illustrated in FIG. 24, the plurality of first ribs 42 protrude from an outer circumferential surface of the tubular body portion 41 toward the outer side in the radial direction. The plurality of first ribs 42 are disposed spaced apart in the circumferential direction. The plurality of first ribs 42 are disposed at equal intervals across the entire circumference in the circumferential direction. A number of the first ribs 42 is the same as the number of the first protruding walls 21b. That is, in the present embodiment, six first ribs 42 are provided. Surfaces of the plurality of first ribs 42 on the front side (+Z side) are each an inclined surface located on the rear side (−Z side), extending toward the outer side in the radial direction. Surfaces of the plurality of first ribs 42 on the rear side are orthogonal to the axial direction. The surfaces of the plurality of first ribs 42 on the rear side come into contact with a surface of the first rotor annular portion 21a on the front side. Thus, the first rotor frame 21 is positioned in the axial direction relative to the connection tube 40.

As illustrated in FIG. 21, each of the plurality of first ribs 42 includes a threaded hole 42b penetrating the first rib 42 in the axial direction. The threaded holes 42b of the plurality of first ribs 42 are located on the respective front sides (+Z sides) of the plurality of holes 21c provided in the first rotor annular portion 21a. Bolts 26a passed through the holes 21c from the rear side (−Z side) are fastened into the threaded holes 42b from the rear side. Thus, the plurality of first ribs 42 are fixed to the first rotor annular portion 21a. Accordingly, a rigidity of the connection tube 40 can be improved by the plurality of first ribs 42, and the connection tube 40 can be firmly fixed to the first rotor frame 21 via the plurality of first ribs 42. Accordingly, it is possible to further suppress inclination of the first rotor 20. A washer 26h is provided between a head portion of the bolt 26a and a surface of the first rotor annular portion 21a on the rear side. The washer 26h is, for example, a wave washer.

As illustrated in FIG. 23, each of the plurality of first ribs 42 includes a facing surface 42a facing the outer side in the radial direction. The facing surfaces 42a of the plurality of first ribs 42 extend in the circumferential direction in a planar view in the axial direction. As illustrated in FIG. 21, the facing surfaces 42a of the plurality of first ribs 42 are disposed facing inner sides, in the radial direction, of the radial inner surfaces 21d of the first protruding walls 21b. At least one of the facing surfaces 42a comes into contact with the radial inner surface 21d of the first protruding wall 21b. This makes it possible to arrange the connection tube 40 and the first rotor frame 21 with high axial accuracy relative to the center axis J. This also makes it possible to further suppress inclination of the first rotor frame 21 relative to the connection tube 40. Accordingly, it is possible to further suppress inclination of the first rotor 20. In the present embodiment, the facing surfaces 42a of the plurality of first ribs 42 disposed surrounding the center axis J are fitted to the inner sides, in the radial direction, of the plurality of first protruding walls 21b disposed surrounding the center axis J.

As illustrated in FIG. 23, the plurality of second ribs 43 protrude from the outer circumferential surface of the tubular body portion 41 toward the outer side in the radial direction. The plurality of second ribs 43 are disposed spaced apart in the circumferential direction. The plurality of second ribs 43 are respectively connected to surfaces of the plurality of second arms 32 on the rear side (−Z side). This makes it possible to further improve the rigidity of the connection tube 40 by the plurality of second ribs 43. This also makes it possible to further improve a connection strength between the connection tube 40 and the second rotor frame 31. Further, inclination of the second rotor frame 31 relative to the connection tube 40 can be further suppressed. Accordingly, it is possible to further suppress inclination of the second rotor 30.

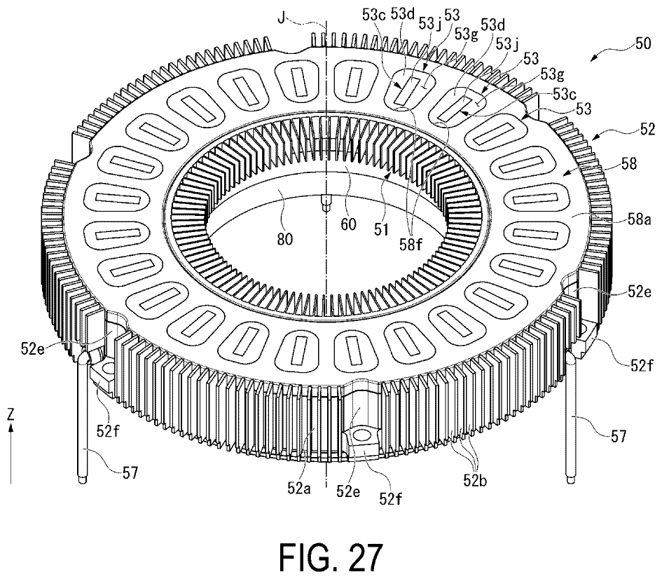

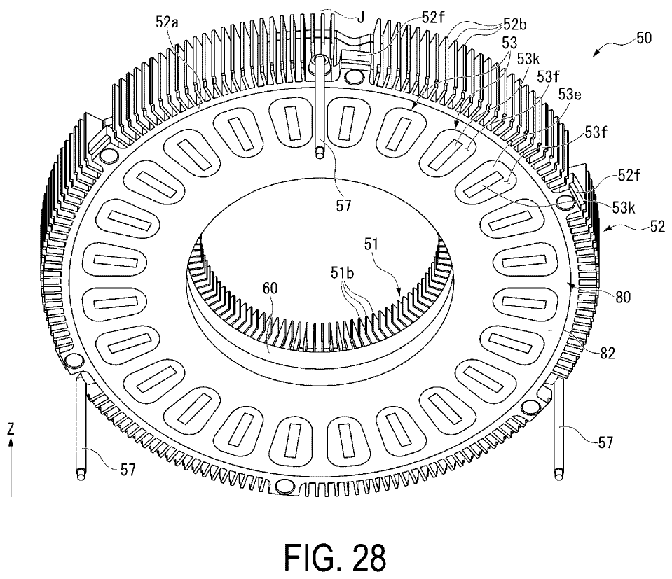

As illustrated in FIG. 27 and FIG. 28, the stator 50 has an annular shape surrounding the center axis J. More specifically, the stator 50 has a circular annular shape having a center that coincides with the center axis J in a planar view in the axial direction. As illustrated in FIG. 6, the stator 50 is located between the first rotor 20 and the second rotor 30 in the axial direction. The stator 50 is located on the front side (+Z side) of the first rotor 20 and is located on the rear side (−Z side) of the second rotor 30. The stator 50 includes an inner housing 51, an outer housing 52, a plurality of electromagnet sections 53, a stator cover 58, and a resin section 80.

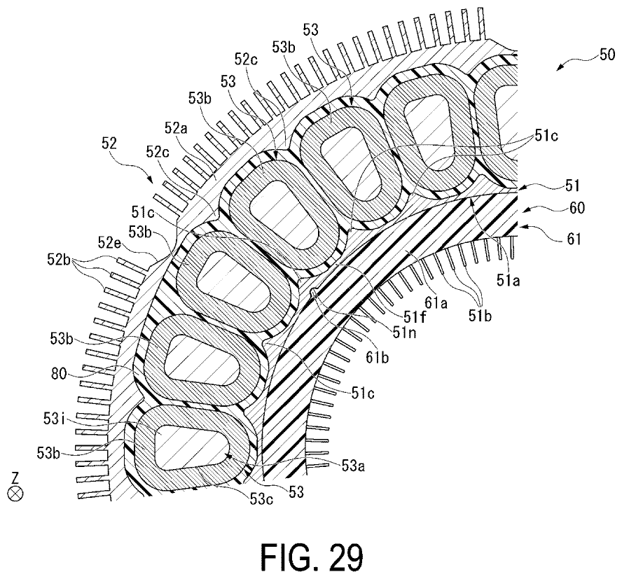

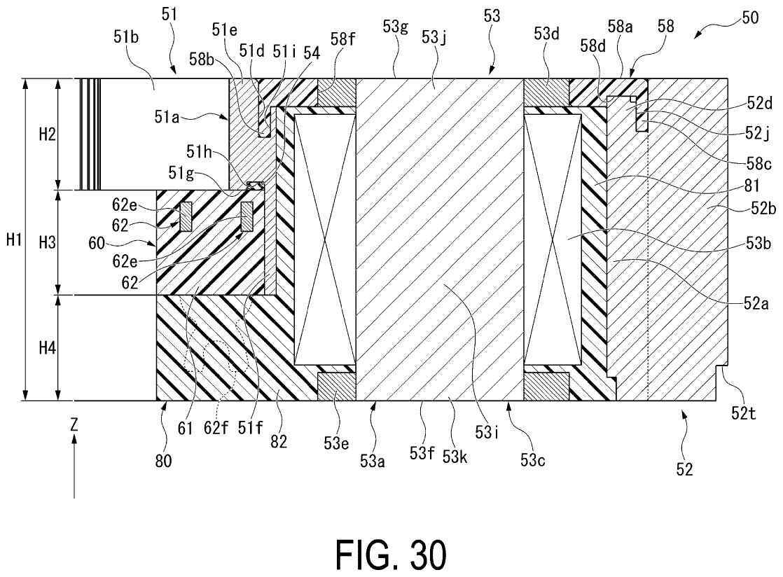

As illustrated in FIG. 27 and FIG. 28, the plurality of electromagnet sections 53 are disposed surrounding the center axis. The plurality of electromagnet sections 53 are disposed at equal intervals across the entire circumference in the circumferential direction. In the present embodiment, 24 electromagnet sections 53 are provided. As illustrated in FIG. 29, each of the plurality of electromagnet sections 53 includes a stator core 53a and a coil 53b. The stator core 53a is made of a magnetic material. As illustrated in FIG. 30, the stator core 53a includes a first core part 53c, a second core part 53d, and a third core part 53e.

The first core part 53c extends in the axial direction. Although not illustrated, the first core part 53c is constituted by a plurality of plate members layered in the radial direction. The plurality of plate members constituting the first core part 53c are, for example, electromagnetic steel plates. The first core part 53c includes a core body portion 53i, a connecting portion 53j, and a connecting portion 53k. The core body portion 53i extends in the axial direction. As illustrated in FIG. 29, the core body portion 53i has a substantially trapezoidal shape in which a dimension in the circumferential direction decreases toward the inner side in the radial direction in a planar view in the axial direction.

As illustrated in FIG. 30, the connecting portion 53j is connected to an end portion of the core body portion 53i on the front side (+Z side). The connecting portion 53k is connected to an end portion of the core body portion 53i on the rear side (−Z side). As illustrated in FIG. 27, the connecting portion 53j has a rectangular shape extending in the radial direction in a planar view in the axial direction. A dimension of the connecting portion 53j in the circumferential direction is smaller than a dimension of the core body portion 53i in the circumferential direction. The connecting portion 53j is an end portion of the first core part 53c on the front side. As illustrated in FIG. 28, the connecting portion 53k has a rectangular shape extending in the radial direction in a planar view in the axial direction. A dimension of the connecting portion 53k in the circumferential direction is smaller than the dimension of the core body portion 53i in the circumferential direction. The connecting portion 53k is an end portion of the first core part 53c on the rear side.

As illustrated in FIG. 27, the second core part 53d has an annular shape surrounding the end portion of the first core part 53c on the front side (+Z side), that is, the connecting portion 53j. An outer circumferential surface of the second core part 53d has a substantially trapezoidal shape with rounded corners and has a dimension in the circumferential direction decreasing toward the inner side in the radial direction in a planar view in the axial direction. A part of the outer circumferential surface of the second core part 53d that is located on the inner side in the radial direction has a circular arc shape protruding toward the inner side in the radial direction in a planar view in the axial direction.

An inner circumferential surface of the second core part 53d has the same shape as that of the outer circumferential surface of the connecting portion 53j in a planar view in the axial direction. That is, in the present embodiment, the inner circumferential surface of the second core part 53d has a rectangular shape extending in the radial direction in a planar view in the axial direction. The connecting portion 53j is fitted into the second core part 53d. The inner circumferential surface of the second core part 53d comes into contact with the outer circumferential surface of the connecting portion 53j, that is, an outer circumferential surface of the first core part 53c. The inner circumferential surface of the second core part 53d comes into contact with the outer circumferential surface of the connecting portion 53j across the entire circumference of the second core part 53d surrounding the first core part 53c. As illustrated in FIG. 30, the second core part 53d is located on the front side (+Z side) of the coil 53b. A material constituting the second core part 53d is, for example, a soft magnetic composite (SMC).

As illustrated in FIG. 28, the third core part 53e has an annular shape surrounding the end portion of the first core part 53c on the rear side (−Z side), that is, the connecting portion 53k. An outer circumferential surface of the third core part 53e has a substantially trapezoidal shape with rounded corners and has a dimension in the circumferential direction decreasing toward the inner side in the radial direction in a planar view in the axial direction. A part of the outer circumferential surface of the third core part 53e that is located on the inner side in the radial direction has a circular arc shape protruding toward the inner side in the radial direction in a planar view in the axial direction.

An inner circumferential surface of the third core part 53e has the same shape as that of an outer circumferential surface of the connecting portion 53k in a planar view in the axial direction. That is, in the present embodiment, the inner circumferential surface of the third core part 53e has a rectangular shape extending in the radial direction in a planar view in the axial direction. The connecting portion 53k is fitted into the third core part 53e. The inner circumferential surface of the third core part 53e comes into contact with the outer circumferential surface of the connecting portion 53k, that is, the outer circumferential surface of the first core part 53c. The inner circumferential surface of the third core part 53e comes into contact with the outer circumferential surface of the connecting portion 53k across the entire circumference of the third core part 53e surrounding the first core part 53c. As illustrated in FIG. 30, the third core part 53e is located on the rear side (−Z side) of the coil 53b. A material constituting the third core part 53e is, for example, a soft magnetic composite. In the present embodiment, the third core part 53e is a member having the same size and the same shape as those of the second core part 53d.

As illustrated in FIG. 29, the coil 53b has an annular shape in a planar view in the axial direction. The coil 53b surrounds the stator core 53a. In the present embodiment, the coil 53b is located on the outer side, in the radial direction, of the core body portion 53i of the first core part 53c, and surrounds the core body portion 53i. Although not illustrated, the coil 53b is formed by a conductive wire wound around the stator core 53a. The conductive wire constituting the coil 53b is, for example, a rectangular wire. The conductive wire constituting the coil 53b may be a round wire.

Each of the plurality of electromagnet sections 53 functions as a magnet by a current flowing through the coil 53b. As illustrated in FIG. 30, each of the plurality of electromagnet sections 53 includes a magnetic pole 53f and a magnetic pole 53g. That is, the stator 50 includes the plurality of magnetic poles 53f and the plurality of magnetic poles 53g. Each of the magnetic poles 53f, 53g is a part that functions as a magnetic pole of a magnet by a current flowing through the coil 53b of each electromagnet section 53. When a current flows through the coil 53b of the electromagnet section 53, one of the magnetic pole 53f or the magnetic pole 53g becomes an N pole, and the other becomes an S pole. The magnetic pole 53f and the magnetic pole 53g are switched between the N pole and the S pole by reversing a direction of the current flowing through the coil 53b.

The respective magnetic poles 53f are end portions of the respective stator cores 53a on the rear side (−Z side). The respective magnetic poles 53g are end portions of the respective stator cores 53a on the front side (+Z side). That is, each stator core 53a includes the magnetic pole 53f and the magnetic pole 53g. The magnetic pole 53f is constituted by the end portion of the first core part 53c on the rear side, that is, the connecting portion 53k, and the third core part 53e. The magnetic pole 53g is constituted by the end portion of the first core part 53c on the front side, that is, the connecting portion 53j, and the second core part 53d. As illustrated in FIG. 6, the plurality of magnetic poles 53f face an end surface of the first rotor 20 on the front side. The plurality of magnetic poles 53g face an end surface of the second rotor 30 on the rear side. In the present embodiment, the end surface of the first rotor 20 on the front side is an end surface of the first cover 24 on the front side, and is a surface, on the front side, of the first top plate portion 24c of the first cover 24. In the present embodiment, the end surface of the second rotor 30 on the rear side is an end surface of the first cover 34 on the rear side, and is a surface, on the rear side, of a first top plate portion 34c of the first cover 34.

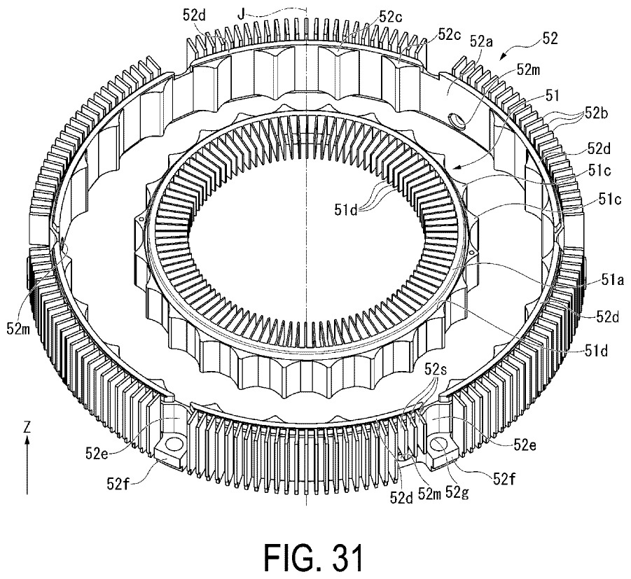

As illustrated in FIG. 31, the inner housing 51 has an annular shape surrounding the center axis J. In the present embodiment, the inner housing 51 has a circular annular shape having a center that coincides with the center axis J in a planar view in the axial direction. In the present embodiment, the inner housing 51 is made of a non-magnetic metal. The metal constituting the inner housing 51 is, for example, aluminum. As illustrated in FIG. 29, the inner housing 51 is located on the inner side of the plurality of electromagnet sections 53 in the radial direction. The inner housing 51 includes an inner housing annular portion 51a, a plurality of inner fins 51b, and a plurality of first housing protruding portions 51c.

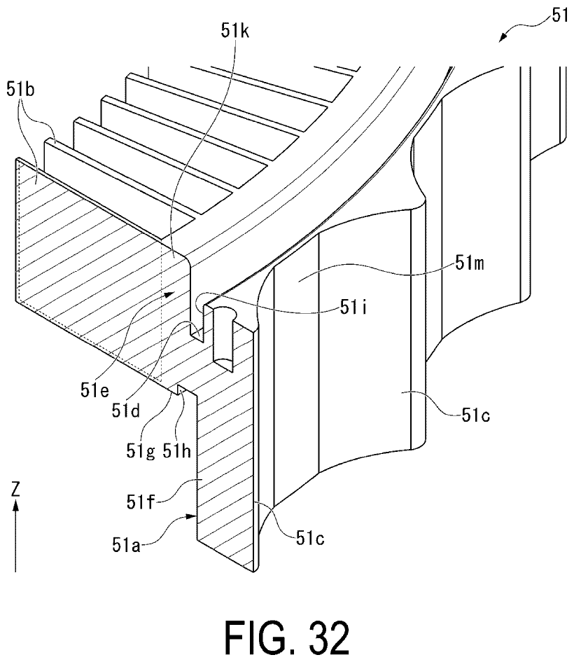

As illustrated in FIG. 31, the inner housing annular portion 51a has an annular shape surrounding the center axis J. In the present embodiment, the inner housing annular portion 51a has a circular annular shape having a center that coincides with the center axis J in a planar view in the axial direction. As illustrated in FIG. 32, the inner housing annular portion 51a includes a first annular portion 51e and a second annular portion 51f. The first annular portion 51e is apart on the front side (+Z side) of the inner housing annular portion 51a. The first annular portion 51e includes, on the front side, a first groove 51d recessed toward the rear side (−Z side). The first groove 51d has an annular shape surrounding the center axis J. That is, the inner housing 51 includes, on the front side, the first groove 51d recessed toward the rear side and surrounding the center axis J. The first groove 51d has a circular annular shape having a center that coincides with the center axis J in a planar view in the axial direction. A surface of an inner surface of the first groove 51d, the surface being located on the outer side in the radial direction, is an inner contact surface 51i. That is, the inner housing 51 includes the inner contact surface 51i. The inner contact surface 51i is a surface extending in the circumferential direction and facing the inner side in the radial direction. In the present embodiment, the inner contact surface 51i has a circular annular shape having a center that coincides with the center axis J in a planar view in the axial direction.

A part of the first annular portion 51e that is located on the inner side of the first groove 51d in the radial direction is an inner portion 51k. Apart of the first annular portion 51e that is located on the outer side of the first groove 51d in the radial direction is an outer portion 51m. An inner circumferential surface of the inner portion 51k is an inner circumferential surface of the first annular portion 51e and constitutes part of an inner circumferential surface of the inner housing annular portion 51a. An outer circumferential surface of the inner portion 51k includes a surface of the inner surface of the first groove 51d, the surface being located on the inner side in the radial direction. The outer circumferential surface of the outer portion 51m is an outer circumferential surface of the first annular portion 51e and constitutes part of an outer circumferential surface of the inner housing annular portion 51a. An inner circumferential surface of the outer portion 51m is the inner contact surface 51i. An end portion of the inner portion 51k on the front side (+Z side) is located frontward of an end portion of the outer portion 51m on the front side. A thickness of the inner portion 51k in the radial direction between the inner circumferential surface and the outer circumferential surface is larger than a thickness of the outer portion 51m in the radial direction between the inner circumferential surface and an outer circumferential surface.

The second annular portion 51f is a part on the rear side (−Z side) of the inner housing annular portion 51a. The second annular portion 51f is connected to an end portion of the first annular portion 51e on the rear side. More specifically, the second annular portion 51f is connected to an end portion of the outer portion 51m on the rear side. An inner diameter of the second annular portion 51f is larger than an inner diameter of the first annular portion 51e. An inner circumferential surface of the second annular portion 51f is located outward of the inner circumferential surface of the first annular portion 51e in the radial direction. The inner circumferential surface of the second annular portion 51f constitutes part of the inner circumferential surface of the inner housing annular portion 51a. An outer circumferential surface of the second annular portion 51f constitutes part of the outer circumferential surface of the inner housing annular portion 51a. The outer circumferential surface of the second annular portion 51f is provided at the same position as that of the outer circumferential surface of the outer portion 51m in the radial direction. The outer circumferential surface of the second annular portion 51f is connected to the rear side of the outer circumferential surface of the outer portion 51m without a step.

A stepped surface 51g facing the rear side is provided between the first annular portion 51e and the second annular portion 51f in the axial direction. That is, the inner housing annular portion 51a includes, on the inner circumferential surface, the stepped surface 51g facing the rear side. The stepped surface 51g has an annular shape surrounding the center axis J. More specifically, the stepped surface 51g has a circular annular shape having a center that coincides with the center axis J in a planar view in the axial direction. The stepped surface 51g is a surface on the rear side (−Z side) of a part of the first annular portion 51e, the part being located inward of the second annular portion 51f in the radial direction. The stepped surface 51g is orthogonal to the axial direction. The stepped surface 51g is provided with a seal groove 51h recessed toward the front side (+Z side). The seal groove 51h has a circular annular shape having a center that coincides with the center axis J in a planar view in the axial direction.

As illustrated in FIG. 29, the inner housing annular portion 51a includes an inner housing recess portion 51n recessed from the inner circumferential surface of the inner housing annular portion 51a toward the outer side in the radial direction. In the present embodiment, the inner housing recess portion 51n is recessed from the inner circumferential surface of the second annular portion 51f toward the outer side in the radial direction. Although not illustrated, in the present embodiment, the inner housing recess portion 51n is a groove extending in the axial direction. The inner housing recess portion 51n is open to the rear side (−Z side). An inner surface of the inner housing recess portion 51n has a semicircular arc shape recessed toward the outer side in the radial direction in a planar view in the axial direction. The inner housing recess portion 51n is provided on an inner circumferential surface of a circumferential part of the inner housing annular portion 51a where the first housing protruding portion 51c is provided on the outer circumferential surface. A center in the circumferential direction of the inner housing recess portion 51n is provided at the same position in the circumferential direction as a center in the circumferential direction of one first housing protruding portion 51c.

As illustrated in FIG. 32, the plurality of inner fins 51b protrude from the inner circumferential surface of the inner housing annular portion 51a toward the inner side in the radial direction. In the present embodiment, the plurality of inner fins 51b protrude from the inner circumferential surface of the first annular portion 51e, that is, the inner circumferential surface of the inner portion 51k, toward the inner side in the radial direction. The plurality of inner fins 51b protrude radially inward from a part of the inner circumferential surface of the inner housing annular portion 51a, the part being located frontward (+Z side) of the stepped surface 51g. The plurality of inner fins 51b each have a plate shape with a plate surface facing the circumferential direction. The plurality of inner fins 51b each have a rectangular shape long in the radial direction as viewed in the circumferential direction. A dimension of each of the plurality of inner fins 51b in the axial direction is the same as a dimension of the inner portion 51k in the axial direction. The plurality of inner fins 51b are disposed spaced apart in the circumferential direction. As illustrated in FIG. 31, the plurality of inner fins 51b are disposed at equal intervals across the entire inner circumferential surface of the inner housing annular portion 51a in the circumferential direction. An interval between the inner fins 51b adjacent to each other in the circumferential direction is smaller than a dimension of the inner fin 51b in the radial direction.

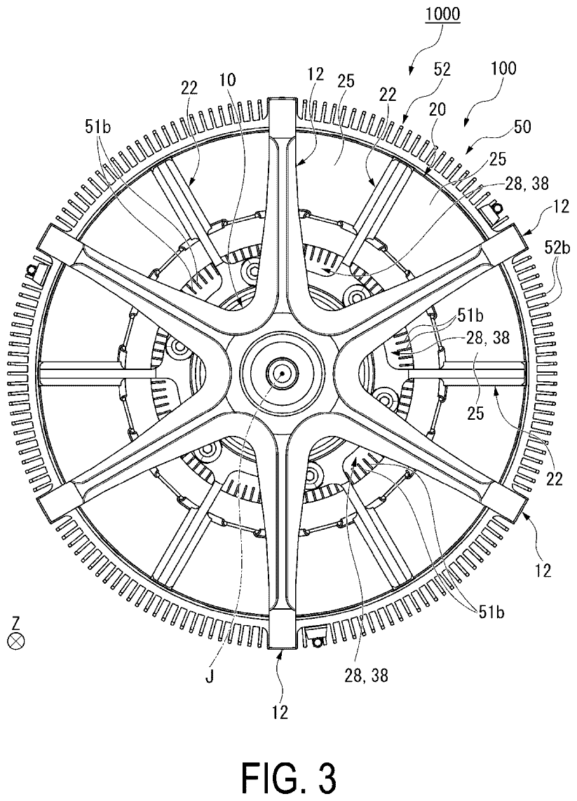

As illustrated in FIG. 3, the plurality of inner fins 51b each include a part provided at the same position as that of the first rotor penetrating portion 28 in the radial direction and a part provided at the same position as that of the second rotor penetrating portion 38 in the radial direction. The first rotor penetrating portion 28 and the second rotor penetrating portion 38 each include a part overlapping at least one inner fin 51b in a planar view in the axial direction. In the present embodiment, the first rotor penetrating portions 28 and the second rotor penetrating portions 38 overlap the plurality of inner fins 51b in a planar view in the axial direction. The inner fin 51b that overlaps the first rotor penetrating portion 28 and the second rotor penetrating portion 38 in the axial direction is sequentially changed to another inner fin 51b as the first rotor 20 and the second rotor 30 rotate. Regardless of rotational positions of the first rotor 20 and the second rotor 30, each first rotor penetrating portion 28 and each second rotor penetrating portion 38 overlap at least one inner fin 51b in the axial direction. Regardless of the rotational positions of the first rotor 20 and the second rotor 30, one or more of the inner fins 51b of the plurality of inner fins 51b are exposed to the rear side (−Z side) of the motor 100 through the first rotor penetrating portion 28. Regardless of the rotational positions of the first rotor 20 and the second rotor 30, one or more of the inner fins 51b of the plurality of inner fins 51b are exposed to the front side (+Z side) of the motor 100 through the second rotor penetrating portion 38.

As illustrated in FIG. 32, the plurality of first housing protruding portions 51c protrude from the outer circumferential surface of the inner housing annular portion 51a toward the outer side in the radial direction. In the present embodiment, the plurality of first housing protruding portions 51c are provided across the outer circumferential surface of the first annular portion 51e, that is, the outer circumferential surface of the outer portion 51m, and the outer circumferential surface of the second annular portion 51f. The plurality of first housing protruding portions 51c extend in the axial direction from an end portion of the outer circumferential surface of the outer portion 51m on the front side (+Z side) to an end portion of the outer circumferential surface of the second annular portion 51f on the rear side (−Z side). The plurality of first housing protruding portions 51c are disposed spaced apart in the circumferential direction. As illustrated in FIG. 31, the plurality of first housing protruding portions 51c are disposed at equal intervals across the entire circumference in the circumferential direction. A number of the first housing protruding portions 51c is the same as a number of the electromagnet sections 53. That is, in the present embodiment, 24 first housing protruding portions 51c are provided.

As illustrated in FIG. 29, a dimension of each of the plurality of first housing protruding portions 51c in the circumferential direction decreases toward the outer side in the radial direction. The first housing protruding portion 51c has a substantially triangular shape protruding toward the outer side in the radial direction in a planar view in the axial direction. A side surface of the first housing protruding portion 51c in the circumferential direction is a curved surface recessed toward the inner side in the radial direction in a planar view in the axial direction. At least part of each first housing protruding portion 51c is located between, in the circumferential direction, end portions of the coils 53b adjacent to each other in the circumferential direction, the end portions being on the inner side in the radial direction. In the present embodiment, a radial outer portion of each first housing protruding portion 51c is located between, in the circumferential direction, the end portions of the coils 53b adjacent to each other in the circumferential direction, the end portions being on the inner side in the radial direction.

As illustrated in FIG. 31, the outer housing 52 has an annular shape surrounding the center axis J. In the present embodiment, the outer housing 52 has a circular annular shape having a center that coincides with the center axis J in a planar view in the axial direction. The outer housing 52 is located outwardly away from the inner housing 51 in the radial direction. The outer housing 52 surrounds the inner housing 51. In the present embodiment, the outer housing 52 is made of a non-magnetic metal. The metal constituting the outer housing 52 is, for example, aluminum. As illustrated in FIG. 29, the outer housing 52 is located on the outer side of the plurality of electromagnet sections 53 in the radial direction. The outer housing 52 surrounds the plurality of electromagnet sections 53. As illustrated in FIG. 1 to FIG. 3, the outer housing 52 is located outward, in the radial direction, of a radial outer edge of the first rotor 20 and a radial outer edge of the second rotor 30. That is, the stator 50 includes the outer housing 52 as a part located outward of the first rotor 20 and the second rotor 30 in the radial direction. As illustrated in FIG. 31, the outer housing 52 includes an outer housing annular portion 52a, a plurality of outer fins 52b, a plurality of second housing protruding portions 52c, a fourth protruding wall 52d, and a plurality of the housing fixed portions 52f.

The outer housing annular portion 52a has an annular shape surrounding the center axis J. In the present embodiment, the outer housing annular portion 52a has a circular annular shape having a center that coincides with the center axis J in a planar view in the axial direction. As illustrated in FIG. 27, the outer housing annular portion 52a surrounds the plurality of electromagnet sections 53. In a planar view in the axial direction, a radial outer edge of the outer housing annular portion 52a includes a plurality of outer housing recess portions 52e recessed toward the inner side in the radial direction and disposed spaced apart in the circumferential direction. The plurality of outer housing recess portions 52e are disposed at equal intervals across the entire circumference in the circumferential direction. In the present embodiment, six outer housing recess portions 52e are provided. The respective housing fixed portions 52f are provided at respective end portions of the outer housing recess portions 52e on the rear side (−Z side).

The plurality of outer fins 52b protrude from an outer circumferential surface of the outer housing annular portion 52a toward the outer side in the radial direction. In the present embodiment, the plurality of outer fins 52b protrude toward the outer side in the radial direction from parts of the outer circumferential surface of the outer housing annular portion 52a that are different in position in the circumferential direction from parts where the outer housing recess portions 52e and the housing fixed portions 52f are provided. The outer fin 52b is not disposed in a part of the outer circumferential surface of the outer housing annular portion 52e where the outer housing recess portion 52f and the housing fixed portion 52b are provided. The plurality of outer fins 52b each have a plate shape with a plate surface facing the circumferential direction. The plurality of outer fins 52b each have a rectangular shape long in the axial direction as viewed in the circumferential direction.

As illustrated in FIG. 30, a dimension of each of the plurality of outer fins 52b in the axial direction is greater than a dimension of the outer housing annular portion 52a in the axial direction. An end portion of each of the plurality of outer fins 52b on the front side (+Z side) is located frontward of an end portion of the outer housing annular portion 52a on the front side. That is, the plurality of outer fins 52b each protrude frontward of the outer housing annular portion 52a. An end portion of each of the plurality of outer fins 52b on the rear side (−Z side) is provided at the same position in the axial direction as an end portion of the outer housing annular portion 52a on the rear side. A cutout portion 52t is provided at an end portion on an outer side in the radial direction of the end portion of each outer fin 52b on the rear side. As illustrated in FIG. 31, the plurality of outer fins 52b are disposed spaced apart in the circumferential direction. The plurality of outer fins 52b are disposed at equal intervals in the circumferential direction in each part of the outer housing annular portion 52a between the outer housing recess portions 52e adjacent to each other in the circumferential direction. An interval between the outer fins 52b adjacent to each other in the circumferential direction is smaller than a dimension of the outer fin 52b in the radial direction.

As illustrated in FIG. 6, an end portion of the outer fin 52b on the outer side in the radial direction is located outward, in the radial direction, of the radial outer edge of the first rotor 20 and the radial outer edge of the second rotor 30. In other words, the radial outer edge of the first rotor 20 and the radial outer edge of the second rotor 30 are located inward, in the radial direction, of the end portions of the plurality of outer fins 52b on the outer side in the radial direction. In the present embodiment, the outer fin 52b, as a whole, is located outward, in the radial direction, of the radial outer edge of the first rotor 20 and the radial outer edge of the second rotor 30.

In the present embodiment, the stator 50 is provided with the plurality of inner fins 51b and the plurality of outer fins 52b, making it possible to improve a heat dissipation of the stator 50. Specifically, the first rotor penetrating portion 28 and the second rotor penetrating portion 38 each include a part overlapping at least one inner fin 51b in a planar view in the axial direction. As a result, air passing through the first rotor penetrating portion 28 and the second rotor penetrating portion 38 can readily come into contact with at least one inner fin 51b. This facilitates the release of heat of the stator 50 from the plurality of inner fins 51b into the air. Accordingly, the heat dissipation of the stator 50 can be improved. Thus, in the motor 100 of an axial flux type, rotor penetrating portions are provided in the respective rotors, and the rotor penetrating portions are opened to the space on the inner side of the stator 50 in the radial direction, thereby facilitating the flow of air to the inner side of the stator 50 in the radial direction through the rotor penetrating portions. This makes it possible to improve the heat dissipation of the stator 50. Further, in the present embodiment, the radial outer edge of the first rotor 20 and the radial outer edge of the second rotor 30 are located inward, in the radial direction, of the end portions of the plurality of outer fins 52b on the outer side in the radial direction. As a result, coverage of the plurality of outer fins 52b by the first rotor 20 and the second rotor 30 from both sides in the axial direction is suppressed, making it possible to readily bring the air flowing in the axial direction relative to the motor 100 into contact with the plurality of outer fins 52b. This facilitates the release of the heat of the stator 50 from the plurality of outer fins 52b into the air. Accordingly, the heat dissipation of the stator 50 can be further improved.

In the present embodiment, the first rotor 20 and the second rotor 30 rotate, thereby rotating the propeller 1100, generating a flow of air from the front side (+Z side) toward the rear side (−Z side). Part of the air passes through the second rotor penetrating portions 38, comes into contact with the plurality of inner fins 51b, and flows to the rear side of the motor 100 through the first rotor penetrating portions 28. Another part of the air flows to the rear side on the outer side of the second rotor 30 in the radial direction, comes into contact with the plurality of outer fins 52b, and flows to the rear side of the motor 100 through the outer side of the first rotor 20 in the radial direction.

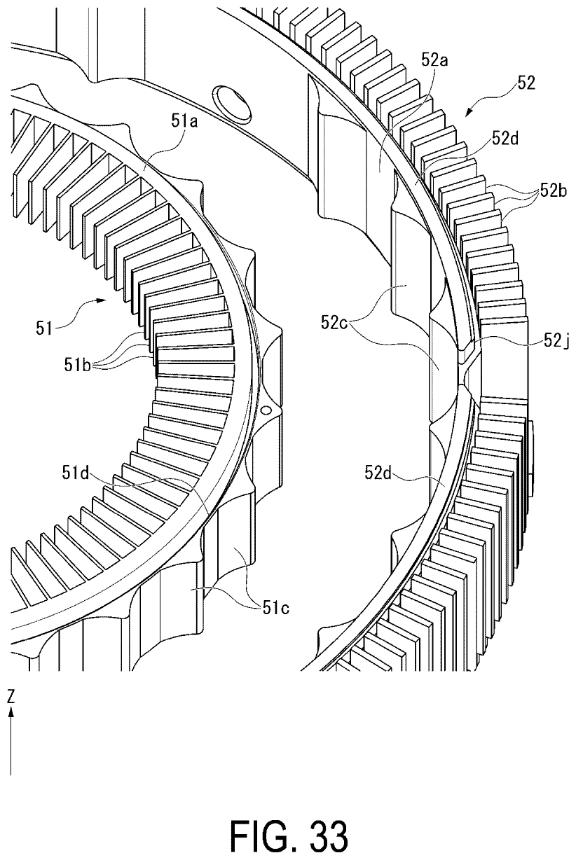

As illustrated in FIG. 33, the plurality of second housing protruding portions 52c protrude from the inner circumferential surface of the outer housing annular portion 52a toward the inner side in the radial direction. The plurality of second housing protruding portions 52c extend in the axial direction. The plurality of second housing protruding portions 52c are disposed spaced apart in the circumferential direction. As illustrated in FIG. 31, the plurality of second housing protruding portions 52c are provided on parts of the inner circumferential surface of the outer housing annular portion 52a that differ from parts where housing through-holes 52m described below are provided. The plurality of second housing protruding portions 52c are provided at positions facing the outer sides of the first housing protruding portions 51c in the radial direction. A number of the second housing protruding portions 52c is less than the number of the first housing protruding portions 51c by the number of the housing through-holes 52m provided. Three housing through-holes 52m are provided. That is, in the present embodiment, 21 second housing protruding portions 52c are provided.

As illustrated in FIG. 29, a dimension of each of the plurality of second housing protruding portions 52c in the circumferential direction decreases toward the inner side in the radial direction. The second housing protruding portion 52c has a substantially triangular shape protruding toward the inner side in the radial direction in a planar view in the axial direction. A side surface of the second housing protruding portion 52c in the circumferential direction is a curved surface recessed toward the outer side in the radial direction in a planar view in the axial direction. At least part of each second housing protruding portion 52c is located between, in the circumferential direction, end portions of the coils 53b adjacent to each other in the circumferential direction, the end portions being on the outer side in the radial direction. In the present embodiment, a radial inner portion of each second housing protruding portion 52c is located between, in the circumferential direction, the end portions of the coils 53b adjacent to each other in the circumferential direction, the end portions being on the outer side in the radial direction.

As illustrated in FIG. 33, the fourth protruding wall 52d is a protruding wall protruding toward the front side from a radial inner edge of a surface of the outer housing annular portion 52a on the front side (+Z side). The fourth protruding wall 52d extends in the circumferential direction. The fourth protruding wall 52d is located inwardly away in the radial direction from a part of each of the plurality of outer fins 52b that protrudes frontward of the outer housing annular portion 52a. That is, apart of each of the plurality of outer fins 52b that is located frontward of the outer housing annular portion 52a is located on the outer side of the fourth protruding wall 52d in the radial direction. An end portion of the fourth protruding wall 52d on the front side is located rearward (−Z side) of the end portions of the plurality of outer fins 52b on the front side. A surface of the fourth protruding wall 52d on the outer side in the radial direction is an outer contact surface 52j. That is, the outer housing 52 includes the outer contact surface 52j. The outer contact surface 52j faces the outer side in the radial direction. The outer contact surface 52j extends in the circumferential direction.

As illustrated in FIG. 31, a plurality of the fourth protruding walls 52d are provided spaced apart in the circumferential direction. Each fourth protruding wall 52d is provided at an end portion on the front side (+Z side) of a part of the outer housing annular portion 52a that is located between the outer housing recess portions 52e adjacent to each other in the circumferential direction. In the present embodiment, six fourth protruding walls 52d are provided.

The plurality of housing fixed portions 52f protrude from the outer circumferential surface of the outer housing annular portion 52a toward the outer side in the radial direction. In the present embodiment, the plurality of housing fixed portions 52f respectively protrude from the plurality of outer housing recess portions 52e toward the outer side in the radial direction. More specifically, the plurality of housing fixed portions 52f respectively protrude from end portions of the plurality of outer housing recess portions 52e on the rear side (−Z side) toward the outer side in the radial direction. The plurality of housing fixed portions 52f are arranged spaced apart in the circumferential direction. The plurality of housing fixed portions 52f are arranged at equal intervals across the entire circumference in the circumferential direction.

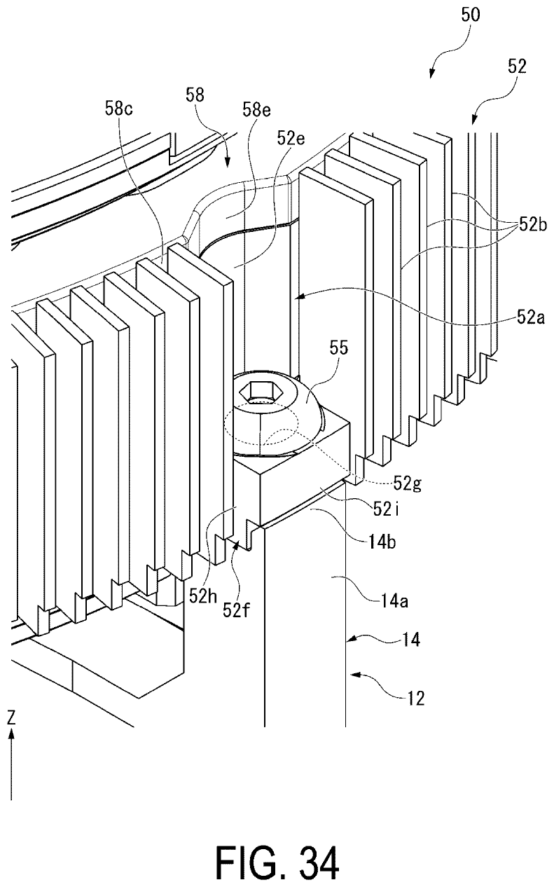

As illustrated in FIG. 34, the housing fixed portion 52f includes a body portion 52h and a protruding portion 52i. The body portion 52h has a substantially rectangular parallelepiped shape. The body portion 52h includes a hole 52g penetrating the body portion 52h in the axial direction. The protruding portion 52i protrudes from a part of the body portion 52h on the front side (+Z side) toward the outer side in the radial direction. The protruding portion 52i has a substantially rectangular parallelepiped shape.

The plurality of housing fixed portions 52f are respectively located on the front sides (+Z side) of the support column parts 14 of the plurality of stator support sections 12. Each support column part 14 of the plurality of stator support sections 12 comes into contact with a surface of the housing fixed portion 52f on the rear side (−Z side). Thus, the support column parts 14 of the plurality of stator support sections 12 come into contact, from the rear side, with a part of the stator 50 that is located outward of the first rotor 20 in the radial direction. Therefore, the stator 50 interposed between the first rotor 20 and the second rotor 30 in the axial direction can be stably supported in the axial direction by the plurality of stator support sections 12. Accordingly, inclination of the stator 50 relative to the center axis J can be suppressed. Further, a gap is provided between the stator support sections 12 adjacent to each other in the circumferential direction, and thus a surface of the first rotor 20 on the rear side as a whole is not covered by the plurality of stator support sections 12. This makes it possible to suppress blockage of the air flowing through the first rotor penetrating portions 28 by the plurality of stator support sections 12, and suppress reduction in the heat dissipation of the motor 100.

In the present embodiment, a surface of the body portion 52h on the rear side (−Z side) comes into contact with the surface of the support column body portion 14a on the front side (+Z side). An end portion of the body portion 52h on the rear side is located on the inner side of the wall portion 14b in the radial direction. A surface of the body portion 52h on the outer side in the radial direction comes into contact with a surface of the wall portion 14b on the inner side in the radial direction. The surface of the body portion 52h on the outer side in the radial direction may face the surface of the wall portion 14b on the inner side in the radial direction with a gap therebetween. The protruding portion 52i is located on the front side of the wall portion 14b. A gap is provided between the protruding portion 52i and the wall portion 14b in the axial direction. Note that the protruding portion 52i and the wall portion 14b may come into contact with each other.

As illustrated in FIG. 6, a bolt 55 is passed through the hole 52g from the front side (+Z side). The bolt 55 passed through the hole 52g is fastened into the threaded hole 14c provided in the surface of the support column body portion 14a on the front side. Thus, the respective support column parts 14 are fixed to the respective housing fixed portions 52f with the bolts 55. Accordingly, the stator 50 can be fixed to the plurality of stator support sections 12, and the stator 50 can be more stably supported. Further, because the stator 50 can be fixed to each stator support section 12 by the bolts 55, the stator 50 can be firmly fixed to the plurality of stator support sections 12. Further, with the plurality of housing fixed portions 52f disposed spaced apart in the circumferential direction, the plurality of outer fins 52b can be provided on parts of the outer circumferential surface of the outer housing annular portion 52a where the housing fixed portions 52f are not provided. This facilitates the release of the heat of the stator 50 by the plurality of outer fins 52b into the air that comes into contact with the plurality of outer fins 52b. Accordingly, the heat dissipation of the stator 50 can be further improved.

As illustrated in FIG. 31, the outer housing 52 includes the housing through-hole 52m that penetrates from an inner circumferential surface to an outer circumferential surface of the outer housing 52. The housing through-hole 52m penetrates a part of the outer housing annular portion 52a on the rear side (−Z side) from the inner circumferential surface to the outer circumferential surface in the radial direction. In the present embodiment, the housing through-hole 52m has a circular shape as viewed in the radial direction. A plurality of the housing through-holes 52m are provided spaced apart in the circumferential direction. In the present embodiment, three housing through-holes 52m are provided. The plurality of outer fins 52b include outer fins 52s provided on an outer circumferential surface of a circumferential part of the outer housing annular portion 52a where the housing through-holes 52m are provided. An end portion of each outer fin 52s on the rear side is located frontward (+Z side) of the outer fins 52b provided in the other circumferential parts. The end portion of the outer fin 52s on the rear side is located frontward of the housing through-hole 52m. A plurality of the outer fins 52s are provided for one housing through-hole 52m.

As illustrated in FIG. 30, an end portion of the inner housing 51 on the front side (+Z side) and an end portion of the outer housing 52 on the front side are provided at the same position in the axial direction. The end portion of the inner housing 51 on the front side is an end portion of the inner housing annular portion 51a on the front side, and is an end portion of the first annular portion 51e on the front side. The end portion of the outer housing 52 on the front side is the end portions of the plurality of outer fins 52b on the front side. An end portion of the inner housing 51 on the rear side (−Z side) is located frontward of an end portion of the outer housing 52 on the rear side. The end portion of the inner housing 51 on the rear side is located frontward of an end portion of the coil 53b on the rear side. The end portion of the inner housing 51 on the rear side is an end portion of the inner housing annular portion 51a on the rear side, and is an end portion of the second annular portion 51f on the rear side. The end portion of the outer housing 52 on the rear side is the end portion of the outer housing annular portion 52a on the rear side and the end portions of the plurality of outer fins 52b on the rear side.

As illustrated in FIG. 29, the plurality of electromagnet sections 53 are disposed between the inner housing 51 and the outer housing 52 in the radial direction. Part of the resin section 80 is filled between the inner housing 51 and the outer housing 52 in the radial direction. The coil 53b of each of the plurality of electromagnet sections 53 is embedded in the resin section 80. This makes it possible to transfer heat generated at each coil 53b to the inner housing 51 and the outer housing 52 through the resin section 80. The heat transferred to the inner housing 51 is released from the plurality of inner fins 51b into the air outside the motor 100. The heat transferred to the outer housing 52 is released from the plurality of outer fins 52b into the air outside the motor 100. Accordingly, the heat dissipation of the stator 50 can be further improved.

As illustrated in FIG. 30, the resin section 80 includes a first resin portion 81 and a second resin portion 82. The first resin portion 81 is a part of the resin section 80 on the front side (+Z side). The first resin portion 81 is a part filled between the inner housing 51 and the outer housing 52 in the radial direction. The first resin portion 81 has an annular shape surrounding the center axis J. The second resin portion 82 is a part of the resin section 80 on the rear side (−Z side). The second resin portion 82 is connected to the rear side of the first resin portion 81. The second resin portion 82 has an annular shape surrounding the center axis J. An inner circumferential surface of the second resin portion 82 is located inward of an inner circumferential surface of the first resin portion 81 in the radial direction. A part of the second resin portion 82 that is located inward of the first resin portion 81 in the radial direction is a part covering a surface of a bus bar holder 61, described below, on the rear side and the end portion of the inner housing annular portion 51a on the rear side. The inner circumferential surface of the second resin portion 82 is provided at the same position in the radial direction as that of an inner circumferential surface of the bus bar holder 61 described below. A surface of the second resin portion 82 on the rear side constitutes part of a surface of the stator 50 on the rear side. The magnetic poles 53f of the plurality of electromagnet sections 53 are exposed on the surface of the second resin portion 82 on the rear side.

The resin section 80 is formed by assembling a jig to an assembly obtained by assembling the stator 50 and the bus bar assembly 60 in a state in which components other than the resin section 80 are assembled, and pouring resin into an interior surrounded by the jig, the inner housing 51, the outer housing 52, and the stator cover 58. The resin constituting the resin section 80 is, for example, an epoxy resin.

In the present embodiment, as described above, at least part of each first housing protruding portion 51c is located between, in the circumferential direction, the end portions of the coils 53b adjacent to each other in the circumferential direction, the end portions being on the inner side in the radial direction. As a result, the first housing protruding portions 51c, which are parts of the inner housing 51, can be arranged close to the coils 53b. This makes it possible to shorten a shortest distance between the coil 53b and the inner housing 51, and better facilitate heat transfer from the coil 53b to the inner housing 51 through the resin section 80. Further, at least part of each second housing protruding portion 52c is located between, in the circumferential direction, the end portions of the coils 53b adjacent to each other in the circumferential direction, the end portions being on the outer side in the radial direction. As a result, the second housing protruding portions 52c, which are parts of the outer housing 52, can be arranged close to the coils 53b. This makes it possible to shorten a shortest distance between the coil 53b and the outer housing 52, and better facilitate heat transfer from the coil 53b to the outer housing 52 through the resin section 80. Accordingly, heat at the coils 53b can be more readily transferred to the inner housing 51 and the outer housing 52, and the heat dissipation of the stator 50 can be further improved.

In the present embodiment, as described above, the dimension of each of the plurality of first housing protruding portions 51c in the circumferential direction decreases toward the outer side in the radial direction. The dimension of each of the plurality of second housing protruding portions 52c in the circumferential direction decreases toward the inner side in the radial direction. As a result, a shape of each of the plurality of first housing protruding portions 51c and a shape of each of the plurality of second housing protruding portions 52c can be readily made to conform to a shape of each the coils 53b having an annular shape in a planar view in the axial direction. This makes it possible to readily bring a circumferential side surface of each housing protruding portion close to each coil 53b while suppressing contact with each coil 53b by each housing protruding portion. Accordingly, the heat dissipation of the stator 50 can be further improved.

As illustrated in FIG. 27, the stator cover 58 has an annular shape surrounding the center axis J. In the present embodiment, the stator cover 58 has an annular shape having a center that coincides with the center axis J in a planar view in the axial direction. The stator cover 58 is fixed to the end portion of the inner housing 51 on the front side (+Z side) and the end portion of the outer housing 52 on the front side. The stator cover 58 closes a part of an area between, in the radial direction, the end portion of the inner housing 51 on the front side and the end portion of the outer housing 52 on the front side. A material constituting the stator cover 58 is a non-magnetic material and is a material having non-conductivity. In the present embodiment, the stator cover 58 is made of a resin. The resin constituting the stator cover 58 is a resin having excellent thermal conductivity. Examples of the resin constituting the stator cover 58 include a resin mixed with graphite or ceramic.

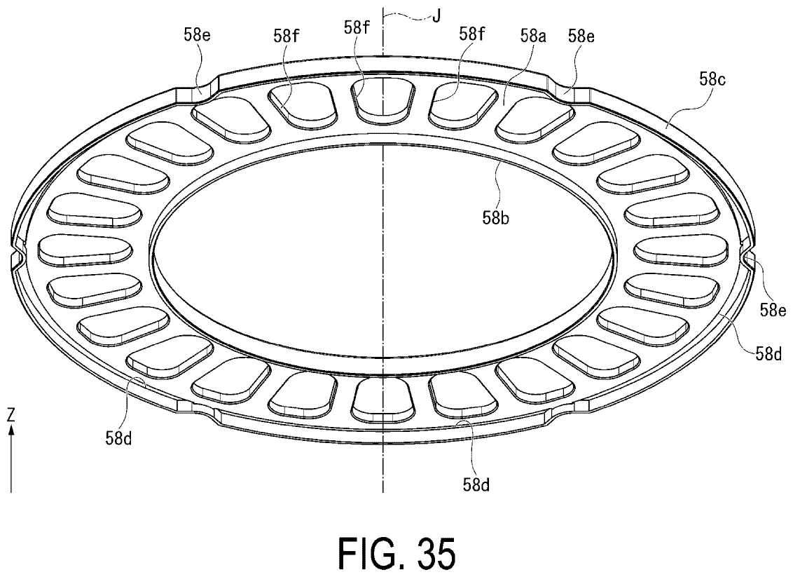

As illustrated in FIG. 35, the stator cover 58 includes a cover body portion 58a, an inner annular wall 58b, and an outer annular wall 58c. The cover body portion 58a has an annular shape surrounding the center axis J. More specifically, the cover body portion 58a has a circular annular shape having a center that coincides with the center axis J in a planar view in the axial direction. The cover body portion 58a has a plate shape with a plate surface facing the axial direction. The cover body portion 58a includes a plurality of cover through-holes 58f penetrating the cover body portion 58a in the axial direction. The plurality of cover through-holes 58f are disposed spaced apart in the circumferential direction. The plurality of cover through-holes 58f are disposed at equal intervals across the entire circumference in the circumferential direction.

As illustrated in FIG. 27, the respective second core parts 53d of the plurality of electromagnet sections 53 are disposed inside the respective cover through-holes 58f. Each second core part 58f is fitted inside each cover through-hole 53d. An inner edge of each cover through-hole 58f has the same shape as that of an outer edge of each second core part 53d in a planar view in the axial direction. In the present embodiment, the inner edge of each cover through-hole 58f comes into contact with the outer edge of each second core part 53d across the entire circumference. Accordingly, heat generated at the coil 53b can be transmitted from the second core part 53d to the stator cover 58. Heat transferred to the stator cover 58 is transferred to the inner housing 51 or the outer housing 52, and released from the inner fins 51b or the outer fins 52b into the air outside the motor 100. Accordingly, the heat dissipation of the stator 50 can be further improved. In the present embodiment, with the stator cover 58 being made of a resin having excellent thermal conductivity, heat is more readily transferred from the second core parts 53d to the stator cover 58. Accordingly, the heat dissipation of the stator 50 can be further improved.

As illustrated in FIG. 35, the cover body portion 58a includes, at a radial outer edge of a surface on the rear side (−Z side), a second groove 58d recessed toward the front side (+Z side) and extending in the circumferential direction. In the present embodiment, a plurality of the second grooves 58d are provided spaced apart in the circumferential direction. A number of the second grooves 58d is the same as a number of the fourth protruding walls 52d. That is, in the present embodiment, six second grooves 58d are provided. As illustrated in FIG. 30, an end portion of the fourth protruding wall 52d on the front side is fitted into the second groove 58d. A surface on the inner side of the fourth protruding wall 52d in the radial direction comes into contact with a surface of an inner surface of the second groove 58d, the surface being located on the inner side in the radial direction. A surface on the outer side of the fourth protruding wall 52d in the radial direction comes into contact with a surface of the inner surface of the second groove 58d, the surface being located on the outer side in the radial direction. An end surface of the fourth protruding wall 52d on the front side comes into contact with a surface of the inner surface of the second groove 58d, the surface being located on the front side. Note that the end portion of the fourth protruding wall 52d on the front side may face the surface of the inner surface of the second groove 58d, the surface being located on the front side, with a gap interposed therebetween.

As illustrated in FIG. 35, the inner annular wall 58b protrudes from an inner circumferential edge of the cover body portion 58a toward the rear side (−Z side). The inner annular wall 58b has an annular shape surrounding the center axis J. In the present embodiment, the inner annular wall 58b has a cylindrical shape about the center axis J. As illustrated in FIG. 30, the inner annular wall 58b is fitted into the first groove 51d. An outer circumferential surface of the inner annular wall 58b comes into contact with the inner contact surface 51i that is a surface located on the outer side, in the radial direction, of the inner surface of the first groove 51d. An inner circumferential surface of the inner annular wall 58b comes into contact with a surface of the inner surface of the first groove 51d, the surface being located on the inner side in the radial direction.

As illustrated in FIG. 35, the outer annular wall 58c protrudes from an outer circumferential edge of the cover body portion 58a toward the rear side (−Z side). The outer annular wall 58c has an annular shape surrounding the center axis J. In the present embodiment, the outer annular wall 58c has a cylindrical shape about the center axis J. As illustrated in FIG. 30, part of the outer annular wall 58c is located between the plurality of outer fins 52b and the fourth protruding wall 52d in the radial direction. An inner circumferential surface of the outer annular wall 58c comes into contact with the outer contact surface 52j that is a surface on the outer side of the fourth protruding wall 52d in the radial direction. The outer circumferential surface of the outer annular wall 58c comes into contact with a radial inner edge of each part of the plurality of outer fins 52b that protrudes frontward (+Z side) of the outer housing annular portion 52a. An end portion of the outer annular wall 58c on the rear side comes into contact with a radial outer edge of the end surface of the outer housing annular portion 52a on the front side. The end portion of the outer annular wall 58c on the rear side may face the radial outer edge of the end surface of the outer housing annular portion 52a on the front side with a gap therebetween.

As described above, in the present embodiment, the stator cover 58 closes part of an area in the radial direction between the end portion of the inner housing 51 on the front side (+Z side) and the end portion of the outer housing 52 on the front side. The stator cover 58 includes the inner annular wall 58b having an annular shape and the outer annular wall 58c having an annular shape, the outer circumferential surface of the inner annular wall 58b comes into contact with the inner contact surface 51i, and the inner circumferential surface of the outer annular wall 58c comes into contact with the outer contact surface 52j. Therefore, when the resin section 80 is formed by potting in which resin is poured into the area between the inner housing 51 and the outer housing 52 in the radial direction, it is possible to suppress leakage of the poured resin from between the inner housing 51 and the stator cover 58 and between the outer housing 52 and the stator cover 58. Further, the stator cover 58 is made of a resin, facilitating formation of a shape of the cover through-hole 58f in accordance with a shape of the second core part 53d. Further, even if the shape of the cover through-hole 58f is slightly different from the shape of the second core part 53d, the shape of the cover through-hole 58f can be easily matched with the shape of the second core part 53d by deforming the stator cover 58. As a result, the inner edge of the cover through-hole 58f and the outer edge of the second core part 53d are readily made to come into contact with each other with favorable accuracy. Accordingly, when the resin section 80 is molded, it is possible to suppress leakage of the resin from between the inner edge of the cover through-hole 58f and the outer edge of the second core part 53d. As described above, leakage of the resin when the resin section 80 is molded can be suppressed by the stator cover 58. This makes it possible to suppress adherence of the resin to an unintended location of the stator 50 when the resin section 80 is molded. Further, the outer circumferential surface of the inner annular wall 58b comes into contact with the inner contact surface 51i, and the inner circumferential surface of the outer annular wall 58c comes into contact with the outer contact surface 52j, making it possible to accurately position the stator cover 58 in the radial direction relative to the inner housing 51 and the outer housing 52. Further, the stator cover 58 is provided with the cover through-holes 58f in which the second core parts 53d are disposed. This makes it possible to accurately position the stator cover 58 in the radial direction relative to the inner housing 51 and the outer housing 52, and thus accurately position the electromagnet sections 53 including the second core part 53d in the radial direction relative to the inner housing 51 and the outer housing 52. Further, in the present embodiment, the stator cover 58 is made of a resin. Therefore, for example, as compared with a case in which the stator cover 58 is made of a ceramic, a linear expansion coefficient of the stator cover 58 tends to be a value close to a linear expansion coefficient of the inner housing 51 and the outer housing 52 made of a metal. Then, even when the inner housing 51, the outer housing 52, and the stator cover 58 expand due to heat, a difference between a deformation amount of the inner housing 51 and the outer housing 52 and a deformation amount of the stator cover 58 is likely to be small. Further, because resin deforms readily as compared with ceramic, even if there is a difference between the deformation amount of the inner housing 51 and the outer housing 52 and the deformation amount of the stator cover 58, the resin readily deforms in accordance with the deformation amount of the inner housing 51 and the outer housing 52. Accordingly, even if the inner housing 51, the outer housing 52, and the stator cover 58 expand due to heat, damage to the stator cover 58 is suppressed.

As described above, in the present embodiment, the surface of the inner surface of the first groove 51d provided in the inner housing 51, the surface being located on the outer side in the radial direction, is the inner contact surface 51i. The inner annular wall 58b is fitted into the first groove 51d. Therefore, the stator cover 58 is readily positioned in the radial direction relative to the inner housing 51 with higher accuracy. Further, with the first groove 51d being provided, a contact area between the inner annular wall 58b and the inner housing 51 readily increases. This makes it possible to further suppress leakage of the resin from between the inner annular wall 58b and the inner housing 51 when the resin section 80 is molded.

As described above, in the present embodiment, part of the outer annular wall 58c is located between the plurality of outer fins 52b and the fourth protruding wall 52d in the radial direction. This makes it possible to suppress displacement of the outer annular wall 58c toward the outer side in the radial direction relative to the outer housing 52 by utilizing the plurality of outer fins 52b. As a result, the stator cover 58 can be positioned in the radial direction relative to the outer housing 52 with higher accuracy.

As described above, in the present embodiment, the end portion of the fourth protruding wall 52d on the front side (+Z side) is fitted into the second groove 58d provided in the cover body portion 58a. This makes it possible to position the stator cover 58 in the radial direction relative to the outer housing 52 with higher accuracy.

As illustrated in FIG. 35, in a planar view in the axial direction, a radial outer edge of the stator cover 58 includes a plurality of stator cover recess portions 58e recessed toward the inner side in the radial direction and disposed spaced apart in the circumferential direction. In the present embodiment, the plurality of stator cover recess portions 58e are provided across a radial outer edge of the cover body portion 58a and the outer annular wall 58c. As illustrated in FIG. 34, the plurality of stator cover recess portions 58e respectively overlap the plurality of outer housing recess portions 52e, in a planar view in the axial direction. With provision of each outer housing recess portion 52e and each stator cover recess portion 58e, it is possible to suppress contact of the head portion of the bolt 55 with the outer circumferential surface of the outer housing annular portion 52a and the radial outer edge of the stator cover 58 when the bolt 55 is inserted into the hole 52g from the front side (+Z side). Further, this makes it possible to set a position, in the radial direction, of the bolt 55 on the inner side in the radial direction as compared with a case in which the outer housing recess portion 52e and the stator cover recess portion 58e are not provided. Thus, protrusion of the head portions of the bolts 55, the housing fixed portions 52f fixed to the stator support sections 12 by the bolts 55, and the stator support sections 12 outward in the radial direction of the outer fins 52b can be suppressed. Accordingly, enlargement of the motor 100 in the radial direction can be suppressed.

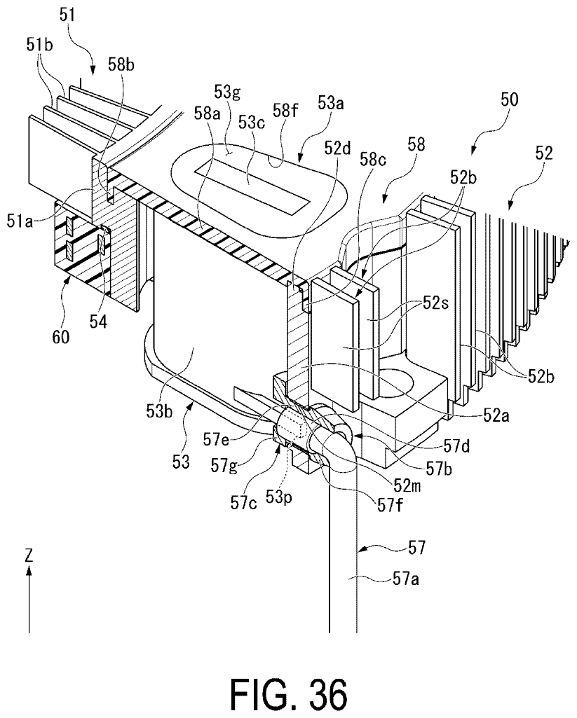

As illustrated in FIG. 36, in at least one electromagnet section 53, a wiring member 57 is connected to the coil 53b. The wiring member 57 is drawn outside the outer housing 52 through the housing through-hole 52m. This makes it possible to suppress contact of the wiring member 57 with the first rotor 20 and the second rotor 30 as compared with a case in which the wiring member 57 is drawn, for example, toward the inner side of the inner housing 51 in the radial direction. This also makes it possible to facilitate connection of the wiring member 57 to an external power source (not illustrated). As a result, a current can be readily introduced to the coil 53b through the wiring member 57.

The wiring member 57 includes a wiring body portion 57a and a connector portion 57b. The wire body portion 57a is a wiring line drawn toward the outer side of the outer housing 52 in the radial direction and connected to an external power source (not illustrated). The connector portion 57b is connected to one end of the wiring body portion 57a. The connector portion 57b is fixed inside the housing through-hole 52m. The connector portion 57b includes a connector cover 57c and a connection terminal 57d.

The connector cover 57c has a tubular shape extending in the radial direction. An inner circumferential surface of the connector cover 57c has a circular shape as viewed in the radial direction. The connector cover 57c opens to the inner side in the radial direction and to the outer side in the radial direction. The connector cover 57c includes an inserted portion 57e, a tapered portion 57f, and a retaining portion 57g. The inserted portion 57e is a part inserted into the housing through-hole 52m. An outer diameter of the inserted portion 57e is smaller than an inner diameter of the housing through-hole 52m.

The tapered portion 57f is connected to an end portion of the inserted portion 57e on the outer side in the radial direction. The tapered portion 57f is located on the outer side of the outer housing annular portion 52a in the radial direction. An outer diameter of the tapered portion 57f decreases toward the outer side in the radial direction. An outer diameter of the end portion of the tapered portion 57f on the inner side in the radial direction is larger than the outer diameter of the inserted portion 57e and the inner diameter of the housing through-hole 52m. An end portion of the tapered portion 57f on the inner side in the radial direction faces a circumferential edge portion of the housing through-hole 52m of an outer circumferential surface of the outer housing annular portion 52a. An outer diameter of the end portion the tapered portion 57f on the outer side in the radial direction is smaller than the inner diameter of the housing through-hole 52m, for example.

The retaining portion 57g is connected to an end portion of the inserted portion 57e on the inner side in the radial direction. The retaining portion 57g is located on the inner side of the outer housing annular portion 52a in the radial direction. An outer diameter of the retaining portion 57g is larger than the outer diameter of the inserted portion 57e, the outer diameter of the tapered portion 57f, and the inner diameter of the housing through-hole 52m. The retaining portion 57g faces the circumferential edge portion of the housing through-hole 52m of the inner circumferential surface of the outer housing annular portion 52a.

The connection terminal 57d is located on the inner side of the connector cover 57c. The connection terminal 57d is made of a metal. The connection terminal 57d has, for example, a tubular shape that opens to both sides in the radial direction. One end of the wiring body portion 57a is electrically connected to the connection terminal 57d.

The worker or the like inserts and presses the end portion of the tapered portion 57f on the outer side in the radial direction into the housing through-hole 52m from the inner side of the outer housing annular portion 52a in the radial direction, thereby causing the tapered portion 57f to pass through the housing through-hole 52m while elastically deforming the tapered portion 57f. When passed through the housing through-hole 52m and located on the outer side of the outer housing annular portion 52a in the radial direction, the tapered portion 57f is elastically restored. This makes it possible to suppress hooking of the tapered portion 57f onto the circumferential edge portion of the housing through-hole 52m from the outer side in the radial direction, and detachment of the connector portion 57b from the housing through-hole 52m toward the inner side of the outer housing annular portion 52a in the radial direction. The retaining portion 57g is hooked onto the circumferential edge portion of the housing through-hole 52m from the inner side in the radial direction. This makes it possible to suppress detachment of the connector portion 57b from the housing through-hole 52m toward the outer side of the outer housing annular portion 52a in the radial direction. Thus, the connector portion 57b is fixed to the housing through-hole 52m.

One end of a conductive wire 53p constituting the coil 53b is connected to the connector portion 57b. Thus, the wiring member 57 includes the connector portion 57b fixed inside the housing through-hole 52m, making it possible to easily connect the conductive wire 53p constituting the coil 53b to the wiring member 57. The one end of the conductive wire 53p is inserted inside the connector cover 57c from an end portion of the connector cover 57c on the inner side in the radial direction, and is electrically connected to the connection terminal 57d. The one end of the conductive wire 53p is, for example, press-fitted inside the connection terminal 57d having a tubular shape. The one end of the conductive wire 53p may be crimped to the connection terminal 57d by, for example, inserting the one end inside the connection terminal 57d and then pressing the connection terminal 57d together with the retaining portion 57g.

As illustrated in FIG. 2, a plurality of the wiring members 57 are provided spaced apart in the circumferential direction. The plurality of wiring members 57 are disposed at equal intervals across the entire circumference in the circumferential direction. In the present embodiment, three wiring members 57 are provided. That is, in the present embodiment, the respective wiring members 57 are connected to the coils 53b of three electromagnet sections 53 among the plurality of electromagnet sections 53.

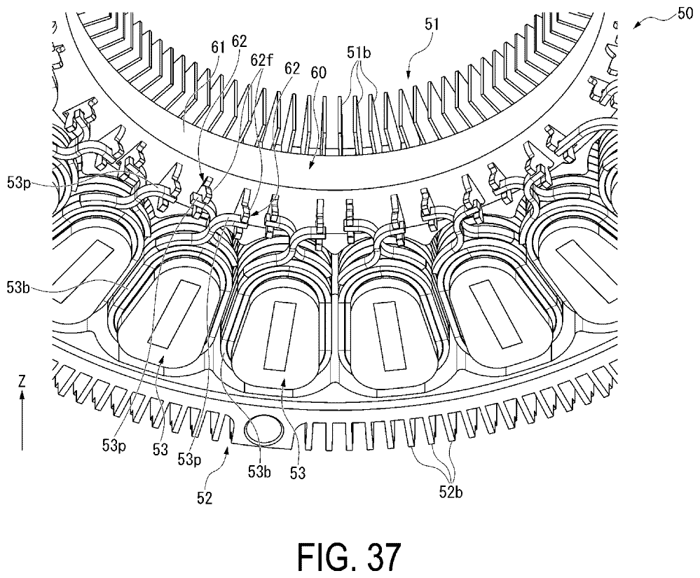

As illustrated in FIG. 29, the bus bar assembly 60 is located on the inner side of the stator 50 in the radial direction. The bus bar assembly 60 has an annular shape surrounding the center axis J. In the present embodiment, the bus bar assembly 60 has a circular annular shape having a center that coincides with the center axis J in a planar view in the axial direction. As illustrated in FIG. 37, the bus bar assembly 60 includes a bus bar holder 61 and a bus bar 62.

The bus bar holder 61 has an annular shape surrounding the center axis J. In the present embodiment, the bus bar holder 61 has an annular shape having a center that coincides with the center axis J in a planar view in the axial direction. Part of the bus bar 62 is embedded in and fixed to the bus bar holder 61. The bus bar holder 61 is made of a resin. The bus bar holder 61 is formed by, for example, insert-molding with the bus bar 62 used as an insert member.

As illustrated in FIG. 30, the bus bar holder 61 is disposed at a position on the inner side of the stator 50 in the radial direction and overlapping part of the plurality of inner fins 51b in a planar view in the axial direction. The other part of the plurality of inner fins 51b is disposed at a position different from that of the bus bar holder 61 in a planar view in the axial direction. With the bus bar holder 61 overlapping part of the plurality of inner fins 51b in the axial direction, the air flowing in the axial direction on the inner side of the stator 50 in the radial direction can be brought into contact with the plurality of inner fins 51b and the bus bar holder 61. This makes it possible to readily release heat generated in the bus bar 62 from a surface of the bus bar holder 61 into the air. Further, the other part of the plurality of inner fins 51b is disposed at a position not overlapping the bus bar holder 61 in the axial direction. Therefore, the plurality of inner fins 51b as a whole are not covered with the bus bar holder 61 in the axial direction, making it possible to suppress hindering of the flow of the air between the plurality of inner fins 51b in the circumferential direction. This makes it possible to suppress a decrease in the heat dissipation of the stator 50 through the plurality of inner fins 51b. Accordingly, it is possible to improve a heat dissipation of the bus bar 62 while suppressing a decrease in the heat dissipation of the stator 50. This makes it possible to improve the heat dissipation of the motor 100. Further, with the bus bar holder 61 being disposed on the inner side of the stator 50 in the radial direction, it is possible to suppress enlargement of the motor 100 in the radial direction as compared with a case in which the bus bar holder 61 is disposed on the outer side of the stator 50 in the radial direction. Further, arrangement of the bus bar holder 61 on the outer side of the stator 50 in the radial direction is not necessary, facilitating enlargement of the stator 50, the first rotor 20, and the second rotor 30 to the maximum extent in the radial direction in a limited arrangement space of the motor 100. Accordingly, an efficiency of the motor 100 can be improved.

In a configuration in which rotors are disposed on both sides of the stator in the axial direction as in the present embodiment, in the related art, the stator is interposed between the two rotors in the axial direction, resulting in the problem that heat is likely to accumulate in the stator and the heat dissipation of the motor is likely to decrease. Further, with the stator interposed between the two rotors in the axial direction, there is a problem that arrangement of the bus bar holder is difficult. To solve these problems, in the present embodiment, as described above, the bus bar holder 61 is disposed on the inner side of the stator 50 in the radial direction, and the bus bar holder 61 overlaps part of the plurality of inner fins 51b in the axial direction, making it possible to improve the heat dissipation of the motor 100. Further, with the bus bar holder 61 being disposed on the inner side of the stator 50 in the radial direction, it is possible to arrange the bus bar holder 61 while suppressing enlargement of the motor 100 in the radial direction. Thus, the effect of facilitating improvement of the heat dissipation of the motor 100 and the effect of facilitating arrangement of the bus bar holder 61 while suppressing enlargement of the motor 100 are particularly usefully obtained in a configuration in which the rotors are disposed on both sides of the stator 50 in the axial direction.

In the present embodiment, the bus bar holder 61 is located on the rear side (−Z side) of the plurality of inner fins 51b. In other words, the plurality of inner fins 51b are located on the front side (+Z side) of the bus bar holder 61. The bus bar holder 61 is fitted to the inner side of the inner housing annular portion 51a in the radial direction. In the present embodiment, the bus bar holder 61 is fitted to the inner side of the second annular portion 51f in the radial direction. That is, the bus bar holder 61 is fitted to the inner side, in the radial direction, of a part of the inner housing annular portion 51a that is located rearward of the stepped surface 51g. The outer circumferential surface of the bus bar holder 61 comes into contact with the inner circumferential surface of the second annular portion 51f. A surface of the bus bar holder 61 on the front side (+Z side) comes into contact with the stepped surface 51g. More specifically, apart on the outer side, in the radial direction, of the surface of the bus bar holder 61 on the front side comes into contact with the stepped surface 51g.

A first seal member 54 having an annular shape surrounding the center axis J is disposed between the surface of the bus bar holder 61 on the front side (+Z side) and the stepped surface 51g. Therefore, even if resin enters between the outer circumferential surface of the bus bar holder 61 and the inner circumferential surface of the second annular portion 51f when the resin section 80 is molded, the first seal member 54 can suppress arrival of the resin at the end portion on the inner side in the radial direction, between the surface of the bus bar holder 61 on the front side and the stepped surface 51g. This makes it possible to suppress leakage of the resin from between the bus bar holder 61 and the stepped surface 51g toward the inner side in the radial direction when the resin section 80 is molded. Accordingly, it is possible to further suppress leakage of the resin when the resin section 80 is molded. Further, because leakage of the resin from between the bus bar holder 61 and the stepped surface 51g toward the inner side in the radial direction can be suppressed, adhesion of the resin to the inner fins 51b can be suppressed. This makes it possible to suppress partial filling of the area between the inner fins 51b with the resin, and the like. Accordingly, it is possible to suppress a decrease in a surface area of the plurality of inner fins 51b that comes into contact with the air, and further suppress a decrease in the heat dissipation of the stator 50.

A part of the bus bar holder 61 on the inner side in the radial direction is located inward of the stepped surface 51g in the radial direction. The bus bar holder 61 overlaps a part of each of the plurality of inner fins 51b that includes an end portion on the outer side in the radial direction, in a planar view in the axial direction. In the present embodiment, the bus bar holder 61 overlaps a part of each inner fin 51b on the outer side in the radial direction, in a planar view in the axial direction. The inner circumferential surface of the bus bar holder 61 is located outward, in the radial direction, of end portions of the plurality of inner fins 51b on the inner side in the radial direction. In other words, the end portions of the plurality of inner fins 51b on the inner side in the radial direction are located inward of the inner circumferential surface of the bus bar holder 61 in the radial direction. This makes it possible to arrange part of the plurality of inner fins 51b in positions that do not overlap the bus bar holder 61 in the axial direction while the outer circumferential surface of the bus bar holder 61 is supported from the outer side in the radial direction by the inner housing annular portion 51a. The inner circumferential surface of the bus bar holder 61 is provided at the same position as that of the inner circumferential surface of the second resin portion 82 in the radial direction. The surface of the bus bar holder 61 on the rear side (−Z side) comes into contact with the surface of the second resin portion 82 on the front side (+Z side) in a part located inward of the first resin portion 81 in the radial direction.

A thickness of the bus bar holder 61 in the radial direction between the inner circumferential surface and the outer circumferential surface is equal to or less than the dimension of each of the plurality of inner fins 51b in the radial direction. In the present embodiment, the thickness of the bus bar holder 61 in the radial direction between the inner circumferential surface and the outer circumferential surface is less than the dimension of each of the plurality of inner fins 51b in the radial direction. A dimension H3 of the bus bar holder 61 in the axial direction is less than a dimension H1 of the stator 50 in the axial direction. This makes it possible to arrange the bus bar holder 61 as a whole on the inner side of the stator 50 in the radial direction. Further, because the bus bar holder 61 can be made small in the axial direction, heat of the bus bar 62 embedded in the bus bar holder 61 can be readily transferred to an axial end surface of the bus bar holder 61. This makes it possible to more readily release the heat of the bus bar 62 into the air that comes into contact with the axial end surface of the bus bar holder 61. Accordingly, the heat dissipation of the motor 100 can be further improved.

The dimension H3 of the bus bar holder 61 in the axial direction is equal to or less than a dimension H2 of the plurality of inner fins 51b in the axial direction. As a result, the bus bar holder 61 can be reduced in size in the axial direction and the plurality of inner fins 51b can be increased in size in the axial direction, within a range of the dimension H1 of the stator 50 in the axial direction. This makes it possible to more readily release the heat of the bus bar 62 from the bus bar holder 61 into the air, and increase the surface area of the plurality of inner fins 51b. Accordingly, the heat dissipation of the bus bar 62 and the heat dissipation of the stator 50 can be further improved, and the heat dissipation of the motor 100 can be further improved.

In the present embodiment, the dimension H3 of the bus bar holder 61 in the axial direction is less than the dimension H2 of the plurality of inner fins 51b in the axial direction. The dimension H3 of the bus bar holder 61 in the axial direction is equal to or less than a dimension H4 of the second resin portion 82 in the axial direction. In the present embodiment, the dimension H3 of the bus bar holder 61 in the axial direction is the same as the dimension H4 of the second resin portion 82 in the axial direction. In the present embodiment, the dimension H3 of the bus bar holder 61 in the axial direction is the same as the dimension of the second annular portion 51f in the axial direction. An end portion of the bus bar holder 61 on the rear side (−Z side) is provided at the same position as that of the end portion of the second annular portion 51f on the rear side, that is, the end portion of the inner housing 51 on the rear side, in the axial direction.

As illustrated in FIG. 29, the bus bar holder 61 includes a holder body portion 61a and a protruding portion 61b. The holder body portion 61a has an annular shape surrounding the center axis J. More specifically, the holder body portion 61a has a circular annular shape having a center that coincides with the center axis J in a planar view in the axial direction. The holder body portion 61a is a part in which part of the bus bar 62 is embedded. The protruding portion 61b protrudes from an outer circumferential surface of the holder body portion 61a toward the outer side in the radial direction. The protruding portion 61b is located in an interior of the inner housing recess portion 51n provided on the inner circumferential surface of the inner housing annular portion 51a. Thus, the protruding portion 61b is hooked onto the inner surface of the inner housing recess portion 51n in the circumferential direction. Accordingly, the bus bar holder 61 can be positioned in the circumferential direction relative to the inner housing 51.

In the present embodiment, the protruding portion 61b has a semi-circular shape protruding toward the outer side in the radial direction in a planar view in the axial direction. The protruding portion 61b is fitted inside the inner housing recess portion 51n. Although not illustrated, the protruding portion 61b extends in the axial direction. The protruding portion 61b extends, for example, from an end portion on the front side (+Z side) to an end portion on the rear side (−Z side) of the holder body portion 61a.

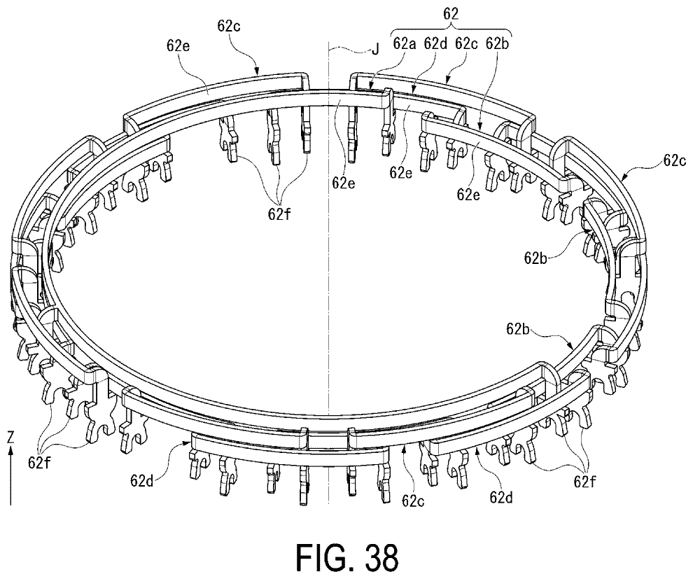

As illustrated in FIG. 38, in the present embodiment, a plurality of the bus bars 62 are provided. Each bus bar 62 is connected to at least one coil 53b. In the present embodiment, each bus bar 62 connects two or more coils 53b to each other. Each of the plurality of bus bars 62 includes a bus bar body portion 62e and a coil connecting portion 62f. The bus bar body portion 62e is embedded in the bus bar holder 61. The bus bar body portion 62e has a plate shape extending in the circumferential direction. A plate surface of the bus bar body portion 62e faces the radial direction. Therefore, a dimension of the bus bar body portion 62e in the radial direction can be reduced as compared with a case in which the plate surface of the bus bar body portion 62e faces the axial direction. This makes it possible to reduce the thickness of the bus bar holder 61 in the radial direction between the inner circumferential surface and the outer circumferential surface. Accordingly, the heat of the bus bar 62 embedded in the bus bar holder 61 can be readily transferred to the inner circumferential surface of the bus bar holder 61. This makes it possible to readily release the heat of the bus bar 62 into the air that comes into contact with the inner circumferential surface of the bus bar holder 61. Further, because the thickness of the bus bar holder 61 in the radial direction between the inner circumferential surface and the outer circumferential surface can be reduced, a dimension in the radial direction of a part of each of the plurality of inner fins 51b that does not overlap the bus bar holder 61 in the axial direction can be increased. This makes it possible to further improve the heat dissipation of the stator 50 through the plurality of inner fins 51b. Accordingly, the heat dissipation of the motor 100 can be further improved.

The coil connecting portion 62f protrudes from the bus bar body portion 62e toward the rear side (−Z side). As illustrated in FIG. 37, the coil connecting portion 62f protrudes from the bus bar holder 61 toward the rear side. In the present embodiment, the coil connecting portion 62f has a substantially U shape that opens toward the rear side as viewed in the circumferential direction. An end portion of the conductive wire 53p constituting the coil 53b is inserted inside each of the coil connecting portions 62f having a substantially U shape. The conductive wire 53p is connected to the coil connecting portion 62f by, for example, welding. Thus, the coil connecting portion 62f is connected to the coil 53b. The coil connecting portion 62f is located on the inner side of the coil 53b in the radial direction. As illustrated in FIG. 30, the coil connecting portion 62f is embedded in the second resin portion 82. An end portion of the coil connecting portion 62f on the rear side is located rearward of the end portion of the second annular portion 51f on the rear side. That is, the end portion of the inner housing 51 on the rear side is located frontward (+Z side) of the end portion of the coil connecting portion 62f on the rear side. This makes it possible to easily connect the end portion of the conductive wire 53b constituting the coil 53p to the coil connecting portion 62f. As a result, the coil 53b and the bus bar 62 can be easily connected.

As illustrated in FIG. 38, each of the bus bars 62 includes two or more coil connecting portions 62f. The plurality of bus bars 62 include a first bus bar 62a, a second bus bar 62b, a third bus bar 62c, and a fourth bus bar 62d. One first bus bar 62a is provided. A dimension of the first bus bar 62a in the circumferential direction is larger than a dimension of the other bus bars 62 in the circumferential direction. The bus bar body portion 62e of the first bus bar 62a has a circular arc shape having a central angle larger than 180° in a planar view in the axial direction. The first bus bar 62a includes three coil connecting portions 62f. Two coil connecting portions 62f of the three coil connecting portions 62f are respectively connected to both end portions, in the circumferential direction, of the bus bar body portion 62e of the first bus bar 62a. The remaining one coil connecting portion 62f is connected to a center portion, in the circumferential direction, of the bus bar body portion 62e of the first bus bar 62a.

A plurality of the second bus bars 62b are provided spaced apart in the circumferential direction. In the present embodiment, seven second bus bars 62b are provided. The bus bar body portion 62e of the second bus bar 62b is located rearward (−Z side) of the bus bar body portion 62e of the first bus bar 62a. The bus bar body portion 62e of the second bus bar 62b is provided at the same position as that of the bus bar body portion 62e of the first bus bar 62a in the radial direction. The bus bar body portion 62e of the second bus bar 62b is partially disposed on the rear side of the bus bar body portion 62e of the first bus bar 62a, with a gap therebetween. That is, the bus bar body portion 62e of the second bus bar 62b partially overlaps the bus bar body portion 62e of the first bus bar 62a in a planar view in the axial direction. The second bus bar 62b includes two coil connecting portions 62f. The two coil connecting portions 62f are respectively connected to both circumferential end portions of the bus bar body portion 62e of the second bus bar 62b.

A plurality of the third bus bars 62c are provided spaced apart in the circumferential direction. In the present embodiment, seven third bus bars 62c are provided. The bus bar body portion 62e of the third bus bar 62c is located outward, in the radial direction, of the bus bar body portion 62e of the first bus bar 62a. The bus bar body portion 62e of the third bus bar 62c is provided at the same position as that of the bus bar body portion 62e of the first bus bar 62a in the axial direction. The bus bar body portion 62e of the third bus bar 62c is partially disposed on the outer side, in the radial direction, of the bus bar body portion 62e of the first bus bar 62a, with a gap therebetween. That is, the bus bar body portion 62e of the third bus bar 62c partially overlaps the bus bar body portion 62e of the first bus bar 62a as viewed in the radial direction. The third bus bar 62c includes two coil connecting portions 62f. The two coil connecting portions 62f are respectively connected to both circumferential end portions of the bus bar body portion 62e of the third bus bar 62c.

A plurality of the fourth bus bar 62d are provided spaced apart in the circumferential direction. In the present embodiment, seven fourth bus bars 62d are provided. The bus bar body portion 62e of the fourth bus bar 62d is located rearward (−Z side) of the bus bar body portion 62e of the third bus bar 62c. The bus bar body portion 62e of the fourth bus bar 62d is provided at the same position as that of the bus bar body portion 62e of the third bus bar 62c in the radial direction. The bus bar body portion 62e of the fourth bus bar 62d is provided at the same position as that of the bus bar body portion 62e of the second bus bar 62b in the axial direction. The bus bar body portion 62e of each fourth bus bar 62d is at least partially disposed on the rear side of the bus bar body portion 62e of the third bus bar 62c, with a gap therebetween. That is, the bus bar body portion 62e of each fourth bus bar 62d at least partially overlaps the bus bar body portion 62e of the third bus bar 62c in a planar view in the axial direction. The bus bar body portion 62e of each fourth bus bar 62d is at least partially disposed on the outer side, in the radial direction, of the bus bar body portion 62e of the second bus bar 62b, with a gap therebetween. That is, the bus bar body portion 62e of each fourth bus bar 62d at least partially overlaps the bus bar body portion 62e of the second bus bar 62b as viewed in the radial direction. The fourth bus bar 62d includes two coil connecting portions 62f. The two coil connecting portions 62f are respectively connected to both circumferential end portions of the bus bar body portion 62e of the fourth bus bar 62d.

In the first bus bar 62a and the second bus bar 62b, each coil connecting portion 62f protrudes from each bus bar body portion 62e toward the outer side in the radial direction. In the third bus bar 62c and the fourth bus bar 62d, each coil connecting portion 62f protrudes from each bus bar body portion 62e toward the inner side in the radial direction. Each coil connecting portion 62f of the first bus bar 62a and the second bus bar 62b and each coil connecting portion 62f of the third bus bar 62c and the fourth bus bar 62d at least partially overlap each other as viewed in the circumferential direction. All coil connecting portions 62f included in all bus bars 62 are disposed side by side spaced apart in the circumferential direction.

In the present embodiment, each bus bar 62 connects two or more coils 53b to each other, but is not directly connected to an external power source (not illustrated) that supplies a current to the coils 53b. As described above, the current is supplied to each coil 53b through the wiring member 57 drawn to the outer side of the stator 50 in the radial direction. Thus, in the present embodiment, a connection between the external power source (not illustrated) and the coil 53b is made not through the bus bar 62 of the bus bar assembly 60 but through the wiring member 57 drawn to the outer side of the stator 50 in the radial direction. Asa result, the bus bar assembly 60 is disposed on the inner side of the stator 50 in the radial direction, making it possible for the worker or the like to easily connect the external power source (not illustrated) and the coil 53b while suppressing enlargement of the motor 100 in the radial direction. Note that a number of the bus bars 62 is not particularly limited as long as the number is one or more.

Hereinafter, embodiments different from the embodiment described above will be described. In the following description of each embodiment, components similar to those described above in the description of each embodiment are denoted as appropriate by the same reference signs and the like, and description thereof may be omitted. In addition, parts in the embodiments that correspond to the respective parts of the configuration described above are denoted by the same names and different reference signs, points differing from the configurations described above will be described, and a description of points similar to those in the configuration described above may be omitted. Note that configurations similar to those described above in each embodiment can be adopted as configurations for which description is omitted in each of the embodiments below, as long as no contradiction arises.

### Second Embodiment

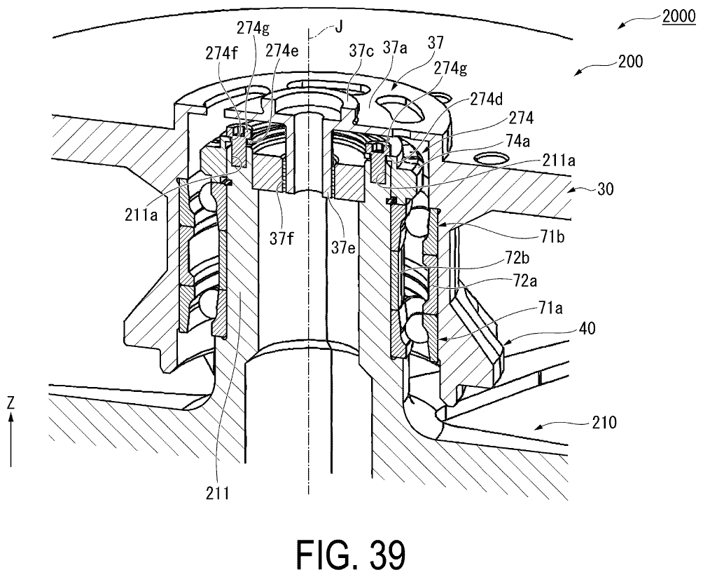

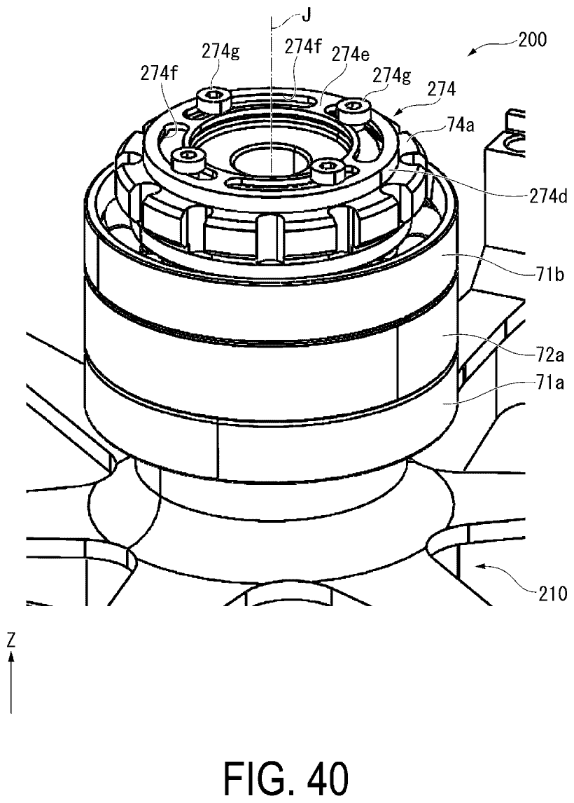

As illustrated in FIG. 39, in a motor 200 of a propulsion device 2000 of the present embodiment, a preload member 274 includes a circumferential wall 274d and a plate-shaped portion 274e. The circumferential wall 274d protrudes from the nut part 74a toward the front side (+Z side). In the present embodiment, the circumferential wall 274d protrudes from a radial inner edge of a surface of the nut part 74a on the front side toward the front side. As illustrated in FIG. 40, the circumferential wall 274d has a tubular shape surrounding the center axis J. In the present embodiment, the circumferential wall 274d has a cylindrical shape about the center axis J.

The plate-shaped portion 274e protrudes from an end portion of the circumferential wall 274d on the front side (+Z side) toward the inner side in the radial direction. The plate-shaped portion 274e has a plate shape with a plate surface facing the axial direction. The plate-shaped portion 274e has an annular shape surrounding the center axis J. In the present embodiment, the plate-shaped portion 274e has a circular annular shape having a center that coincides with the center axis J in a planar view in the axial direction. As illustrated in FIG. 39, the plate-shaped portion 274e is located on the front side of a support shaft 211. The plate-shaped portion 274e is provided frontwardly away from an end surface of the support shaft 211 on the front side. A radial inner edge of the plate-shaped portion 274e is provided at the same position in the radial direction as that of a radial inner edge of the end portion of the support shaft 211 on the front side, for example.

As illustrated in FIG. 40, the plate-shaped portion 274e includes a long hole 274f penetrating the plate-shaped portion 274e in the axial direction. The long hole 274f extends in the circumferential direction. In the present embodiment, a plurality of the long holes 274f are provided spaced apart in the circumferential direction. In the present embodiment, four long holes 274f are provided. A bolt 274g is passed through each long hole 274f in the axial direction from the front side (+Z side). A dimension of each long hole 274f in the radial direction is smaller than an outer diameter of a head portion of the bolt 274g. The head portion of the bolt 274g comes into contact with a circumferential edge portion of the long hole 274f of a surface of the plate-shaped portion 274e on the front side. Other configurations of the preload member 274 are similar to other configurations of the preload member 74 of the first embodiment.

As illustrated in FIG. 39, the support shaft 211 of an attachment member 210 includes a threaded hole 211a into which the bolt 274g passed through the long hole 274f from the front side (+Z side) is fastened. Therefore, by fastening the bolt 274g into the threaded hole 211a, it is possible to fix a relative position of the preload member 274 in the circumferential direction to the support shaft 211. This makes it possible to suppress unintentional rotation of the preload member 274 around the center axis J, and suppress a change in preload applied to the first rolling bearing 71a and the second rolling bearing 71b. Accordingly, it is possible to suppress a decrease in the rigidity of the first rolling bearing 71a and the rigidity of the second rolling bearing 71b, and further suppress inclination of the first rotor 20 and the second rotor 30. The long hole 274f through which the bolt 274g is passed extends in the circumferential direction and thus, even if a position of the preload member 274 in the circumferential direction is displaced in order to adjust the preload applied to the first rolling bearing 71a and the second rolling bearing 71b, the bolt 274g is readily fastened into the threaded hole 211a through the long hole 274f.

The threaded hole 211a is recessed from an end surface of the support shaft 211 on the front side (+Z side) toward the rear side (−Z side). In the present embodiment, a plurality of the threaded holes 211a are provided spaced apart in the circumferential direction. In the present embodiment, four threaded holes 211a are provided. The bolts 211a are fastened into the threaded holes 274g. Note that, as long as the bolt 211a is fastened into at least one threaded hole 274g, there may be a threaded hole 274g into which the bolt 211a is not fastened. Other configurations of the support shaft 211 are similar to other configurations of the support shaft 11 in the first embodiment. Other configurations of the attachment member 210 are similar to other configurations of the attachment member 10 in the first embodiment.

Other configurations of the motor 200 are similar to other configurations of the motor 100 in the first embodiment. Other configurations of the propulsion device 2000 are similar to other configurations of the propulsion device 1000 in the first embodiment.

### Third Embodiment

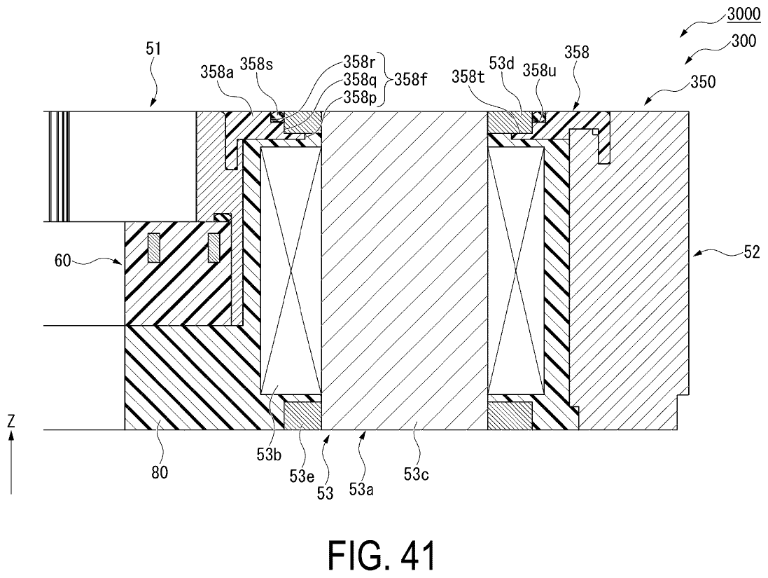

As illustrated in FIG. 41, in a motor 300 of a propulsion device 3000 of the present embodiment, a stator 350 differs from the stator 50 of the first embodiment in a configuration of a stator cover 358. A cover through-hole 358f of a cover body portion 358a in the stator cover 358 includes a first portion 358p, a second portion 358q, and a third portion 358r. The first portion 358p is an end portion of the cover through-hole 358f on the rear side (−Z side). The second portion 358q is connected to the front side (+Z side) of the first portion 358p. An inner diameter of the second portion 358q is larger than an inner diameter of the first portion 358p. A fourth stepped surface 358t facing the front side is provided between an inner circumferential surface of the first portion 358p and an inner circumferential surface of the second portion 358q. The third portion 358r is connected to the front side of the second portion 358q. An inner diameter of the third portion 358r is larger than the inner diameter of the second portion 358q. A fifth stepped surface 358u facing the front side is provided between the inner circumferential surface of the second portion 358q and an inner circumferential surface of the third portion 358r. An end portion of the third portion 358r on the front side is an end portion of the cover through-hole 358f on the front side. Other configurations of the stator cover 358 are similar to other configurations of the stator cover 58 in the first embodiment.

In the present embodiment, the second core part 53d is fitted inside the second portion 358q. A part on an outer edge side of a surface of the second core part 53d on the rear side (−Z side) comes into contact with the fourth stepped surface 358t. An outer circumferential surface of a part of the second core part 53d on the front side (+Z side) is provided inwardly separated from the inner circumferential surface of the third portion 358r. A second seal member 358s having an annular shape surrounding the second core part 53d is disposed between the outer circumferential surface of the part of the second core part 53d on the front side and the inner circumferential surface of the third portion 358r. That is, the second seal member 358s having an annular shape surrounding each second core part 53d is disposed between the inner circumferential surface of each cover through-hole 358f and the outer circumferential surface of each second core part 53d. Therefore, when the resin section 80 is molded, the second seal member 358s can further suppress leakage of the resin from between an inner edge of the cover through-hole 358f and the outer edge of the second core part 53d. Accordingly, it is possible to further suppress leakage of the resin when the resin section 80 is molded.

The respective second seal members 358s come into contact with the respective inner circumferential surfaces of the cover through-holes 358f and the respective outer circumferential surfaces of the second core parts 53d. The respective second seal member 358s seal areas between the respective inner circumferential surfaces of the cover through-holes 358f and the respective outer circumferential surfaces of the second core parts 53d. The second seal member 358s comes into contact with the fifth stepped surface 358u. Although not illustrated, the second seal member 358s has a shape similar to an outer shape of the second core part 53d in a planar view in the axial direction. The second seal member 358s is, for example, an O-ring.

Other configurations of the stator 350 are similar to other configurations of the stator 50 in the first embodiment. Other configurations of the motor 300 are similar to other configurations of the motor 100 in the first embodiment. Other configurations of the propulsion device 3000 are similar to other configurations of the propulsion device 1000 in the first embodiment.

### Fourth Embodiment

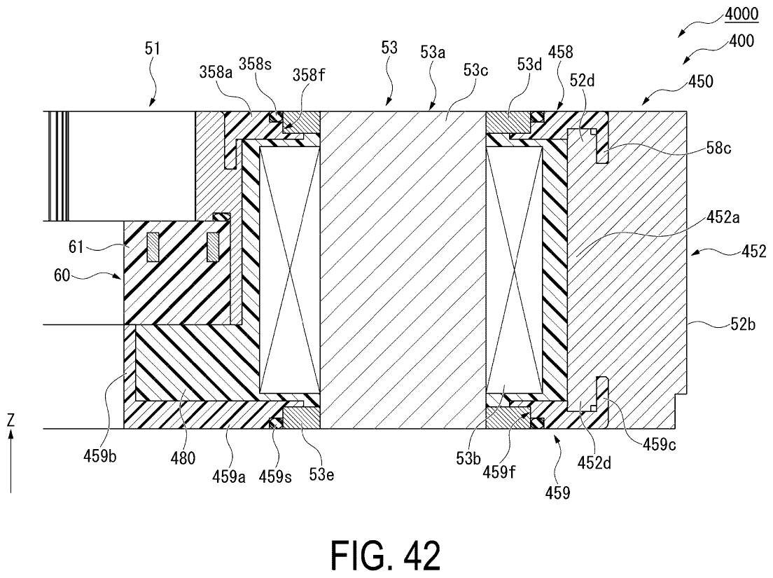

As illustrated in FIG. 42, in a motor 400 of a propulsion device 4000 of the present embodiment, a stator 450 includes a first stator cover 458 and a second stator cover 459. The first stator cover 458 has a configuration similar to that of the stator cover 358 of the third embodiment. The second stator cover 459 is located on the rear side (−Z side) of the coil 53b. The second stator cover 459 has an annular shape surrounding the center axis J. The second stator cover 459 includes a second cover body portion 459a, a second inner annular wall 459b, and a second outer annular wall 459c. The second cover body portion 459a has an annular shape surrounding the center axis J. A radial inner edge of the second cover body portion 459a is located inward, in the radial direction, of a radial inner edge of the cover body portion 358a of the first stator cover 458. Other configurations of the second cover body portion 459a, excluding inversion in the axial direction, are similar to other configurations of the cover body portion 358a of the first stator cover 458.

The third core part 53e of each electromagnet section 53 is fitted inside each cover through-hole 459f in the second cover body portion 459a. A third seal member 459s having an annular shape surrounding each third core part 53e is disposed between an inner circumferential surface of each cover through-hole 459f and the outer circumferential surface of each third core part 53e. The third seal member 459s seals an area between the inner circumferential surface of each cover through-hole 459f and the outer circumferential surface of each third core part 53e. The third seal member 459s is, for example, an O-ring.

The second inner annular wall 459b protrudes from the radial inner edge of the second cover body portion 459a toward the front side (+Z side). The second inner annular wall 459b has a cylindrical shape about the center axis J. An end portion of the second inner annular wall 459b on the front side comes into contact with an end surface of the bus bar holder 61 on the rear side (−Z side). More specifically, the end portion of the second inner annular wall 459b on the front side comes into contact with a radial inner edge of the end surface of the bus bar holder 61 on the rear side (−Z side).

The second outer annular wall 459c protrudes from the radial outer edge of the second cover body portion 459a toward the front side (+Z side). The second outer annular wall 459c is attached to an outer housing 452 in the same manner as the outer annular wall 58c of the first stator cover 458 except for being inverted in the axial direction. The second outer annular wall 459c is located between, in the radial direction, the plurality of outer fins 52b and a rear protruding wall 452d protruding from an end portion, on the rear side (−Z side), of an outer housing annular portion 452a of the outer housing 452 toward the rear side. An inner circumferential surface of the second outer annular wall 459c comes into contact with a surface on the outer side of the rear protruding wall 452d in the radial direction. Configurations of the outer housing annular portion 452a are similar to configurations of the outer housing annular portion 52a in the first embodiment except that the end portion on the rear side is located frontward of the end portions of the plurality of outer fins 52b on the rear side. Configurations of the rear protruding wall 452d, excluding inversion in the axial direction, are similar to configurations of the fourth protruding wall 52d.

In the present embodiment, a resin section 480 is formed by pouring resin inside an area surrounded by the inner housing 51, the outer housing 452, the first stator cover 458, the second stator cover 459, the second core part 53d, and the third core part 53e. In the present embodiment, with the second stator cover 459 being provided, the resin section 480 can be molded without covering the rear side (−Z side) of the stator 450 with a jig or the like. Further, as with the first stator cover 458, the second stator cover 459 can suppress leakage of the resin to the rear side of the stator 450. Accordingly, it is possible to further suppress leakage of the resin when the resin section 480 is molded. Further, in the present embodiment, the third seal member 459s having an annular shape surrounding each third core part 53e is disposed between the inner circumferential surface of each cover through-hole 459f and the outer circumferential surface of each third core part 53e. Therefore, when the resin section 480 is molded, leakage of the resin from between the inner circumferential surface of each cover through-hole 459f and the outer circumferential surface of each third core part 53e is further suppressed. Accordingly, it is possible to further suppress leakage of the resin when the resin section 480 is molded.

Other configurations of the stator 450 are similar to other configurations of the stator 350 in the third embodiment. Other configurations of the motor 400 are similar to other configurations of the motor 300 in the third embodiment. Other configurations of the propulsion device 4000 are similar to other configurations of the propulsion device 3000 in the third embodiment.

### Fifth Embodiment

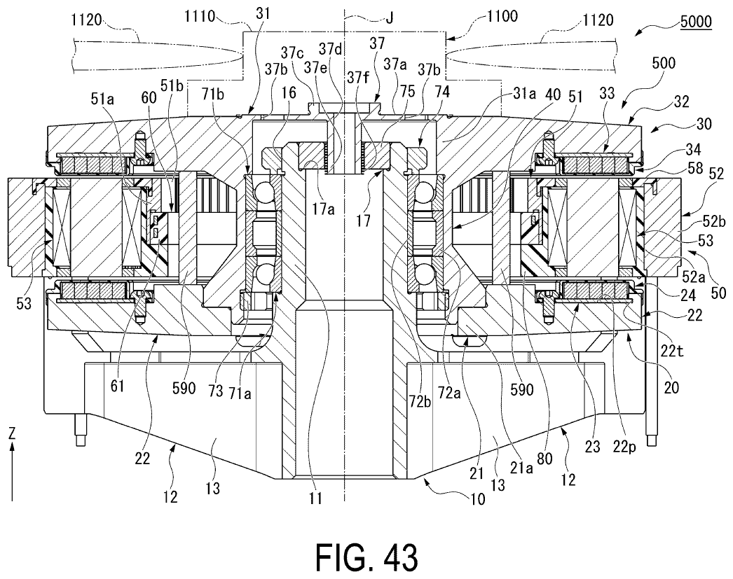

As illustrated in FIG. 43, a motor 500 in a propulsion device 5000 of the present embodiment includes a plurality of connecting columns 590. The plurality of connecting columns 590 extend in the axial direction. The plurality of connecting columns 590 each have, for example, a columnar shape extending in the axial direction. At least part of each connecting column 590 is located between the first rotor 20 and the second rotor 30 in the axial direction. In the present embodiment, each connecting column 590 is entirely located between the first rotor 20 and the second rotor 30 in the axial direction. Each connecting column 590 is passed, in the axial direction, through the inner side of the stator 50 in the radial direction and the inner side of the bus bar holder 61 in the radial direction.

The plurality of connecting columns 590 are located inward of the plurality of inner fins 51b and the bus bar holder 61 in the radial direction. The plurality of connecting columns 590 are fixed to at least one of the first rotor 20 or the second rotor 30. In the present embodiment, the plurality of connecting columns 590 are fixed to both the first rotor 20 and the second rotor 30. The plurality of connecting columns 590 come into contact with the surface of the first rotor 20 on the front side and a surface of the second rotor 30 on the rear side. This makes it possible to maintain an interval between the first rotor 20 and the second rotor 30 in the axial direction by the plurality of connecting columns 590. With the plurality of connecting columns 590 being disposed inward of the plurality of inner fins 51b in the radial direction, the interval between the first rotor 20 and the second rotor 30 in the axial direction can be maintained without arranging a plurality of the connecting columns 590 on the outer side of the stator 50 in the radial direction. This makes it possible to suppress enlargement of the stator 50 in the radial direction while providing the plurality of outer fins 52b on the outer circumferential surface of the outer housing annular portion 52a. With facilitation of provision of the plurality of inner fins 51b and the plurality of outer fins 52b, it is possible to improve the heat dissipation of the stator 50 as described in the first embodiment. Further, even if the plurality of connecting columns 590 are disposed on the inner side of the plurality of inner fins 51b in the radial direction, the flow of air flowing in the axial direction to the plurality of inner fins 51b is not hindered, and thus the heat dissipation of the stator 50 is not reduced. The plurality of connecting columns 590 rotate together with the first rotor 20 and the second rotor 30, stirring the air flowing on the inner side of the stator 50 in the radial direction by the plurality of connecting columns 590. This facilitates the flow of air on the inner side of the stator 50 in the radial direction, making it possible to readily bring the air into contact with the plurality of inner fins 51b. Accordingly, the heat dissipation of the stator 50 can be further improved.

The plurality of connecting columns 590 are disposed spaced apart in the circumferential direction. The plurality of connecting columns 590 are respectively disposed between the plurality of first arms 22 and the plurality of second arms 32 in the axial direction. In the present embodiment, an end portion of each connecting column 590 on the rear side (−Z side) comes into contact with a surface of each first arm 22 on the front side (+Z side) and is fixed to each first arm 22. In the present embodiment, an end portion of each connecting column 590 on the front side comes into contact with the surface of each second arm 32 on the rear side and is fixed to each second arm 32.

Other configurations of the motor 500 are similar to other configurations of the motor 100 in the first embodiment. Other configurations of the propulsion device 5000 are similar to other configurations of the propulsion device 1000 in the first embodiment.

### Sixth Embodiment

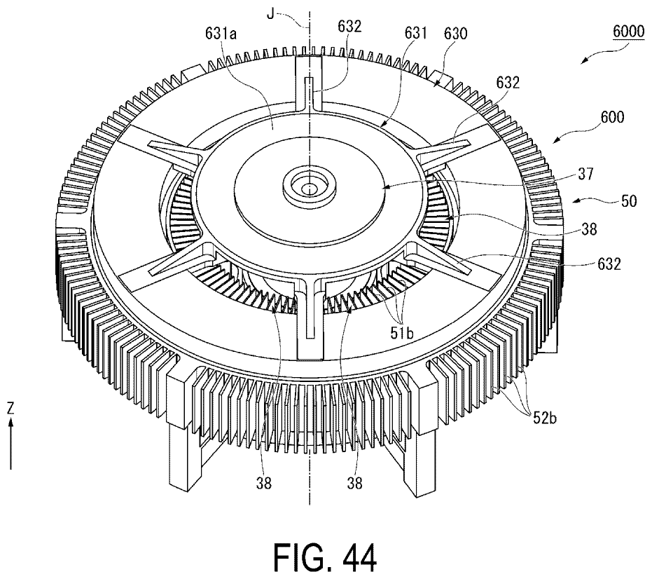

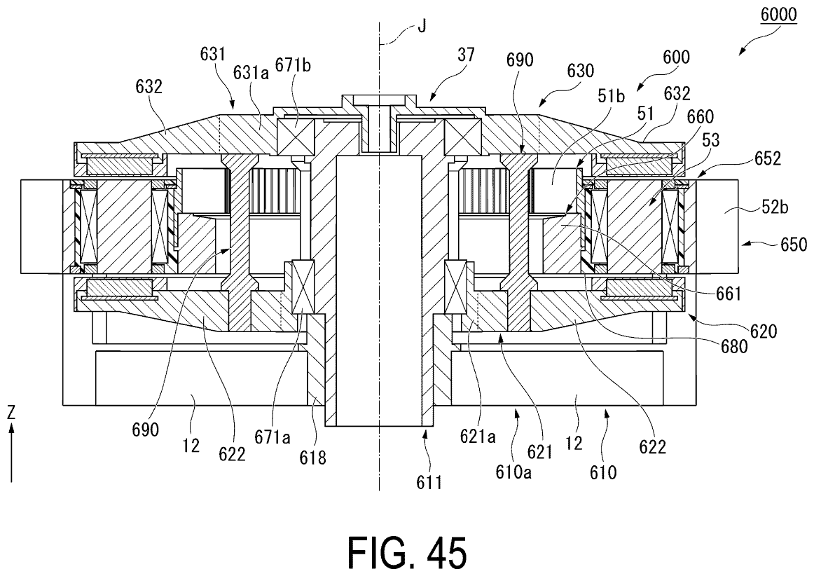

As illustrated in FIG. 44, in a motor 600 of a propulsion device 6000 of the present embodiment, a number of second arms 632 in a second rotor 630 is six. As illustrated in FIG. 45, a second rotor annular portion 631a of a second rotor frame 631 of the second rotor 630 is rotatably supported by a support shaft 611 via a second bearing 671b. The second bearing 671b is, for example, a rolling bearing such as a ball bearing. Note that the second bearing 671b may be a sliding bearing. A radial outer edge of the second rotor annular portion 631a is located outward, in the radial direction, of a radial outer edge of the second rotor annular portion 31a in the first embodiment. A radial outer edge of the second rotor annular portion 631a is located outward, in the radial direction, of a radial outer edge of a first rotor annular portion 621a. Other configurations of the second rotor 630 are similar to other configurations of the second rotor 30 in the first embodiment.

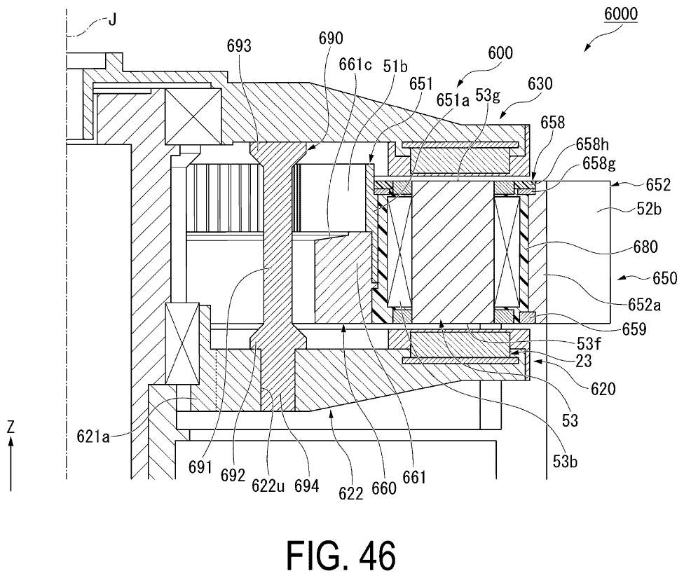

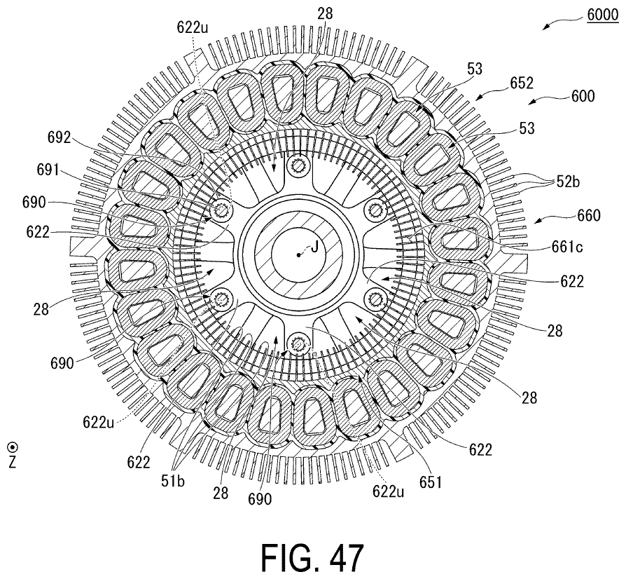

In a first rotor frame 621 of a first rotor 620, the first rotor annular portion 621a is rotatably supported by the support shaft 611 via a first bearing 671a. The first bearing 671a is, for example, a rolling bearing such as a ball bearing. Note that the first bearing 671a may be a sliding bearing. As illustrated in FIG. 46, each of a plurality of first arms 622 includes a fixing hole 622u recessed from a surface of each first arm 622 on the front side (+Z side) toward the rear side (−Z side). Each fixing hole 622u is provided in a part on the inner side of each first arm 622 in the radial direction. More specifically, each fixing hole 622u is provided in a part of each first arm 622 that is located inward, in the radial direction, of the end portions of the plurality of inner fins 51b on the inner side in the radial direction. Each fixing hole 622u is located inward of the rotor body 23 in the radial direction. In the present embodiment, the fixing hole 622u penetrates the first arm 622 in the axial direction. The fixing hole 622u may be a hole including a bottom portion on the rear side. As illustrated in FIG. 47, each fixing hole 622u has a circular shape in a planar view in the axial direction.

In the present embodiment, a number of the first arms 622 is six. Other configurations of each first arm 622 are similar to other configurations of each first arm 22 in the first embodiment. Other configurations of the first rotor 620 are similar to other configurations of the first rotor 20 in the first embodiment. Note that, in FIG. 44 to FIG. 47, the first rotor 620 and the second rotor 630 are simplified as appropriate.

As illustrated in FIG. 45, in the present embodiment, the motor 600 includes a plurality of connecting columns 690. The plurality of connecting columns 690 extend in the axial direction. The plurality of connecting columns 690 each have, for example, a columnar shape extending in the axial direction. At least part of each connecting column 690 is located between the first rotor 620 and the second rotor 630 in the axial direction. Each connecting column 690 is passed, in the axial direction, through the inner side of a stator 650 in the radial direction and an inner side of a bus bar holder 661 in the radial direction.

As illustrated in FIG. 46, each of the plurality of connecting columns 690 includes a column body portion 691, a first contact portion 692, a second contact portion 693, and a fitting fixing portion 694. The column body portion 691 extends in the axial direction. In the present embodiment, the column body portion 691 has a columnar shape. The column body portion 691 is located between the first rotor 620 and the second rotor 630 in the axial direction.

The first contact portion 692 is connected to an end portion of the column body portion 691 on the rear side (−Z side). The second contact portion 693 is connected to an end portion of the column body portion 691 on the front (+Z side). The first contact portion 692 and the second contact portion 693 are located between the first rotor 620 and the second rotor 630 in the axial direction. In the present embodiment, the connecting column 690, as a whole, excluding the fitting fixing portion 694, is located between the first rotor 620 and the second rotor 630 in the axial direction. An outer diameter of the first contact portion 692 and an outer diameter of the second contact portion 693 are larger than an outer diameter of the column body portion 691. A surface of the first contact portion 692 on the rear side comes into contact with a surface of the first rotor 620 on the front side. A surface of the second contact portion 693 on the front side comes into contact with a surface of the second rotor 630 on the rear side. A contact area between the connecting column 690 and each rotor can be increased by the first contact portion 692 and the second contact portion 693 having larger outer diameters than that of the column body portion 691. Accordingly, the connecting column 690 can be stably brought into contact with each rotor in the axial direction.

An outer diameter of a part of the first contact portion 692 on the front side (+Z side) that is connected to the column body portion 691 increases toward the rear side (−Z side). An outer diameter of a part of the first contact portion 692 on the rear side is the same as an outer diameter of an end portion, on the rear side, of the part of the first contact portion 692 on the front side. A surface, on the rear side, of each first contact portion 692 of the plurality of connecting columns 690 respectively comes into contact with a surface of each of the plurality of first arms 622 on the front side. In the present embodiment, the surface of each first contact portion 692 on the rear side comes into contact with a surface, on the front side, of a part of each first arm 622 on the inner side in the radial direction.

An outer diameter of a part of the second contact portion 693 on the rear side (−Z side) connected to the column body portion 691 increases toward the front side (+Z side). An outer diameter of a part of the second contact portion 693 on the front side is the same as an outer diameter of an end portion, on the front side, of the part of the second contact portion 693 on the rear side. A surface, on the front side, of each second contact portion 693 of the plurality of connecting columns 690 comes into contact a surface of the second rotor annular portion 631a on the rear side. The surface of each second contact portion 693 on the front side is fixed to the surface of the second rotor annular portion 631a on the rear side. Thus, each of the connecting columns 690 is fixed to the second rotor 630. A method of fixing the second contact portion 693 to the second rotor annular portion 631a is not particularly limited, and may be bonding with an adhesive, may be welding, or may be screwing.

The fitting fixing portion 694 is connected to an end portion of the first contact portion 692 on the rear side (−Z side). In the present embodiment, the fitting fixing portion 694 has a columnar shape extending in the axial direction. Each of the fitting fixed portions 694 of the plurality of connecting columns 690 is a part fixed inside each fixing hole 622u of the plurality of first arms 622. Thus, each of the connecting columns 690 is fixed to the first rotor 620. The fitting fixing portion 694 hooks onto an inner circumferential surface of the fixing hole 622u in the circumferential direction, making it possible to suppress displacement of the connecting column 690 in the circumferential direction relative to the first rotor 620. Accordingly, detachment of the connecting column 690 from the first rotor 620 can be suppressed. This makes it possible to more suitably maintain an interval between the first rotor 620 and the second rotor 630 in the axial direction by the plurality of connecting columns 690. The respective fitting fixing portions 694 are fitted inside the respective fixing holes 622u. The respective fitting fixing portions 694 are press-fitted and fixed inside the respective fixing holes 622u. Note that the respective fitting fixing portions 694 may be fixed inside the respective fixing holes 622u by, for example, an adhesive.

As illustrated in FIG. 47, in the present embodiment, each fixing hole 622u is provided in a part of each first arm 622 that is adjacent to the first rotor penetrating portion 28 in the circumferential direction. That is, the plurality of connecting columns 690 are respectively fixed to parts of the plurality of first arms 622 that are adjacent to the first rotor penetrating portions 28 in the circumferential direction. This facilitates the stirring of the air passing through the first rotor penetrating portions 28 by the connecting columns 690. Accordingly, the heat dissipation of the motor 600 can be further improved.

As illustrated in FIG. 46, in a bus bar assembly 660, among end surfaces of the bus bar holder 661 in the axial direction, an end surface facing the plurality of inner fins 51b in the axial direction, that is, an end surface on the front side (+Z side), includes an inclined portion 661c facing the plurality of inner fins 51b. In the present embodiment, a part on the inner side, in the radial direction, of the end surface of the bus bar holder 661 on the front side is the inclined portion 661c. The inclined portion 661c is increasingly separated from the plurality of inner fins 51b in the axial direction toward the inner side in the radial direction. That is, the inclined portion 661c is increasingly located on the rear side (−Z side) toward the inner side in the radial direction. A radial inner edge of the inclined portion 661c is connected to an end portion, in the axial direction, of an inner circumferential surface of the bus bar holder 661. This makes it possible to facilitate the flow of air coming into contact with the inclined portion 661c from the front side toward the inner side in the radial direction by the inclined portion 661c, and facilitate the flow of the air toward the inner side of the bus bar holder 661 in the radial direction. As a result, it is possible to facilitate the flow of air to the part of the plurality of inner fins 51b overlapping the bus bar holder 661 in the axial direction, and further facilitate contact of the air with the plurality of inner fins 51b. Accordingly, the heat dissipation of the stator 650 can be further improved, and the heat dissipation of the motor 600 can be further improved.

A radial outer edge of the inclined portion 661c is located inwardly away from an outer circumferential surface of the bus bar holder 661 in the radial direction. The radial outer edge of the inclined portion 661c is located rearward (−Z side) of a part of an end surface of the bus bar holder 661 on the front side (+Z side), the part being located outward of the inclined portion 661c in the radial direction. As illustrated in FIG. 47, in the present embodiment, the inclined portion 661c has an annular shape surrounding the center axis J. More specifically, the inclined portion 661c has a circular annular shape having a center that coincides with the center axis J in a planar view in the axial direction. Note that, in FIG. 46, the bus bar assembly 660 is illustrated in a simplified manner in which the bus bar holder 661 and the bus bar are integrated.

In an inner housing 651 of the stator 650, an end portion of an inner housing annular portion 651a on the front side (+Z side) is located frontward of an end portion, on the front side, of an outer housing annular portion 652a of an outer housing 652. Unlike the inner housing annular portion 51a of the first embodiment, the inner housing annular portion 651a is not provided with the first groove 51d. Unlike the outer housing 52 of the first embodiment, the outer housing 652 is not provided with the fourth protruding wall 52d. Other configurations of the inner housing 651 are similar to other configurations of the inner housing 51 in the first embodiment. Other configurations of the outer housing 652 are similar to other configurations of the outer housing 52 in the first embodiment.

The stator 650 includes a front cover 658 and a rear cover 659. The front cover 658 closes part of an area between, in the radial direction, an end portion of the inner housing annular portion 651a on the front side (+Z side) and an end portion of the outer housing annular portion 652a on the front side. The front cover 658 is configured by stacking a first cover member 658g and a second cover member 658h in the axial direction. Each of the first cover member 658g and the second cover member 658h has a shape similar to that of the cover body portion 58a in the first embodiment except that the second groove 58a is not provided. The first cover member 658g and the second cover member 658h are located on the front side (+Z side) of the coil 53b. The first cover member 658g and the second cover member 658h are fitted between the inner housing annular portion 651a and the outer housing annular portion 652a in the radial direction. The first cover member 658g is made of a ceramic. The second cover member 658h is made of a resin. The second cover member 658h is made of, for example, flame retardant type 4 (FR4). The second cover member 658h is located on the front side of the first cover member 658g. Note that a material constituting the first cover member 658g and a material constituting the second cover member 658h are not particularly limited.

The rear cover 659 at least partially closes a part on the outer side in the radial direction between the end portion of the inner housing annular portion 651a on the rear side (−Z side) and an end portion of the outer housing annular portion 652a on the rear side in the radial direction. The rear cover 659 has a plate shape with a plate surface facing the axial direction. Although not illustrated, the rear cover 659 has an annular shape surrounding the center axis J. A radial outer edge of the rear cover 659 is fitted to an inner circumferential surface of the outer housing annular portion 652a. The rear cover 659 is made of a ceramic. In the present embodiment, a resin section 680 includes a part located between the front cover 658 and the rear cover 659 in the axial direction. Note that a material constituting the rear cover 659 is not particularly limited.

As illustrated in FIG. 45, an attachment member 610 of the present embodiment includes the support shaft 611 and a stator support member 610a. The support shaft 611 and the stator support member 610a are separate members from each other. The stator support member 610a includes a tubular portion 618 and the plurality of stator support sections 12. The tubular portion 618 has a cylindrical shape about the center axis J and opens to both sides in the axial direction. A part of the support shaft 611 that is located rearward (−Z side) of the first bearing 671a is fitted to the inner side of the tubular portion 618 in the radial direction. An inner circumferential surface of the tubular portion 618 is fixed to an outer circumferential surface of the support shaft 611. In the present embodiment, the plurality of stator support sections 12 extend toward the outer side, in the radial direction, from a part of an outer circumferential surface of the tubular portion 618 that is located rearward of the first rotor 620. In the present embodiment, end portions of the plurality of stator support sections 12 on the inner side in the radial direction are indirectly connected to a part of the support shaft 611 that is located rearward of the first rotor 620, with the tubular portion 618 interposed therebetween.

Other configurations of the motor 600 are similar to other configurations of the motor 100 in the first embodiment. Other configurations of the propulsion device 6000 are similar to other configurations of the propulsion device 1000 in the first embodiment.

### Seventh Embodiment

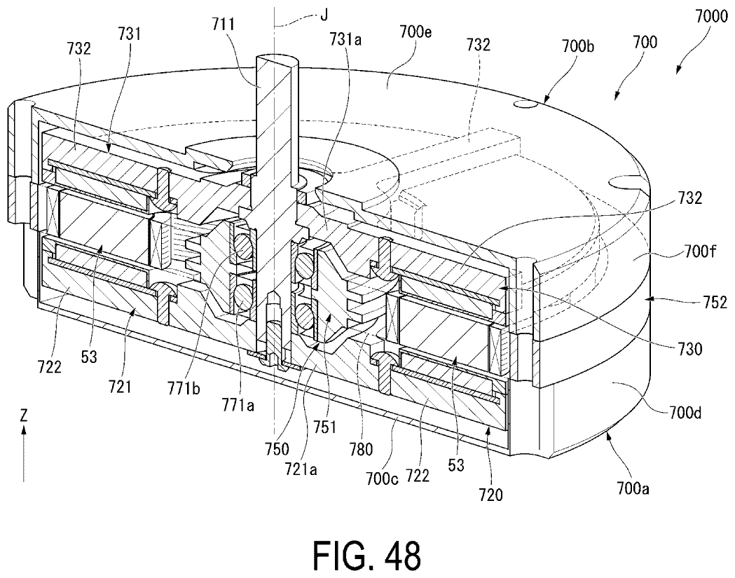

As illustrated in FIG. 48, a motor 700 of a propulsion device 7000 of the present embodiment includes a first housing 700a and a second housing 700b. The first housing 700a covers a first rotor 720 from the rear side (−Z side). The second housing 700b covers a second rotor 730 from the front side (+Z side).

The first housing 700a includes a first lid portion 700c and a first tubular portion 700d. The first lid portion 700c is located on the rear side (−Z side) of the first rotor 720 and covers the first rotor 720 from the rear side. The first lid portion 700c has a disc shape having a center that coincides with the center axis J in a planar view in the axial direction. The first tubular portion 700d protrudes from a radial outer edge of the first lid portion 700c toward the front side (+Z side). The first tubular portion 700d has a cylindrical shape about the center axis J and opens to the front side.

The second housing 700b includes a second lid portion 700e and a second tubular portion 700f. The second lid portion 700e is located on the front side (+Z side) of the second rotor 730 and covers the second rotor 730 from the front side. The second lid portion 700e has a disc shape having a center that coincides with the center axis J in a planar view in the axial direction. The second tubular portion 700f protrudes from a radial outer edge of the second lid portion 700e toward the rear side (−Z side). The second tubular portion 700f has a cylindrical shape about the center axis J and opens to the rear side.

A stator 750 includes an inner housing 751, an outer housing 752, and the plurality of electromagnet sections 53. The inner housing 751 has a cylindrical shape about the center axis J and opens to both sides in the axial direction. The inner housing 751 is located on the inner side of the plurality of electromagnet sections 53 in the radial direction. A first rolling bearing 771a and a second rolling bearing 771b are fitted to an inner circumferential surface of the inner housing 751. The outer housing 752 surrounds the plurality of electromagnet sections 53. The outer housing 752 has a cylindrical shape about the center axis J and opens to both sides in the axial direction. The inner housing 751, the outer housing 752, and the plurality of electromagnet sections 53 are connected to each other by a resin section 780. The inner housing 751 differs from the inner housing 51 in the first embodiment in not including the plurality of inner fins 51b. The outer housing 752 differs from the outer housing 52 in the first embodiment in not including the plurality of outer fins 52b.

The first housing 700a and the second housing 700b are fixed to the outer housing 752. Apart of the outer housing 752 on the outer side in the radial direction is interposed between the first tubular portion 700d and the second tubular portion 700f in the axial direction. The first tubular portion 700d and the second tubular portion 700f are fixed to the outer housing 752. The first tubular portion 700d, the second tubular portion 700f, and the outer housing 752 are fixed to each other by being fastened together by a plurality of bolts, for example.

In the present embodiment, the motor 700 includes a rotating shaft 711 instead of a support shaft. The rotating shaft 711 extends in the axial direction along the center axis J. The rotating shaft 711 has a substantially columnar shape about the center axis J. An inner circumferential surface of a first rotor annular portion 721a of a first rotor frame 721 and an inner circumferential surface of a second rotor annular portion 731a of a second rotor frame 731 are fixed to the outer circumferential surface of the rotating shaft 711. The rotating shaft 711 is rotatable around the center axis J together with the first rotor 720 and the second rotor 730. The rotating shaft 711 penetrates the second lid portion 700e of the second housing 700b in the axial direction. An end portion of the rotating shaft 711 on the front side (+Z side) is located frontward of the second housing 700b and is exposed to the outside of the motor 700. Although not illustrated, a propeller is attached to a part of the rotating shaft 711 that is located frontward of the second housing 700b.

In the first rotor frame 721, a number of the first arms 722 is four. In the second rotor frame 731, a number of second arms 732 is four. Other configurations of the first rotor 720 are similar to other configurations of the first rotor 20 in the first embodiment. Other configurations of the second rotor 730 are similar to other configurations of the second rotor 30 in the first embodiment. Other configurations of the motor 700 are similar to other configurations of the motor 100 in the first embodiment. Other configurations of the propulsion device 7000 are similar to other configurations of the propulsion device 1000 in the first embodiment.

The present invention is not limited to the embodiments described above, and other configurations and other methods can be adopted within the scope of the technical idea of the present invention. The number of magnets in the rotor body is not particularly limited as long as the number is at least one or more. The rotor body may have only one magnet having an annular shape. The rotor body need not include the annular member. In this case, the rotor body is constituted only by at least one magnet. Further, in a case in which the rotor body does not include the annular member, when the rotor body is constituted by a plurality of magnets, the plurality of magnets are fixed to each other by, for example, an adhesive. In each of the embodiments described above, a configuration is adopted in which the rotor includes the first rotor and the second rotor, but the configuration is not limited thereto. In each of the embodiments described above, only one of the first rotor or the second rotor may be provided. The support structure of the rotor is not particularly limited. The support structure of the stator is not particularly limited. The arrangement of the bus bar assembly is not particularly limited. The bus bar assembly need not be provided. The stator cover need not be provided. The motor according to the present disclosure may be a double-stator axial flux type motor in which two stators are provided for one rotor, or may be an axial flux type motor including one rotor and one stator. The application of the motor and the application of the propulsion device according to the present disclosure are not particularly limited. The motor according to the present disclosure may be provided in a device other than a propulsion device.

Note that the present technology can have configurations such as the following.

(1) A motor includes a rotor rotatable around a center axis, and a stator located on one side of the rotor in an axial direction. The stator includes a plurality of magnetic poles facing an end surface of the rotor on the one side in the axial direction. The rotor includes a rotor body having an annular shape and including at least one magnet, a rotor frame including a plurality of arms extending in a radial direction, and a first cover fixed to the rotor frame. The at least one magnet has, at least in part or in whole, a magnetization direction in the axial direction. The plurality of arms are located on the other side of the rotor body in the axial direction. The first cover is configured to cover at least part of a surface of the at least one magnet, the surface facing the one side in the axial direction.

(2) In the motor according to (1), the rotor frame includes a rotor annular portion surrounding the center axis. Each of the plurality of arms extends from an outer circumferential surface of the rotor annular portion toward an outer side in the radial direction, is disposed spaced apart from neighboring arms in a circumferential direction, and is configured to come into contact with a surface of the rotor body on the other side in the axial direction at a part of either a surface of the arm facing the one side in the axial direction or an edge of the arm in the circumferential direction.

(3) In the motor according to (2), each of the plurality of arms includes a holding surface located on an outer side of the rotor body in the radial direction and facing an inner side of the rotor body in the radial direction, and a mounting surface located on the other side of the rotor body in the axial direction and facing the one side of the rotor body in the axial direction. The mounting surface is configured to come into contact with the surface of the rotor body on the other side in the axial direction, and the holding surface is configured to come into contact with an outer circumferential surface of the rotor body.

(4) In the motor according to (3), the rotor body includes an annular member made of a magnetic material, located on the other side of the at least one magnet in the axial direction, and surrounding the center axis. The at least one magnet is fixed to a surface of the annular member on the one side in the axial direction. A surface of the annular member on the other side in the axial direction is configured to come into contact with the mounting surface. Each of the plurality of arms includes an arm body portion extending in the radial direction, a holding wall protruding from an end portion of the arm body portion on the outer side in the radial direction toward the one side in the axial direction and including the holding surface, and a first protruding portion protruding from an end portion of the holding wall on the one side in the axial direction toward the inner side in the radial direction. The annular member includes an annular body portion having an annular shape and to which the at least one magnet is fixed, and a plurality of outer protruding portions protruding to the outer side in the radial direction from an outer circumferential edge of the annular body portion and disposed spaced part in the circumferential direction. The plurality of outer protruding portions are respectively located on the other side of the first protruding portions of the plurality of arms in the axial direction. A radial outer edge of each of the plurality of outer protruding portions is configured to come into contact with the holding surface. Each of the plurality of outer protruding portions is configured to come into contact with or face, with a gap therebetween, a surface of each of the first protruding portions on the other side in the axial direction.

(5) In the motor according to (4), at least one of the plurality of arms includes a protruding wall protruding from a part of the arm body portion toward the one side in the axial direction, the part being provided at a position inwardly separated from the holding wall in the radial direction, and a second protruding portion protruding from an end portion of the protruding wall on the one side in the axial direction toward the outer side in the radial direction. The annular member includes a first inner protruding portion protruding from an inner circumferential edge of the annular body portion toward the inner side in the radial direction. The first inner protruding portion is located on the other side of the second protruding portion in the axial direction and is configured to come into contact with or face, with a gap therebetween, a surface of the second protruding portion on the other side in the axial direction.

(6) In the motor according to (5), the first inner protruding portion includes a first penetrating portion penetrating the first inner protruding portion in the axial direction. An inner edge of the first penetrating portion includes parts located on both sides in the circumferential direction. The second protruding portion includes a second penetrating portion that penetrates the second protruding portion in the axial direction. An inner edge of the second penetrating portion includes parts located on both sides in the circumferential direction. The first penetrating portion and the second penetrating portion at least partially overlap each other in a planar view in the axial direction. A pin member extending in the axial direction is passed through the first penetrating portion and the second penetrating portion. The pin member is configured to come into contact with the parts of the inner edge of the first penetrating portion located on both sides in the circumferential direction and the parts of the inner edge of the second penetrating portion located on both sides in the circumferential direction.

(7) In the motor according to any one of (4) to (6), the annular member includes a second inner protruding portion protruding from an inner circumferential edge of the annular body portion toward the inner side in the radial direction. The first cover includes a top plate portion having an annular shape and configured to cover at least part of a surface of the at least one magnet, the surface facing the one side in the axial direction, an inner wall protruding from an inner circumferential edge of the top plate portion toward the other side in the axial direction and located on the inner side of the rotor body in the radial direction, and a fixed portion protruding toward the inner side in the radial direction from an end portion of the inner wall on the other side in the axial direction and fixed to an arm of the plurality of arms with a bolt. The fixed portion includes a through-hole penetrating the fixed portion in the axial direction. The through-hole includes a first hole portion including an inner edge having a circular arc shape recessed toward the inner side in the radial direction in a planar view in the axial direction, and a second hole portion located on the outer side of the first hole portion in the radial direction. The second hole portion opens to a surface of the inner wall on the outer side in the radial direction. At least part of the second inner protruding portion is located at the second hole portion. An inner edge of the second hole portion in the radial direction includes a circular arc portion having a circular arc shape recessed toward the outer side in the radial direction in a planar view in the axial direction. An inner edge of the first hole portion and the circular arc portion form a bolt through-hole through which the bolt is passed from the one side in the axial direction. The bolt is passed through the bolt through-hole and fastened into a threaded hole provided in the arm. A head portion of the bolt presses the fixed portion and the second inner protruding portion against the arm from the one side in the axial direction.

(8) In the motor according to any one (1) to (7), the first cover includes an annular portion surrounded inwardly and outwardly by two concentric circles, the two concentric circles having a center that coincides with the center axis, in a planar view in the axial direction. Given a difference in radius between the two concentric circles being defined as a width of the annular portion, the width of the annular portion is larger than a height of the first cover as a whole in the axial direction. The first cover includes a first cover recess portion on the other side in the axial direction, the first cover recess portion being recessed at a center portion of the annular portion in a width direction toward the one side in the axial direction and extending along the annular portion so as to surround the center axis.

(9) In the motor according to any one of (1) to (8), the rotor includes a second cover disposed on the other side of the rotor body in the axial direction, and the second cover is configured to cover at least part of a surface of the rotor body on the other side in the axial direction, and be fixed to at least one of the rotor frame or the first cover.

(10) In the motor according to (9), the second cover includes a bottom plate portion having a fan shape about the center axis in a planar view in the axial direction, and a fixed wall protruding from a radial outer edge of the bottom plate portion toward the first cover. The fixed wall is located on an outer side of the rotor body in the radial direction and is fixed to the first cover.

(11) In the motor according to (10), the second cover includes a claw protruding from a radial inner edge of the bottom plate portion toward the one side in the axial direction. The claw is located on the inner side of the rotor body in the radial direction and is configured to hook onto on the first cover from the one side in the axial direction.

(12) In the motor according to (10) or (11), the rotor includes a plurality of the second covers disposed spaced apart in a circumferential direction, and the plurality of second covers are respectively located between the plurality of arms adjacent to each other in the circumferential direction.

(13) In the motor according to any one of (1) to (12), the first cover is made of a fiber reinforced plastic.

(14) In the motor according to any one of one of (1) to (13), the rotor body includes a plurality of the magnets. The plurality of magnets include a plurality of first magnets having a magnetization direction in the axial direction and a plurality of second magnets having a magnetization direction in a direction intersecting the axial direction, and are arranged in a Halbach array.

The configurations and methods described above in the present specification can be combined as appropriate within a range in which they do not contradict each other.

### REFERENCE SIGNS LIST

20, 620, 720 First rotor (rotor), 21 First rotor frame (rotor frame), 21a First rotor annular portion (rotor annular portion), 22, 22a, 22b, 22c, 22d, 622 First arm (arm), 22f Arm body portion, 22g Holding wall, 22h First protruding portion, 22i Third protruding wall (protruding wall), 22j, 22k Second protruding portion, 22n Second penetrating portion, 22p Mounting surface, 22r Threaded hole, 22t Holding surface, 23, 33 Rotor body, 23a, 33a Annular member, 23c Annular body portion, 23d Outer protruding portion, 23e, 23g, 23h First inner protruding portion, 23f Second inner protruding portion, 23i First penetrating portion, 23j Circular arc portion, 23r First magnet, 23s Second magnet, 23t Magnet, 24, 34 First cover, 24a Annular portion, 24b Fixed portion, 24c First top plate portion (top plate portion), 24d Inner wall, 24g Through-hole, 24h First hole portion, 24i Second hole portion, 24t First cover recess portion, 25, 35 Second cover, 25a Bottom plate portion, 25b Fixed wall, 25c Claw, 26b Bolt, 26c Pin member, 26e Head portion, 26f Bolt through-hole, 30, 630, 730 Second rotor (rotor), 31 Second rotor frame (rotor frame), 32 Second arm (arm), 37a Second top plate portion (top plate portion), 50, 350, 450, 650, 750 Stator, 53f, 53g Magnetic pole, 100, 200, 300, 400, 500, 600, 700 Motor, C1, C2 Concentric circle, J Center axis.

What is claimed is:

1. A motor comprising:
a rotor rotatable around a center axis; and
a stator located on one side of the rotor in an axial direction, wherein the stator includes a plurality
of magnetic poles facing an end surface of the rotor on the one side in the axial direction, the rotor includes—
a rotor body having an annular shape and including at least one magnet,
a rotor frame including a plurality of arms extending in a radial direction, and
a first cover fixed to the rotor frame,
the at least one magnet has, at least in part or in whole, a magnetization direction in the axial direction,
the plurality of arms are located on the other side of the rotor body in the axial direction, and
the first cover is configured to cover at least part of a surface of the at least one magnet, the surface facing the one side in the axial direction.

2. The motor according to claim 1, wherein
the rotor frame includes a rotor annular portion surrounding the center axis,
each of the plurality of arms extends from an outer circumferential surface of the rotor annular portion toward an outer side in the radial direction,
each of the plurality of arms is disposed spaced apart from neighboring arms in a circumferential direction,
each of the plurality of arms is configured to come into contact with a surface of the rotor body on the other side in the axial direction at a part of either a surface of the arm facing the one side in the axial direction or an edge of the arm in the circumferential direction.

3. The motor according to claim 2, wherein
each of the plurality of arms includes
a holding surface located on an outer side of the rotor body in the radial direction and facing an inner side of the rotor body in the radial direction, and
a mounting surface located on the other side of the rotor body in the axial direction and facing the one side of the rotor body in the axial direction,
the mounting surface is configured to come into contact with the surface of the rotor body on the other side in the axial direction, and
the holding surface is configured to come into contact with an outer circumferential surface of the rotor body.

4. The motor according to claim 3, wherein
the rotor body includes an annular member made of a magnetic material, located on the other side of the at least one magnet in the axial direction, and surrounding the center axis,
the at least one magnet is fixed to a surface of the annular member on the one side in the axial direction,
a surface of the annular member on the other side in the axial direction is configured to come into contact with the mounting surface,
each of the plurality of arms includes:
an arm body portion extending in the radial direction,
a holding wall protruding from an end portion of the arm body portion on the outer side in the radial direction toward the one side in the axial direction and including the holding surface, and
a first protruding portion protruding from an end portion of the holding wall on the one side in the axial direction toward the inner side in the radial direction,
the annular member includes:
an annular body portion having an annular shape and to which the at least one magnet is fixed, and
a plurality of outer protruding portions protruding to the outer side in the radial direction from an outer circumferential edge of the annular body portion and disposed spaced part in the circumferential direction,
the plurality of outer protruding portions are respectively located on the other side of the first protruding portions of the plurality of arms in the axial direction,
a radial outer edge of each of the plurality of outer protruding portions is configured to come into contact with the holding surface, and
each of the plurality of outer protruding portions is configured to come into contact with or face, with a gap therebetween, a surface of each of the first protruding portions on the other side in the axial direction.

5. The motor according to claim 4, wherein
at least one of the plurality of arms includes:
a protruding wall protruding from a part of the arm body portion toward the one side in the axial direction, the part being provided at a position inwardly separated from the holding wall in the radial direction, and
a second protruding portion protruding from an end portion of the protruding wall on the one side in the axial direction toward the outer side in the radial direction,
the annular member includes a first inner protruding portion protruding from an inner circumferential edge of the annular body portion toward the inner side in the radial direction,
the first inner protruding portion is located on the other side of the second protruding portion in the axial direction and is configured to come into contact with or face, with a gap therebetween, a surface of the second protruding portion on the other side in the axial direction.

6. The motor according to claim 5, wherein
the first inner protruding portion includes a first penetrating portion penetrating the first inner protruding portion in the axial direction,
an inner edge of the first penetrating portion includes parts located on both sides in the circumferential direction,
the second protruding portion includes a second penetrating portion that penetrates the second protruding portion in the axial direction,
an inner edge of the second penetrating portion includes parts located on both sides in the circumferential direction,
the first penetrating portion and the second penetrating portion at least partially overlap each other in a planar view in the axial direction,
a pin member extending in the axial direction is passed through the first penetrating portion and the second penetrating portion,
the pin member is configured to come into contact with the parts of the inner edge of the first penetrating portion located on both sides in the circumferential direction and the parts of the inner edge of the second penetrating portion located on both sides in the circumferential direction.

7. The motor according to claim 4, wherein
the annular member includes a second inner protruding portion protruding from an inner circumferential edge of the annular body portion toward the inner side in the radial direction,
the first cover includes
a top plate portion having an annular shape and configured to cover at least part of a surface of the at least one magnet, the surface facing the one side in the axial direction,
an inner wall protruding from an inner circumferential edge of the top plate portion toward the other side in the axial direction and located on the inner side of the rotor body in the radial direction, and
a fixed portion protruding toward the inner side in the radial direction from an end portion of the inner wall on the other side in the axial direction and fixed to an arm of the plurality of arms with a bolt,
the fixed portion includes a through-hole penetrating the fixed portion in the axial direction,
the through-hole includes:
a first hole portion including an inner edge having a circular arc shape recessed toward the inner side in the radial direction in a planar view in the axial direction, and
a second hole portion located on the outer side of the first hole portion in the radial direction,
the second hole portion opens to a surface of the inner wall on the outer side in the radial direction,
at least part of the second inner protruding portion is located at the second hole portion,
an inner edge of the second hole portion in the radial direction includes a circular arc portion having a circular arc shape recessed toward the outer side in the radial direction in a planar view in the axial direction,
an inner edge of the first hole portion and the circular arc portion form a bolt through-hole through which the bolt is passed from the one side in the axial direction,
the bolt is passed through the bolt through-hole and fastened into a threaded hole provided in the arm,
a head portion of the bolt presses the fixed portion and the second inner protruding portion against the arm from the one side in the axial direction.

8. The motor according to claim 1, wherein
the first cover includes an annular portion inwardly and outwardly surrounded by two concentric circles, the two concentric circles having a center that coincides with the center axis, in a planar view in the axial direction,
a difference in radius between the two concentric circles being defined as a width of the annular portion, the width of the annular portion is larger than a height of the first cover as a whole in the axial direction,
the first cover includes a first cover recess portion on the other side in the axial direction, the first cover recess portion being recessed at a center portion of the annular portion in a width direction toward the one side in the axial direction and extending along the annular portion so as to surround the center axis.

9. The motor according to claim 8, wherein
the rotor includes a second cover disposed on the other side of the rotor body in the axial direction,
the second cover is configured to cover at least part of a surface of the rotor body on the other side in the axial direction,
the second cover is configured to be fixed to at least one of the rotor frame or the first cover.

10. The motor according to claim 9, wherein
the second cover includes a bottom plate portion having a fan shape about the center axis in a planar view in the axial direction,
the second cover includes a fixed wall protruding from a radial outer edge of the bottom plate portion toward the first cover,
the fixed wall is located on an outer side of the rotor body in the radial direction and is fixed to the first cover.

11. The motor according to claim 10, wherein
the second cover includes a claw protruding from a radial inner edge of the bottom plate portion toward the one side in the axial direction,
the claw is located on the inner side of the rotor body in the radial direction and is configured to hook onto on the first cover from the one side in the axial direction.

12. The motor according to claim 10, wherein
the rotor includes a plurality of the second covers disposed spaced apart in a circumferential direction,
the plurality of second covers are respectively located between the plurality of arms adjacent to each other in the circumferential direction.

13. The motor according to claim 8, wherein
the first cover is made of a fiber reinforced plastic.

14. The motor according to claim 8, wherein
the rotor body includes a plurality of the magnets,
the plurality of magnets include a plurality of first magnets having a magnetization direction in the axial direction and a plurality of second magnets having a magnetization direction in a direction intersecting the axial direction, and are arranged in a Halbach array.

15. The motor according to claim 1, wherein
the rotor includes a second cover disposed on the other side of the rotor body in the axial direction,
the second cover is configured to cover at least part of a surface of the rotor body on the other side in the axial direction,
the second cover is configured to be fixed to at least one of the rotor frame or the first cover.

16. The motor according to claim 15, wherein
the second cover includes a bottom plate portion having a fan shape about the center axis in a planar view in the axial direction,
the second cover includes a fixed wall protruding from a radial outer edge of the bottom plate portion toward the first cover,
the fixed wall is located on an outer side of the rotor body in the radial direction and is fixed to the first cover.

17. The motor according to claim 16, wherein
the second cover includes a claw protruding from a radial inner edge of the bottom plate portion toward the one side in the axial direction,
the claw is located on the inner side of the rotor body in the radial direction and is configured to hook onto on the first cover from the one side in the axial direction.

18. The motor according to claim 16, wherein
the rotor includes a plurality of the second covers disposed spaced apart in a circumferential direction,
the plurality of second covers are respectively located between the plurality of arms adjacent to each other in the circumferential direction.

19. The motor according to claim 1, wherein
the first cover is made of a fiber reinforced plastic.

20. The motor according to claim 1, wherein
the rotor body includes a plurality of the magnets,
the plurality of magnets include a plurality of first magnets having a magnetization direction in the axial direction and a plurality of second magnets having a magnetization direction in a direction intersecting the axial direction, and are arranged in a Halbach array.
